(19) United States
(12) Patent Application Publication
(10) Pub. No.: US 2007/0059692 A1
(43) Pub. Date: Mar. 15, 2007

(54) Array oligomer synthesis and use

(76) Inventors: Xiaolian Gao, Houston, TX (US); Xiaochuan Zhou, Houston, TX (US); Shi-Ying Cai, Houston, TX (US); Qimin You, Houston, TX (US); Xiaolin Zhang, Sugar Land, TX (US)

Correspondence Address: VINSON & ELKINS, L.L.P., 1001 FANNIN STREET, 2300 FIRST CITY TOWER, HOUSTON, TX, 77002-6760, US

(21) Appl. No.: 10/533,208

(22) PCT Filed: Oct. 28, 2003
(86) PCT No.: PCT/US03/34207

§ 371 Date: Apr. 21, 2006

Related U.S. Application Data
(60) Provisional application No. 60/421,942, filed on Oct. 28, 2002.

(51) Int. Cl. C40B 30/06; C40B 40/04; C40B 40/08; C40B 40/10

(52) U.S. Cl. 435/6; 435/7.1

(57) ABSTRACT

The present disclosure provides efficient and reproducible methods for individually synthesizing oligomers in a parallel manner (e.g., oligonucleotides) on a solid support to produce pools of oligomers. Pools of oligonucleotides can be used for a variety of genomic and proteomic applications, including synthesis of genes or long DNA of any arbitrary sequence, PCR template amplification, and to generate primers for multiplexing PCR or transcription. Rapid availability of these oligonucleotide products will greatly accelerate the processes of de novo protein design, vaccine development, production of short RNA fragments, such as siRNA, oligonucleotide-based drug screening, and SNP sample preparation.

### STATEMENT REGARDING FEDERALLY SPONSORED RESEARCH OR DEVELOPMENT

Defense Advanced Research Projects Agency.

### REFERENCE TO A “Microfiche Appendix”

Not applicable.

### BACKGROUND OF THE INVENTION

1. Field of the Invention

The present disclosure relates to the field of macromolecule synthesis and their applications, in particular high throughput oligonucleotide synthesis using a microfluidic microarray platform for generating pools of oligonucleotides of known sequences.

2. Description of Related Art

The amazing progress in the last several decades in the area of biotechnology has occurred largely because of developments in the areas of genomic technologies and molecular biology. While astronomical amounts of gene codes in various species have been generated, the advancements in molecular biology have provided the tools for analyzing, manipulating, and constructing various combinations of genetic elements, also known as genetic engineering. These DNA/RNA technologies create new and useful nucleic sequences by joining together pieces of nucleic acid materials with different functions in novel ways. The assembled synthetic sequences and joined nucleic acid sequences may be copies of known genes, novel genes, primers, promoters, templates, or any functional module for many well known biochemical and biomedical applications, including polymerase chain reaction (PCR), isothermal replication, transcription, and chain length extension by ligation.

Traditional molecular biology methods for manipulating genetic material to build constructs primarily involve enzyme-based methods, for example the use of restriction endonuclease and ligase enzymes to cut and paste nucleic acid fragments together, and the use of cloning vectors to amplify the newly subcloned fragments. PCR is another powerful tool for synthesizing and amplifying desired nucleic acid fragments. Traditional methods involve the isolation of nucleic acid material from resources such as genomic DNA libraries or cDNA libraries, or directly from biological sources such as cells, tissue samples, etc. These methods are slow, labor-intensive, and tedious, and it is often unpredictable how long it will take to isolate a desired nucleic acid material for further manipulation. Additionally, building constructs through the use of vectors and cloning often involves events such as random mutagenesis, recombination, deletions, insertions, and rearrangements, which are unpredictable and further impede progress. Another disadvantage of traditional methods of genetic engineering is that larger fragments of nucleic acids become increasingly difficult to manipulate.

Traditional tools of molecular biology are also used to generate constructs that can be used to elucidate and better understand the function of various proteins. Systematic mutagenesis is a powerful technique for analyzing the function of a protein down to the impact of a single amino acid change in the sequence of a protein, but generating these precise mutations in a protein sequence are also labor-intensive and time-consuming. For example, molecular evolution methodologies have proven immensely powerful for engineering proteins with desired properties. Such methodologies include PCR, cassette mutagenesis, and a variety of methods collectively known as DNA shuffling. But while PCR can be used to mutagenize a mixture of fragments of known or unknown sequence, published PCR protocols suffer from a low processivity of the polymerase and therefore are often unable to produce the random mutagenesis desired for an average sized gene. This limits the practical applicability of PCR for generating an array of mutant sequences for further study.

Cassette mutagenesis replaces a specific region of a gene to be optimized with a synthetically mutagenized oligonucleotide. Therefore, the maximum information content that can be obtained is statistically limited by the size of the sequence block and the number of random sequences. This constitutes a statistical bottle-neck, eliminating other sequence families which are not currently the best, but which have greater long term potential.

Recently developed DNA shuffling methods exploit the recombination between genes to dramatically accelerate the rate at which genes can be evolved. Examples of DNA shuffling methods include sexual PCR (U.S. Pat. Nos. 6,440,668 and 5,965,408) and the “staggered-extension” process (STEP) (U.S. Pat. Nos. 6,153,410 and 6,177,263). While sexual PCR and STEP have been used to improve proteins by in vitro recombination using random chimeragenesis, these methodologies are limited by low cross-over rates and high background of unshuffled parental clones. In addition, when these methods are applied to regions of high sequence homology they are relatively inefficient and only a small number of variants result. Even improved methods of DNA shuffling such as iterative truncation for the creation of hybrid enzymes (ITCHY) (Ostermeier et al., Bioorg Med Chem 7:2139-2144, 1999) and random chimeragenesis on transient templates (RACHITT) (Coco et al., Nature Biotech 19:354-359, 2001) do not produce a high number of cross-over events and thus large numbers of variants still escapes these methodologies.

In many multiplexing applications, such as simultaneously amplifying DNA from several different DNA templates using PCR, multiple primers of different sequences are required. Traditionally, these primers are synthesized in separate reaction vessels and combined before their use. This process requires repetitive operations for each sequence, such as synthesis, deprotection, and unpackaging the reaction vessels. This results in a high rate of mixing unequal amounts of primers due to the error of weighing solid support materials at the initiation of the synthesis. It is highly desirable to have a parallel synthesis process to significantly reduce the amount of labor and time for producing a pool of oligonucleotides for multiplexing applications.

In many multiplexing applications, such as simultaneously transcribing several RNA sequences, multiple template DNA sequences are required. Traditionally, these templates are synthesized in separate reaction vessels and combined before their use. This process requires repetitive operations for each sequence, such as synthesis, deprotection, and unpackaging the vessels. This results in a high rate of mixing unequal amount of templates due to the error of weighing solid support materials at the initiation of the synthesis. It is highly desirable to have a parallel synthesis process to significantly reduce the amount of labor and time for producing a pool of oligonucleotides for multiplexing applications. The templates may be directly synthesized, and additional copies of the templates can be obtained using PCR.

Thus, the needs exist for a high-throughput system for producing large numbers of oligonucleotides of diverse sequences (such as pools of oligonucleotides) that can be used as inserts, or assembled into macromolecules, or as templates for DNA or RNA synthesis. Preferably these pools of oligonucleotides are used to produce assembled macromolecules such as DNA fragments, RNA fragments, gene fragments, genes, chromosome fragments, chromosomes, regulatory regions, expression constructs, gene therapy constructs, vaccine constructs, homologous recombination constructs, vectors, viral genomes, bacterial genomes, and the like, efficiently and economically. Additionally, the method for assembling macromolecules would preferably allow for the targeted mutagenesis of nucleic acid sequences in a reliable and rapid manner, thus allowing for the systematic mutagenesis of a sequence for analysis, for example determining the function of a gene, gene fragment, DNA fragment, mRNA, RNA, or protein, screening for potential antigens, or screening for drug or other molecule interactions.

The use of existing multiplexing parallel DNA synthesis methods on a traditional synthesizer, which generates one sequence per reaction, for generating oligonucleotides cannot fulfill the need for the generation of large amounts (pools) of oligonucleotides. The handling of multiple reactions in separate reaction vessels is labor intensive, time consuming, and costly. Additionally, this instrumentation is not amenable to miniaturization. There are existing oligonucleotide array synthesis technologies, such as that using photodeprotection of photolabile group protected nucleotides (U.S. Pat. No. 5,143,854). But these methods of oligonucleotide synthesis have low synthesis yields due to a low coupling efficiency, and thus cannot generate oligonucleotides of sufficient length (oligonucleotides synthesis is limited to approximately 25-mers) for many applications. For example, it would be impractical to use oligonucleotides of this length to assemble and synthesize large DNA sequences or gene products, and the high error rates found when using these techniques to synthesize oligonucleotides is unacceptable. Further, these techniques are based on the use of flat surfaces to synthesize the oligonucleotides, which must be cleaved efficiently and recovered in a small volume. Another critical requirement is that the cleaved oligonucleotides have 3′- and/or 5′-functional groups, such as hydroxyl or phosphate, for subsequent chemical or biological applications.

Existing multiplexing parallel DNA synthesis methods also include robotic and inkjet-based approaches (Rayner et al., Genome Research 8:741-47, 1998). These techniques are most often used to synthesize 96 DNA sequences in separate reaction vessels using a robotic instrument. The sequences are then deprotected and cleaved from the solid support and used for various molecular biology applications. Multiplexing synthesizers capable of producing oligonucleotides on 96-well titer plates are used in several oligonucleotide houses and core facilities. DNA sequences synthesized using inkjet-printing processes remain linked to the flat surface and are utilized in their immobilized form (Hughes et al., Nat Biotechnol 19:34247, 2001). Although these processes use conventional synthesis chemistry and are capable of producing high-purity oligonucleotides, the sequences are synthesized in separate reaction vessels, which complicates the subsequent use of these oligonucleotides for various applications. Therefore, instrument miniaturization and complete automation of these processes are difficult, which makes these systems impractical for rapid multiplexing parallel DNA synthesis.

Other methods and equipment have also attempted to achieve efficient multiplex production of oligonucleotides. One notable microfluidic device that may be suitable for multiplexing contains valves, pumps, constrictors, mixers and other liquid handling structures (U.S. Pat. No. 5,846,396). But the practical use of this fluidic device is limited because it is very complicated (the device is composed of a minimum eight layers of fluidic structures), leading to high manufacturing costs, and has a limited scalability. Additionally, the electrode pumps used require high voltage of 200 to 300 volts and each pump is controlled by a separate sets of wires. It would be difficult to build a control system for handling thousands of such pumps, and the pumping behaviors (direction and speed) highly depend on the dielectric properties and conductivities of the solutions or solvents used. Typically oligonucleotide synthesis involves at least ten different solutions in three different solvents, and it has not yet been demonstrated that these pumps could properly handle all these solutions. A preferred microfluidic device for synthesizing oligonucleotides is composed of only one layer of fluidic structure, can be easily scaled to contain several hundred to several tens of thousands of reactor cells, and can handle any type of solutions/solvents (e.g., U.S. Ser. No. 09/897,106, incorporated herein by reference).

An electrochemistry-based oligonucleotide synthesis method developed at Combimatrix for DNA microarray fabrication (U.S. Pat. No. 6,444,111) also has the potential for multiplexing synthesis applications. The core of the technology is an electrochemistry that produces active reagents (e.g. acids) with electrical current. Concerns about the technology include the efficiency and potential side reactions of the electrode chemistry used, as well as how well the reaction sites can be isolated to prevent the mixing of active reagents among adjacent reaction sites (“cross-talk” effect). The reaction efficiency has a significant effect on the final quality of the oligonucleotides synthesized, and any “cross-talk” effect would significantly degrade the fidelity of those sequences.

A photolithographic approach for parallel synthesis of oligonucleotides which combines photolabile synthesis chemistry with digital micromirror array projection technology has been demonstrated by Singh-Gasson et al. (Nature Biotechnology 17:974-978, 1999). The main limitation with this approach, however, is the same as with the photolabile deprotection approach: the use of low-yield chemistry (Pirrung et al., J. Org. Chem. 60:6270-6276, 1995; McGall et al., J. Am. Chem. Soc. 119:5081-5090, 1997). For example, with this chemistry the purity level for a 25-mer product could be less than ten percent. The synthesis from this method is in practical terms limited to 24-mers. This low-yield limitation makes photo-labile chemistry unsuitable for generating oligonucleotides that have sufficient accuracy and lengths to be used as primers, templates, and for the assembly into desired macromolecules. Thus, the inability of previous technologies to generate pools of high-quality oligonucleotides in a short amount of time by parallel DNA synthesis (hundreds to thousands, to tens of thousands, to hundreds of thousands of oligonucleotides in a few hours) has limited many powerful applications of synthesized oligonucleotides.

### BRIEF SUMMARY OF THE INVENTION

The present disclosure provides efficient and reproducible methods for multiplex parallel oligonucleotide synthesis on a solid support, which can be used to generate DNA sequences by the generation and assembly of oligonucleotides. In
preferred embodiments, the oligonucleotides synthesized are rapidly assembled to form long DNA sequences, for example DNA sequences, gene fragments, genes, transposons, chromosome fragments, chromosomes, regulatory regions, expression constructs, gene therapy constructs, viral constructs, homologous recombination constructs, vectors, viral genomes, bacterial genomes, and the like. This method is versatile, allowing for the synthesis of any arbitrary DNA sequence.

In another preferred embodiment, synthesized oligonucleotides are cleaved from the solid surface to produce pools of oligonucleotides (hundreds to thousands, to tens of thousands, to hundreds of thousands of oligonucleotides). The present disclosure overcomes the deficiencies of previously known methods for generating oligonucleotides by significantly simplifying the process of multiplex parallel DNA synthesis, reducing the time required for generating pools of oligonucleotides, and increasing the number of different oligonucleotides generated in the pool. In preferred embodiments the pool of oligonucleotides are of known sequence. The applications for pools of oligonucleotides include but are not limited to using the oligonucleotides to generate long DNA sequences, including any arbitrary sequence; primers for PCR template amplification; primers for multiplexing PCR and transcription; short RNA fragments, for example RNAi (RNA interference) or siRNA (short interfering RNA); DNA fragments for SNP (single nucleotide polymorphism) detection and sample preparation; and DNA, RNA, oligonucleotide, and/or combinatorial libraries. The pools of oligomers can also be used to provide libraries for genomic and proteomic applications, including de novo protein design, vaccine development, drug screening (molecular evolution), including oligonucleotide based drug screening, and many other applications that require the use of large pools of oligonucleotides.

Multiplex parallel oligonucleotide synthesis can be used to generate wild-type or modified partial or full-length DNA sequences by the generation and assembly of the synthesized oligonucleotides. In preferred embodiments, the oligonucleotides synthesized are rapidly assembled to form long DNA sequences, for example DNA sequences, gene fragments, genes, transposons, chromosome fragments, chromosomes, regulatory regions, expression constructs, gene therapy constructs, viral constructs, homologous recombination constructs, vectors, viral genomes, bacterial genomes, and the like. Other applications for these oligonucleotides include the generation of template libraries for PCR amplification and primer libraries for multiplexing PCR or transcription. In other preferred embodiments, the rapid synthesis and assembly of oligonucleotides into long DNA sequences will allow for new protein design, new vaccine development, the systematic mutagenesis of a sequence for analysis, for example determining the function of a gene, gene fragment, DNA fragment, mRNA, RNA, or protein, screening for potential antigens, or screening for drug or other molecule interactions.

The present disclosure advantageously employs existing chemistry to synthesize oligonucleotides and replaces at least one of the reagents in a reaction with a photo-reagent precursor. Therefore, unlike methods of the prior art, which require monomers containing photo-labile protecting groups or a polymeric coating layer as the reactive medium, the present method uses monomers of conventional chemistry and requires minimal variation of the conventional synthetic chemistry and protocols. The conventional chemistry adopted by the present disclosure routinely achieves better than 98.5% yield per step synthesis of oligonucleotides, which is a significant improvement over the 85-95% yield obtained by the previous method of using photolabile protecting groups. Pirrung et al., J. Org. Chem. 60:6270-6276, 1995; McGall et al., J Am. Chem. Soc. 119:5081-5090, 1997; McGall et al., Proc. Natl. Acad. Sci. USA 93:13555-13560, 1996. This improved stepwise yield is critical for synthesizing high-quality oligonucleotide arrays for diagnostic and clinical applications, and allows for the synthesis of oligonucleotides of much longer length, for example from 25, 50, 100, 150, or 200 nucleotides. Oligonucleotides of these lengths cannot be produced using previously known methods such as those that use photolabile protecting groups.

A preferred embodiment of the present disclosure is a method for parallel synthesis of an array of selected multimers on a substrate comprising isolated reaction sites containing one or more protected initiating moieties, the method comprising:
(a) selectively irradiating isolated reaction sites to generate deprotected initiating moieties at the irradiated isolated reaction sites;
(b) coupling one or more monomers to the deprotected initiating moieties;
(c) repeating steps (a)-(b) until the array of selected multimers has been synthesized;
wherein the multimers synthesized comprise multimers from about 75 to 200 monomers is length

In another preferred embodiment, the synthesized multimers comprise multimers from about 60 to 100 monomers in length, from about 100 to 175 monomers is length, or from about 125 to 150 monomers is length. Preferably the selected multimers are composed of DNA, oligonucleotides, RNA, DNA/RNA hybrids, peptides, or carbohydrates.

In the above method, the deprotected initiating moieties are preferably generated by contacting the substrate with a liquid solution comprising one or more photo-reagent precursors, such that the liquid solution is in contact with the initiating moieties; and selectively irradiating isolated reaction sites to produce one or more photo-generated reagents, wherein the photo-generated reagents are effective to deprotect the initiating moieties at the irradiated isolated reaction sites. In a preferred embodiment, the photo-reagent precursors are selected from the group consisting of acid precursors and base precursors. In another preferred embodiment, the monomer utilized in the reaction comprises an unprotected reactive site and a protected reactive site, and is preferably selected from the group consisting of nucleophosphoramidites, nucleophosphonates and analogs thereof. In yet another preferred embodiment, the protected initiating moieties are protected by an acid-labile group, and/or comprise linker molecules, wherein each of the linker molecules has a reactive functional group protected by an acid-labile group.

Another preferred embodiment of the present disclosure is a method of generating a DNA sequence comprising:
a) selecting suitable oligonucleotide subchains for the assembly of the DNA sequence, wherein the subchains are designed so that the DNA sequence is formed by the annealed subchains;
b) parallel synthesis of the subchains on a solid support, wherein the subchains are from about 75 to about 150 nucleotides in length;
c) annealing the subchains;
d) ligating the annealed subchains to generate the DNA sequence.

In preferred embodiments, the DNA sequence produced by the above method is about 100 bp to 1,000 bp in length, preferably 1,000 bp to 10,000 bp in length, and more preferably 10,000 bp to 100,000 bp in length. Given the ability to synthesize any arbitrary set of oligonucleotides to assemble the DNA sequence, a variety of different DNA sequences may be produced using the above method, including but not limited to genes, gene fragments, transposons, regulatory regions, transcription machines, expression constructs, gene therapy constructs, homologous recombination constructs, vaccine constructs, viral genomes, vectors, and artificial chromosomes. Preferably the oligonucleotide subchains synthesized are cleaved from the solid support before the subchains are annealed, preferably using a restriction endonuclease enzyme, or, if the oligonucleotide subchains are synthesized such that they contain one or more reverse-U linkers, they are preferably cleaved from the solid support with RNase A. Alternatively a predetermined set of oligonucleotide subchains are cleaved from the solid support before the subchains are annealed, and these predetermined subchains are then preferably annealed to subchains attached to the solid supports In an another preferred embodiment, the oligonucleotide subchains are designed so that gaps are present in the duplex DNA sequence formed by the annealed subchains, and the gaps are preferably filled in with a DNA polymerase.

Yet another preferred embodiment of the present disclosure is a method of generating a DNA sequence comprising:
a) selecting suitable oligonucleotide subchains for the assembly of the DNA sequence, wherein the subchains are designed so that the duplex DNA sequence is formed by the annealed subchains;
b) parallel synthesis of the subchains on a solid support, wherein a 98% coupling efficiency or greater per step of oligonucleotide synthesis is achieved;
c) annealing the subchains;
d) ligating the annealed subchains to generate the DNA sequence.

A preferred embodiment of the present disclosure is a method of generating a library of short RNA molecules comprising:
a) synthesizing an array of selected oligonucleotides on a substrate, wherein the selected oligonucleotides comprise an RNA polymerase promoter sequence, wherein the substrate comprises protected initiating moieties at specific reaction sites on the substrate, comprising:
   i) contacting the substrate with a liquid solution comprising one or more photo-reagent precursors, such that the liquid solution is in contact with the protected initiating moieties;
   ii) isolating the specific reaction sites;
   iii) selectively irradiating isolated reaction sites to produce one or more photo-generated reagents, wherein the photo-generated reagents are effective to deprotect the initiating moieties at the irradiated reaction sites;
   iv) contacting the substrate with a monomer, wherein the monomer comprises an unprotected reactive site and a protected reactive site, under conditions such that the unprotected reactive site of the monomer couples with the deprotected initiating moieties so as to create an attached monomer and protected initiating moieties;
   v) repeating steps (i)-(iv) until the array of selected oligonucleotides has been synthesized;

wherein the selected oligonucleotides comprise two specific primer sequences for DNA amplification;
b) cleaving of the selected oligonucleotides from the solid support;
c) amplifying the selected oligonucleotides using primers that recognize the specific primer sequences, wherein double stranded DNA comprising the sequences of the selected oligonucleotides is generated;
d) in vitro transcription of the amplified double stranded DNA using an RNA polymerase that recognizes the RNA promoter sequence, wherein a library of short RNA molecules is generated.

In a preferred embodiment of this method, short RNA molecules generated are short interfering RNA (siRNA) molecules. In another preferred embodiment, the selected oligonucleotides comprise one or more reverse-U linkers, which allows the selected oligonucleotides to be cleaved from the solid support using RNase A, and/or comprise one or more restriction enzyme sites. The RNA polymerse used for the in vitro transcription in the above method is preferably 17 RNA polymerase, SP6 RNA polymerase, or T3 RNA polymerase.

Another preferred embodiment of the present disclosure is a method of large-scale Single Nucleotide Polymorphism (SNP) detection in a DNA sample comprising:
a) designing an array of primer pairs that will amplify an array of amplicons from the DNA sample, wherein each amplicon comprises one or more SNPs;
b) synthesizing the array of primer pairs on a substrate, wherein the substrate comprises protected initiating moieties at specific reaction sites on the substrate, comprising:
   i) contacting the substrate with a liquid solution comprising one or more photo-reagent precursors, such that the liquid solution is in contact with the protected initiating moieties;
   ii) isolating the specific reaction sites;
   iii) selectively irradiating isolated reaction sites to produce one or more photo-generated reagents, wherein the photo-generated reagents are effective to deprotect the initiating moieties at the irradiated reaction sites;
   iv) contacting the substrate with a monomer, wherein the monomer comprising an unprotected reactive site and a protected reactive site, under conditions such that the unprotected reactive site of the monomer couples with the deprotected initiating moieties so as to create an attached monomer and protected initiating moieties;
   v) repeating steps (i)-(iv) until the array of selected oligonucleotides has been synthesized;
   wherein a single primer pair is synthesized in each reaction site on the substrate;
b) DNA amplification of the amplicons using the primer pairs, wherein a single amplicon is generated in each reaction site on the substrate;
c) detection of the one or more SNPs present in each amplicon

In preferred embodiments of the present disclosure, the one or more SNPs present in each amplicon are detected by PCR, Oligonucleotide Ligation Assay (OLA), mismatch hybridization, Single Base Extension Assay, RFLP detection based on allele-specific restriction-endonuclease cleavage, or hybridization with allele-specific oligonucleotide probes.

Yet another preferred embodiment of the present disclosure is a method of large-scale Single Nucleotide Polymorphism (SNP) detection in a DNA sample comprising:
a) designing an array of primer pairs that will amplify an array of amplicons from the DNA sample, wherein each primer pair will only amplify an amplicon if a particular SNP is present in the DNA sample;
b) synthesizing the array of primer pairs on a substrate, wherein the substrate comprises protected initiating moieties at specific reaction sites on the substrate, comprising:
   i) contacting the substrate with a liquid solution comprising one or more photo-reagent precursors, such that the liquid solution is in contact with the protected initiating moieties;
   ii) isolating the specific reaction sites;
   iii) selectively irradiating isolated reaction sites to produce one or more photo-generated reagents, wherein the photo-generated reagents are effective to deprotect the initiating moieties at the irradiated reaction sites;
   iv) contacting the substrate with a monomer, wherein the monomer comprising an unprotected reactive site and a protected reactive site, under conditions such that the unprotected reactive site of the monomer couples with the deprotected initiating moieties so as to create an attached monomer and protected initiating moieties;
   v) repeating steps (i)-(iv) until the array of selected oligonucleotides has been synthesized;
   wherein a single primer pair is synthesized in each reaction site on the substrate;
b) DNA amplification of the amplicons using the primer pairs, wherein the amplification of an amplicon indicates the presence of a particular SNP in the DNA sample.

A preferred embodiment of the present disclosure is a method of generating an oligonucleotide library comprising:
a) synthesizing an array of selected oligonucleotides on a substrate, wherein the selected oligonucleotides comprise two specific primer sequences and a variable region of sequence, wherein the substrate comprises protected initiating moieties at specific reaction sites on the substrate, comprising:
   i) contacting the substrate with a liquid solution comprising one or more photo-reagent precursors, such that the liquid solution is in contact with the protected initiating moieties;
   ii) isolating the specific reaction sites;
   iii) selectively irradiating isolated reaction sites to produce one or more photo-generated reagents, wherein the photo-generated reagents are effective to deprotect the initiating moieties at the irradiated reaction sites;
   iv) contacting the substrate with a monomer, wherein the monomer comprising an unprotected reactive site and a protected reactive site, under conditions such that the unprotected reactive site of the monomer couples with the deprotected initiating moieties so as to create an attached monomer and protected initiating moieties;
   v) repeating steps (i)-(iv) until the array of selected oligonucleotides has been synthesized;
b) cleavage of the selected oligonucleotides from the solid support;
c) DNA amplification of the selected oligonucleotides using primers that recognize the specific primer sequences, thereby generating an oligonucleotide library of double stranded DNA sequences comprising the variable region sequences of the selected oligonucleotides.

### BRIEF DESCRIPTION OF THE SEVERAL VIEWS OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1. Schematic illustration of the technologies used to generate pools of oligonucleotides as disclosed herein.

FIG. 2. Schematic illustration of the structure and operation of a microfluidic array reactor chip.

FIG. 3. A comparison of conventional acid-catalyzed with the deprotection reaction using PGA in oligonucleotides synthesis. DMT=4,4′-dimethoxytriphenylmethyl.

FIG. 4. An illustration of an oligonucleotides synthesis process. In the diagram: L-linker group; Pₐ-acid-labile protecting group; H⁺-proton; T, A, C, and G-nucleophosphoramidite monomers; hv-proton.

FIG. 5. Synthesis of U-phosphoramidite.

FIG. 6. A schematic of a preferred embodiment for oligonucleotide synthesis.

FIG. 7. Schematic illustration of purification by the hybridization method.

FIG. 8. Basic element of a cascade synthesizer: (a) small DNA fragments are synthesized in individual reactors; (b) the synthesized small DNA fragments are cleaved in the individual reactors, and directed to another reactor for assembly through hybridization and ligation.

FIG. 9. Design of a cascade synthesizer array chip.

FIG. 10. Schematic of fusion PCR for multi-stage long gene assembling.

FIG. 11. Large-scale SNP detection on a Super Micro Plate. Pairs of specific primers are synthesized in situ in the same reaction cell, the target sample and reagents are added to the reaction cell, the primers are cleaved from the substrate, and different amplicons are amplified by PCR in each reaction cell. The pool of amplicons is subsequently collected and purified, and the SNPs present in the amplicons are detected and identified.

FIG. 12. Ampflication of single stranded RNA molecules using universal primers and the T7 promoter, amplification of single stranded DNA using primers which introduce a nicking site that allows DNA polymerase to extend and displace the DNA strand, thereby generating single stranded DNA.

FIG. 13. Schematic illustration of a preferred embodiment for detecting SNPs using an amplification and detection chip.

FIG. 14. Schematic illustration of generating two primers from a single oligonucleotide synthesized on a solid substrate by incorporating two reverse-U linkers into the oligonucleotide, and cleaving the linkers with RNase A to produce two primers that can be used for DNA amplification to generate a pool of oligonucleotides.

FIG. 15. Schematic illustration of the generation of a pool of short RNA molecules.

FIG. 16. The Puc2 probe hybridized strongly with the Puc2PM control sites (intensity=˜40,000), hybridized less strongly with the Puc2MM control sites (intensity=˜10,000), and did not hybridize significantly with any other sequences on the chip.

FIG. 17. Subchain GFP oligonucleotides were synthesized on a chip and subsequently ligated to generate the full-length GFP gene. The full-length GFP gene was amplified using PCR. Lanes A: used GFP-N3 and GFP-C2 as primers for PCR and Pfu as the DNA polymerase; Lanes B: used GFP-N3 and GFP-C2 as primers for PCR and Taq (SureStart) as the DNA polymerase; and Lanes C: used GFP-F2 and GFP-R17 as primers for PCR and Pfu as DNA polymerase. For TO.75ul, T3ul, and T12ul, 0.75 μl, 3.0 μl, and 12 μl of oligonucleotides synthesized on the chip respectively were used for the ligation reaction. C1nM and C10nM are positive control ligations that used oligonucleotide concentrations of 1 nM or 10 nM.

FIG. 18. pTrcHis-ChipGFP-TA clones digested with EcoRI and BamHI. A total of 11 clones out of 30 analyzed contained the full-length GFP gene synthesized using the disclosed methods.

FIG. 19. pTrcHis-ChipGFP-TA clones induced by IPTG on LB agar plates. If the clone contains a full-length functional GFP gene synthesized using the disclosed method, then the colony will fluoresce green. Excluding the two positive and negative controls on each plate, 78 of the 256 colonies (30.5%) fluoresced green, and therefore contained a functional fill-length GFP gene.

FIG. 20. PCR amplified GFP product. Lane 1 is a DNA ladder; lane 2 is the control fraction of the assembled full-length GFP DNA; and lane 3 is the T7 endonuclease I treated fraction of the assembled full-length GFP DNA. The results indicate that T7 endonuclease I does digest some of the ligated GFP DNA products.

FIG. 21. The functionality of ligated GFP constructs was observed under UV illumination. Clones containing a functional copy of the GFP construct emitted green fluorescence when they were expressed in E. coli.

FIG. 22. DNA fragments fusion by PCR. Four, six, or eight DNA fragments from GFP gene was mixed and diluted to a series of concentration for PCR. Lanes are labeled 2-6, which indicate the dilution of the template DNA: lane 2, 1:4; lane 3, 1:16; lane 4, 1:64; lane 5, 1:256; lane 6, 1:1024. This experiment demonstrates that four, six, or eight DNA fragments can be fused to generate long DNA sequences.

FIG. 23. Dpn II digested GFP-F2part/DpnIISite oligonucleotides in solution and control. After one hour approximately 80% of the GFP-F2part/DpnIISite oligonucleotides were released from the solid substrate into solution.

FIG. 24. Hybridization specificity by mismatch and deletion tests.

FIG. 25. Illustration of synthesis of oligomers up to 100 nucleotides in length was demonstrated on a microfluidic array chip.

FIG. 26. Synthesis of oligomers up to 100 nucleotides in length was demonstrated on a microfluidic array chip.

FIG. 27. Comparison of step yield for 15-mer to 100-mer oligonucleotides for dual chip.

FIG. 28. A design of a microfluidic array chip for use in synthesizing oligonucleotides which are subsequently ligated together to generate a large DNA product.

FIG. 29. An agarose gel shows that the 60-mer PCR products generated from a pool of oligonucleotides were of the expected size, and that SAP1 digestion of the PCR products yielded the expected 41 bp and 19 bp products.

FIG. 30. Analysis of RNA molecules produced in vitro from a pool of oligonucleotide sequences synthesized on a solid substrate according to the methods disclosed herein.

### DETAILED DESCRIPTION OF THE INVENTION

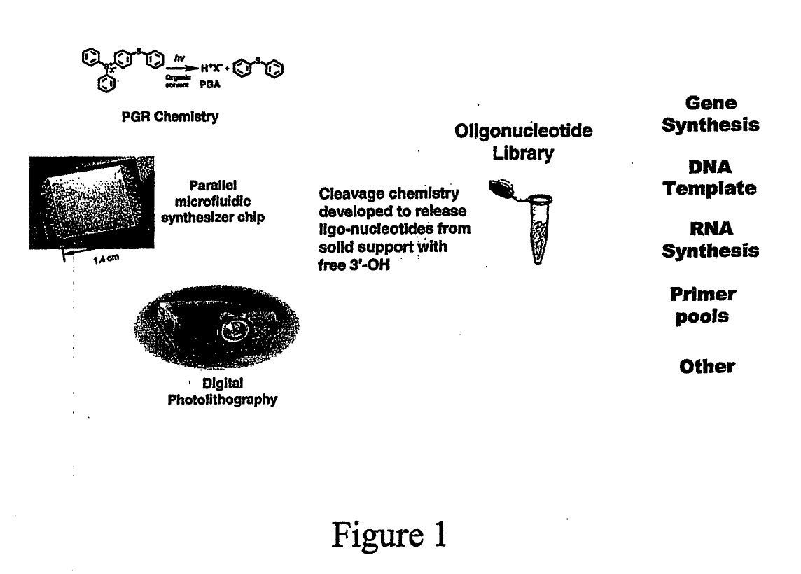

This present disclosure is directed to a multiplex parallel DNA synthesis system based on an integrated microfluidic microarray platform for parallel production of oligonucleotides. This system utilizes photogenerated acid chemistry, parallel microfluidics, and a programmable digital light controlled synthesizer to generate oligonucleotide libraries, which have many different applications (FIG. 1). Based on this technology In a preferred embodiment, a self-contained parallel synthesis system embodying a powerful combination of array synthesis chemistry, surface chemistry, digital photolithography, and microfluidics, is used to synthesize oligonucleotides on a solid substrate. Preferably the synthesized oligonucleotides are cleaved from the solid surface to produce pools of oligonucleotides. In other preferred embodiments, the methods of the present disclosure are used to generate pools of DNA or RNA oligomers. The applications for pools of oligomers include but are not limited to using the oligonucleotides to generate long DNA sequences, including any arbitrary sequence; primers for PCR template amplification; primers for multiplexing PCR and transcription; short RNA fragments, for example RNAi (RNA interference) or siRNA (short interfering RNA); DNA fragments for SNP (single nucleotide polymorphism) detection and sample preparation; and DNA, RNA, oligonucleotide, and/or combinatorial libraries. The pools of oligomers can also be used to provide libraries for genomic and proteomic applications, including de novo protein design, vaccine development, drug screening (molecular evolution), including oligonucleotide based drug screening, and many other applications that require the use of large pools of oligonucleotides.

In preferred embodiments of the present disclosure, PGA chemistry, as disclosed in U.S. Pat. No. 6,426,184, incorporated herein by reference, is used for the multiplex parallel DNA synthesis system disclosed herein for parallel production of oligomers. Using a microfluidic array chip as a multiplexing reactor, a Digital Light Projector as a reliable reaction controller, and highly optimized conventional phosphoramidite and acid-labile protection chemistry as the underlying synthesis chemistry, the disclosed system produces a large number of high-quality oligonucleotides in a massive parallel fashion and in a self-contained small device.

In preferred embodiments disclosed herein, sequences of known compositions are synthesized at known locations on a solid support. For example, in one square millimeter area, there are at least 1 up to 4 different sequences, at least 4 up to 10 different sequences, at least 10 up to 100 different sequences, at least 100 up to 400 different sequences, at least 400 up to 10,000 different sequences, and at least 10,000 up to 1,000,000 different sequences. Until now, the most efficient high-throughput process for making large numbers of oligonucleotides using conventional synthesis chemistry involved the use of robotic liquid delivery and 96 or 384 titer plates. The present disclosure provides for 10-10³ fold improvement on throughput and greatly reduced production costs for synthesizing pools of oligomers, pools of oligonucleotides, and oligonucleotide libraries.

This parallel synthesis system may also be modified to synthesize a variety of molecules, such as RNA, carbohydrates, small organic molecules, peptides and peptidomimetics. Molecules that are synthesized on a chip may be released into solution and applied to biological assays and molecular computing, used as sensors or bacterial/viral detection probes, and assembled into large molecular complexes, such as genes, gene fragments, transposons, regulatory regions, transcription machines, expression constructs, gene therapy constructs, homologous recombination constructs, vaccine constructs, viral genomes, vectors, and artificial chromosomes.

One preferred embodiment of the present disclosure is directly inserting the pool of oligomers, for example DNA or RNA oligomers, into a vector to create a library of new clones containing inserts of specific known sequences. The number of different clones that can be generated from a pool of synthesized oligonucleotides is at least about 100 up to 1,000, at least about 1,000 up to 8,000, at least about 8,000 up to 50,000, and at least about 50,000 up to 100,000 clones. In another preferred embodiment of the present disclosure, the pool of oligomers is amplified using methods well-known to those of skill in the art, for example PCR. In yet another preferred embodiment of the present disclosure, pools of DNA templates are generated that are used for in vitro RNA transcription to generate pools of RNA sequences according to sequence specific designs. This system makes possible the routine generation and use of large oligonucleotide libraries, synthetic genes, and combinatorial libraries.

Several technologies are required for practicing the present disclosure including, for example: photogenerated acid/reagent activation of chemical reactions and digital photolithographic synthesis of chemical/biochemical compounds (U.S. Pat. No. 6,426,184, incorporated herein by reference), microfluidic array reactors (U.S. Ser. No. 09/897,106, incorporated herein by reference), enzymatic purification of oligonucleotides (U.S. Ser. No. 09/364,643, incorporated herein by reference), oligonucleotide synthesis, oligonucleotide library design for large DNA synthesis, an integrated parallel synthesis system using microfluidic microarray reactors and optical modules, a software package for operating the instrument, and a software package for the design of oligonucleotide libraries for large DNA synthesis, as described herein.

A. Photogenerated Acid/Reagent Activation of Chemical Reactions

The present DNA system preferably and advantageously employs photogenerated acids (PGA) to enable conventional or standard oligonucleotide synthesis chemistry in a highly parallel manufacturing process. The use of PGA chemistry for the parallel synthesis of molecular sequence arrays on solid surfaces was first disclosed in U.S. Pat. No. 6,426,184, incorporated herein by reference. PGA chemistry replaces at least one of the reagents for synthesizing oligonucleotides in a reaction with a photo-reagent precursor. Therefore, unlike previously known methods that require monomers containing photo-labile protecting groups or a polymeric coating layer as the reactive medium, the present disclosure uses monomers of conventional chemistry and requires minimal variation of the conventional synthetic chemistry and protocols. Additionally, the special photo-labile group protected monomers used in earlier methods for synthesizing oligonucleotides on a chip cannot be stored in large quantities since they have short shelf lifetimes.

The conventional chemistry utilizing photogenerated acids adopted by the present disclosure routinely achieves better than 97-99% yield per step synthesis of oligonucleotides, which is far better than the 82-97% yield and low purity products obtained by the previously known methods of using photo-labile protecting groups for photolithographic on-chip parallel synthesis. Fodor et al., Science 251:767-73 (1991); Pirrung et al., J. Org. Chem. 60:6270-6276, (1995); McGall et al., J Am. Chem. Soc. 119:5081-5090 (1997); McGall et al., Proc. Natl. Acad. Sci. USA 93:13555-13560 (1996). This improved stepwise yield is critical for synthesizing high-quality oligonucleotide arrays for diagnostic and clinical applications, and also allows for the synthesis of oligonucleotides of much longer length, for example from 50 to 200 nucleotides. For example, for synthesizing a 50-mer oligonucleotide, a stepwise yield of 92% would lead to only 0.92⁵⁰=1.5% of the synthesized oligonucleotides becoming full-length products, while a stepwise yield of 99% would lead to 0.99⁵⁰=60.5% of the synthesized oligonucleotides becoming full-length product. This dramatic increase in the percentage of synthesized fill-length oligonucleotides results in greater sensitivity for assays on a chip, as well as increases the number of applications for the pools of oligonucleotides generated.

In preferred embodiments, the presently disclosed chemistry can be used to synthesize oligonucleotides that are about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 105, 110, 115, 120, 125, 130, 135, 140, 145, 150, 155, 160, 165, 170, 175, 180, 185, 190, 195, or 200 nucleotides in length. In other preferred embodiments, the stepwise yield of the presently disclosed chemistry allows for greater percentages of fill-length oligonucleotide products being produced. For example, in preferred embodiments, an oligonucleotide of any of the above desired lengths is synthesized so that at least about 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or 100% of the oligonucleotide products synthesized are full-length. The ability of PGA chemistry to generate longer oligonucleotides greatly enhances the range of applications for these synthesized oligonucleotides.

A PGA synthesis system may contain an acid precursor, a photosensitizer, a stabilizer, and a solvent. Acid precursors produce acids upon excitation, either by photons or by energy transferred through interactions with other excited molecules (photosensitizer). DeVoe et al., Photochem 17:313-55 (1992). By selecting the proper photosensitizers, acids can be produced at a desired wavelength. The stabilizers are suitable radical H donors and thus may enhance acid formation. Table I lists examples of compounds suitable for use with the present disclosure.

TABLE I
Examplary PGA Precursors, Photosensitizers, and Stabilizers
(R, Ri = substitution groups):

| | | |
|---|---|---|
| | | Acid |
| Name | Chemical Structure | Produced |

Photoacid Precursor

| | | |
|---|---|---|
| Sulfonium salts | 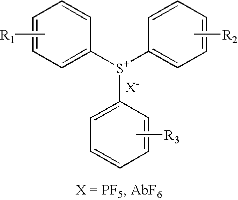 | HX, BF₃ |
| Iodonium salts | 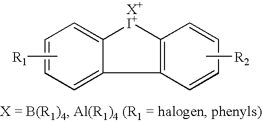 | HX, BF₃ |
| Perhalo- triazines | 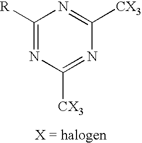 | HX |
| Diazoquione/ ketone sulfonate | 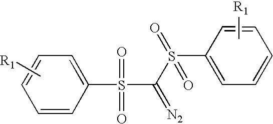 | RSO₃H R₁PhSO₃H |
| Dimethoxy- benzolnyl- carbonates or carbamates | 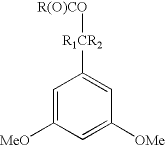 | RCO₂H |
| o-Nitro- benzyloxy carbonates or carbamates | 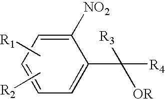 | R₅CO₂H CF₃SO₃H |

Photosensitizer

| | |
|---|---|
| 1-chloro-4- isopropoxy- 9H- thioxanthen- 9-one | 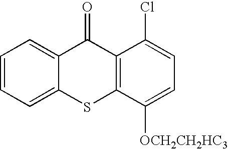 |

Stabilizer

| | |
|---|---|
| Propylene carbonate | 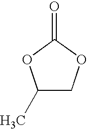 |
| Cyclohexene | 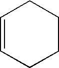 |

Table I lists only a few candidates for making PGAs (Süs, V. O., Liebigs Ann Chem 556:65-84, 1944; Fréchet, J. M., Pure & Appl Chem 64:1239-48, 1992; Fouassier et al., Pure & Appl Chem A31:677-701, 1994; Crivello, J. V., Adv Polymer Sci 62:3-49, 1984; incorporated herein by reference), and there are many other compounds that have been widely used in photoresist formulations for microelectronics and printing industries (Willson, C. G. (1994) “Organic resist materials,” in Introduction to Microlithography, Eds. Thompson, L. F., Willson, C. G., and Bowden, M. J., Am Chem Soc Washington D.C. pp. 138-267; MacDonald et al., Acc Chem Res 27:151-57, 1994; U.S. Pat. No. 5,158,885; incorporated herein by reference). Such compounds are potential candidates for the DNA deblock reactions (deprotection of 5′-ODMT groups), providing a repertoire of reagents for acid-catalyzed deprotection reactions (Greene, T. W. (1991) “Protective groups in organic synthesis,” 2nd ed. John Wiley & Sons: New York, incorporated herein by reference).

B. Microfluidic Reactor for Multiplex Parallel Oligomer Synthesis

The synthesis system for a microfluidic reactor for multiplex parallel oligomer synthesis includes a digital light projector (DLP) optical module, a microarray reactor assembly, a reagent manifold, and a computer control system. A microarray reactor assembly is composed of a microfluidic array chip and a chip holder or cartridge that facilitates the liquid connection between the microfluidic array chip and a reagent manifold. In a preferred embodiment, the microfluidic array chip of the present disclosure has a significantly simplified structure and more robust mechanism of operation than currently available devices for parallel performance of discrete chemical reactions (U.S. Ser. No. 09/897,106, incorporated herein by reference). An important feature of the microfluidic chip is that it preferably does not require any complicated built-in valves, pumps, and electrodes, which would add complexity in manufacturing processes and lower the robustness and reliability of the chip operation. This design is preferable to all other current state-of-art microfluidic-based technologies, which require complex built-in mechanisms to control the delivery of chemical reagents of different amounts and/or different kinds into individual corresponding reaction vessels, which facilitate different chemical reactions in the individual reaction vessels (U.S. Pat. No. 5,846,396).

The system disclosed herein allows the above-mentioned chemical synthesis process to be carried out in a highly parallel fashion. The disclosed microfluidic array chip is a (external) pressure driven device and is made of a silicon substrate containing channels which are arranged such that reagents are distributed to discrete reaction cells. In predetermined reaction cells reactive chemical reagents are generated in situ by light exposure from an external light source. The chip itself can be miniaturized. An exemplary chip (for bioassay applications) measures approximately 1.5×2.0×0.1 cm, contains up to approximately 27,000 discrete reaction cells, and has a total internal volume of only 10 μl. Within the chip, the cross-section dimensions of the fluid channels and reaction cells are very small (on the order of tens of microns), and the mass transfer between the surface and the liquid is significantly enhanced as compared to larger sized reactors. This design significantly enhances the rate of chemical reactions during the chemical synthesis.

A key factor in utilizing a photogenerated reagent in a solution phase to carry out different chemical reactions on discrete surface sites is the isolation of reaction sites during the chemical reaction so that the active reagent (e.g. H⁺) generated at one location does not infiltrate adjacent sites. The presently described microfluidic array chip prevents the intermixing of active reagents between discrete reaction cells as long as certain fluid flow conditions are maintained. The chip is highly miniaturized with a total internal volume of only 10 μl and individual reaction cell volume of sub-nl. In other preferred embodiments, the total internal volume of the chip is about 1, 2, 3, 4, 5, 6, 7, 8, 9, 10, 11, 12, 13, 14, 15, 16, 17, 18, 19, 20, 25, 30, 35, 40, 45, or 50 μl. The chip is constructed using simple techniques and the materials used (preferably silicon and glass) are fully compatible with oligonucleotide synthesis chemistry.

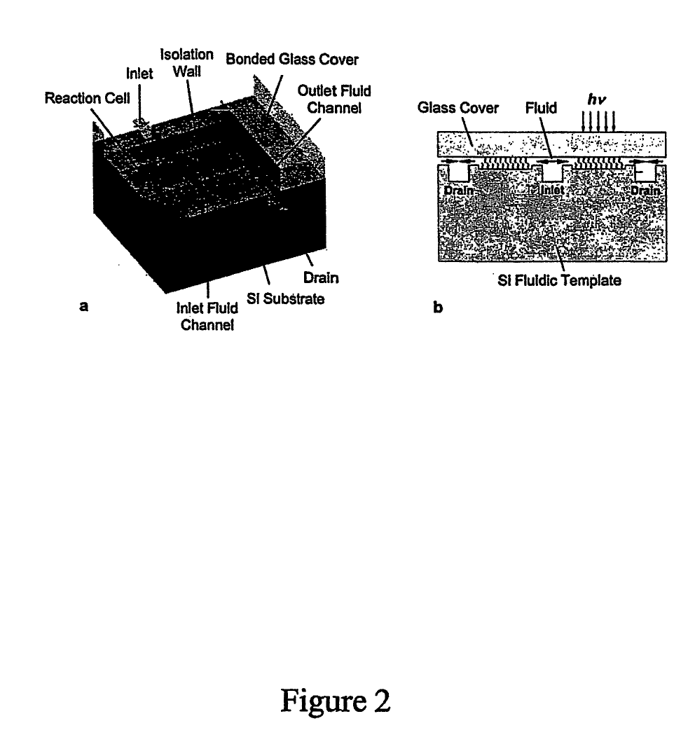

A preferred embodiment of the chip is shown in FIG. 2. This chip is designed to make 4,000 different oligonucleotides (or any other types of bimolecular compounds), measures about 20 mm×15 mm×1 mm, and has a total internal volume of only 10 μl. Each chip is made of a silicon substrate on which fluid channels and reaction cells are fabricated using standard semiconductor etching processes (Madou, Fundamentals of Microfabrication, CRC Press, New York (1997), incorporated herein by reference). The chip is anodically bonded with a glass cover through which light can pass through to facilitate photochemical reaction and fluorescence detection.

A description of the operation principle of the chip is as follows. As shown in FIG. 2a, during the operation of synthesizing oligonucleotides, a fluid stream flows into the array chip through an inlet and splits into side streams that enter reaction cells along the inlet fluid channel. Adjacent reaction cells are separated from each other by the isolation walls between them. The top surface of the isolation walls is bonded with the lower surface of the glass cover and therefore the side streams in the adjacent reaction cells do not mix with each other through the isolation walls. After passing through the reaction cells, the side streams merge into the outlet fluid channel and flow out of the array chip into the drain. During a photochemical reaction, as shown in FIG. 2b, a fluid containing a photogenerated reagent precursor is sent into the array chip and a light beam is directed at the reaction cell on the right so that an active reagent is produced inside the illuminated reaction cell on the right and no active reagent is generated inside the un-illuminated reaction cell on the left. At a suitable fluid flow condition, the flow rate into the reaction cell on the right is high enough to prevent the active reagent from diffusing back into the inlet channel, thus preventing any active reagent from entering the reaction cell on the left. With this structural and operational design each individual reaction cell is dynamically isolated and a plurality of discrete chemical reactions can be conducted in parallel among any arbitrarily selected group of reaction cells.

In other preferred embodiments, alternative flow conditions can be used for the operation of the disclosed microfluidic array chip. For example, the fluid inside the chip can be maintained static during light illumination periods as long as the time is short enough so that the diffusion of the active reagents generated at the illuminated reaction cells to the un-illuminated reaction cells is not enough to cause significant reactions at the un-illuminated reaction cells.

The microfluidic array chip is essentially a multiplexing reactor in which chemical reactions take place on the interior surfaces of individual reaction cells. The interior surface of the reaction cell is composed of a lower surface of the glass window, the upper surface of the silicon substrate, and the side surface of the isolation walls. The interior surface is preferably made of silicon dioxide, or for example other type of appropriate compounds such as functionalized polymers, and derivatized with linker molecules to facilitate oligonucleotide synthesis, as described herein. Although the linker surface density can be greater than 1 pmole/mm², experiments indicate that in order to achieve high stepwise yield for the oligonucleotide synthesis, the proper surface density is about 0.1 to 0.3 pmole/mm². With the surface density fixed the surface area of the reaction cells and the reaction yield determine the quantity of oligonucleotides produced.

In cases where significantly higher quantities of oligonucleotide subchains are required for the ligation reaction, the microfluidic array chip design may be modified to include porous materials in the reaction cells, thereby increasing substrate surface areas for oligonucleotide synthesis. With this approach, a ten to a hundred fold increase in the quantity of oligonucleotides synthesized may be obtained without significantly changing the overall size of the microfluidic array chip and the synthesis protocols. In one embodiment, a controlled porous glass film is formed on the silicon wafer during the chip fabrication process. A borosilicate glass film is deposited by plasma vapor deposition on the silicon wafer. The wafer is thermally annealed to form segregated regions of boron and silicon oxide. The boron is then selectively removed using an acid etching process to form the porous glass film, which is an excellent substrate material for oligonucleotide synthesis.

Another alternative embodiment is to form a polymer film, such as cross-linked polystyrene. A solution containing linear polystyrene and UV activated cross-link reagents is injected into and then drained from a microfluidic array chip, leaving a thin-film coating on the interior surface of the chip. The chip, which contains opaque masks to define the reaction cell regions, is next exposed to UV light so as to activate crosslinks between the linear polystyrene chains in the reaction cell regions. This step is followed by a solvent wash to remove non-crosslinked polystyrene, leaving the crosslinked polystyrene only in the reaction cell regions. Crosslinked polystyrene is also an excellent substrate material for oligonucleotide synthesis.

C. Digital Lithography

A fundamental enhancement to currently available systems includes the application of Maskless-Digital Photolithography (MDP) technology. The digital photolithography described herein provides major advantages over both inkjet- and photomask-based approaches for parallel DNA synthesis. Photolithography has inherently much higher resolution than mechanical-inkjet-based methods and is therefore more suitable for automation and miniaturized chemical reactions. Thus, an important component in the present disclosure is the programmable spatial optical modulator, i.e., Digital Micromirror Device (DMD, Texas Instruments). DMD is a reflective display device that is commercially available from Texas Instruments for making projection TV- and computer-displays with a Digital Light Projector (DLP). By modifying the projector optics, the DLP is converted into a MDP system, which is essentially a micro-projector. As such, the photomask, which is required in a conventional photolithographic system, is eliminated.

A DMD contains a plurality of micro-mirrors arranged in a square matrix with x and y pitches of 17 μm×17 μm. The mirrors are integrated with silicon-based integrated circuits and can be individually controlled to rotate around their own axis. Depending on the tilting angle of each mirror, it reflects incident light either into or out of the pupil of a projection lens, thereby producing an image on a screen. Using this device, photomasks can be eliminated from a photolithographic system which eliminates some of the most restrictive and expensive processes of previous DNA-microarray fabrication technology.

In other preferred embodiments of the synthesizer, a mercury lamp is used as the light source. A bandpass optical filter, with center wavelengths ranging from 350 to 450 nm, is used to select adequate wavelengths for the excitation of photoacids. A 768×1024 DMD is used to generate light patterns, and a 75 to 100-mm lens is used as the projection lens to project images onto the microfluidic array chip surface. At the chip surface, each projected pixel measures about 30×30 μm. A flux density of about 10 to 30 mW/cm² will be generated at the surface of the microfluidic array chip. A pellicle beam splitter and a CCD video camera is used to facilitate optical alignment. A commercial DNA/RNA synthesizer (PerSeptive Expedite 8909) is used, without any alternation, as a reagent manifold. A microfluidic array chip is placed in a cartridge, which facilitates the liquid connection between the microfluidic chip and the reagent manifold. The cartridge is mounted on a xyz translation stage and a tilt platform for alignment. Computer software (ArrayDesigner) written in C++ is used to generate light patterns based on predetermined DNA-sequence layouts on an array.

In another preferred embodiment, a semiconductor violet laser diode having a wavelength at 405 nm and continuous output power of 30 mW is used as the light source. The laser diode is commercially available from Nichia (Anan-Shi, Tokushima, Japan) and weighs less than 10 grams. A compact lens with a relatively short focal length is used as the projection lens to reduce the size of the optical system. A compact reagent manifold is constructed to reduce reagent consumption, to add recycling mechanisms, and to integrate with the microfluidic array chip and the optics. Preferably a self-contained and portable parallel synthesis instrument is used for the disclosed methods of generating pools of oligomers.

In another preferred embodiment of the projection system, a UV light emitting diode (LED) is used as the light source for the DLP projector. UV LED is commercially available from Cree Inc. (Durham, N.C.) as well as Nichia (Anan-Shi, Tokushima, Japan). These UV LEDs have wavelengths ranging from 375 nm to 410 nm and power ranging from sub-mW to tens of mW.

In yet another preferred embodiment a UV LED array is used as the light source. For this embodiment, DMD optics is no longer needed for performing selective illumination on microfluidic array chips. Either one-dimensional (1D) or two-dimensional (2D) UV LED arrays can be used. The LED arrays can be made by assembling discrete LEDs on a bar or a panel. The LED arrays may also be made directly from semiconductor wafers, on which LED devices are fabricated. In the case of a 1D UV LED array, a two-dimensional image can be obtained by sweeping the 1D UV LED array along its perpendicular direction using mechanical mechanisms, electro-optical mechanisms, and/or electro-mechanical-optical mechanisms. In the case of a 2D UV LED array, simple projection lens optics can be used to project the image onto the microfluidic array chip.

Use of LED arrays to produce images is a well-known art in the fields of photonics and optics. U.S. Pat. No. 5,953,469, which is incorporated herein by reference, describes an electro-mechanical-optical method of using a 1D LED array to produce 2D images. Optical fibers and/or fiber bundles can be advantageously used to couple the light from an LED array to a microfluidic array so as to avoid the heat generated from the LED array from reaching the microfluidic array. In addition, the use of LED arrays to trigger photochemical reaction is not limited to the use of microfluidic array chips. They can be used in any photochemical applications that requires the corresponding wavelength and power. For example, UV LED arrays can also be used to make DNA arrays using photochemical methods involving photolabile protection groups (Pirrung et al., J. Org. Chem. 60:6270-6276, 1995; McGall et al., J. Am. Chem. Soc. 119:5081-5090, 1997; McGall et al., Proc. Natl. Acad. Sci. USA 93:13555-13560, 1996).

D. Oligonucleotide Synthesis

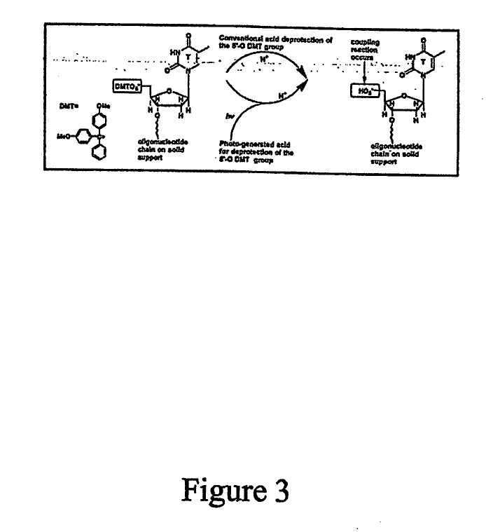

In one embodiment of the present disclosure a new chemical approach is preferably utilized to enable the well-established conventional DNA synthesis protocols for light-directed oligonucleotide synthesis (Gao et al., J Am Chem Soc 120:12698-699 (1998), incorporated herein by reference). Conventional DNA/RNA synthesis begins when linker molecules are attached to a substrate surface on which oligonucleotides sequence arrays are to be synthesized (the linker is an “initiation moiety,” a term which broadly includes monomers or oligomers on which another monomer can be added). Each linker molecule contains a reactive functional group, such as 5′-OH, protected by an acid-labile protecting group. Next, a photo-acid precursor or a photo-acid precursor and its photosensitizer are applied to the substrate, followed by a predetermined light pattern being projected onto the substrate surface. Acids such as a protic acid (H⁺) are produced at the illuminated sites, which causes deprotection of the acid-labile protecting group (e.g., 5′-O DMT group) of a linker, monomer, or nucleoside attached to the solid support, as shown in FIG. 3 (McBride and Caruthers, Tetrahedron Letter 24:245-48 (1983); Merrifield, B., Science 232:341-47 (1986)).

The reaction produces terminal 5′-OH groups, which then undergo a coupling reaction with incoming monomers to attach the monomer to the linker or to form dimers (“monomers” as used hereafter are broadly defined as chemical entities, which, as defined by chemical structures, may be monomers or oligomers or their derivatives). The attached monomers also contain reactive functional terminal groups protected by an acid-labile group. Unreacted 5′-OH groups are subsequently capped with acetyl groups. The subsequent washing and oxidation steps complete the first synthetic cycle. The H⁺ deprotection reaction is repeated to produce the terminal 5′-OH available for coupling to a second set of incoming monomers. These deprotection, coupling, capping, and oxidation steps are repeated until the desired sequences are made. This synthesis process is well-known in the field of DNA synthesis and is described by McBride and Caruthers, in Tetrahedron Letters, 24:245-48, 1983, which is hereby included herein by reference.

One preferred series of steps for performing oligonucleotides synthesis includes oligonucleotide library synthesis as shown below:
2. Derivatization of the surface of the substrate with OH functional groups;
3. Coupling of 5′-phosphoramidite, 2′, 3′-O-methoxyethylidene U to the surface OH groups;
4. Open the 2′, 3′ cyclic moiety to form 2′(3′)-O-acetyl, 2′(3′)-OH U;
5. Synthesis of oligonucleotides by coupling the first phosphoramidite monomer to the 2′(3′)-OH of U, followed by n−1 cycles of the coupling reactions, where n is the 4× length of the oligonucleotide to be synthesized;
6. Removal of the base and phosphate protecting groups from oligonucleotides bound to the solid surface;
7. Thorough washing to remove the compounds generated by the deprotection reactions while oligonucleotides being covalently bound to the support surface; and,
8. Cleaving the U-3′-HO-oligonucleotide linkage to free 3′-HO-oligonucleotides.

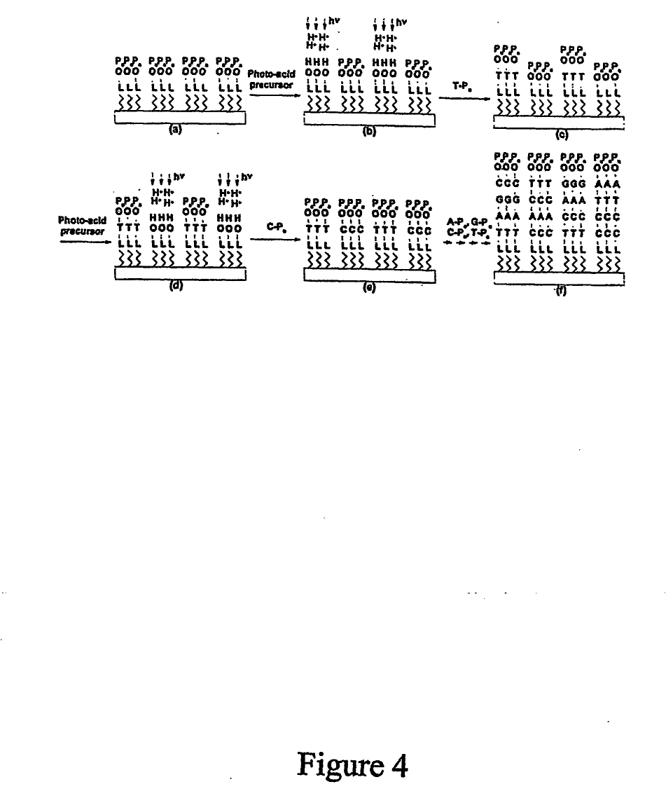

FIGS. 3 and 4 illustrate synthesis of a DNA array according to the above oligonucleotide synthesis method. In the first step, linker molecules are attached to a substrate surface (FIG. 4a). Each linker molecule contains a reactive functional group that is protected by an acid-labile group. Next, a photo-acid precursor is applied to the substrate. A predetermined light pattern is then projected onto the substrate surface (FIG. 4b). At illuminated sites, acids are produced and cause the cleavage of the acid-labile protecting groups from the linker molecules, which leads to the formation of terminal OH groups. At dark sites, no acid is produced and, therefore, the acid-labile protecting groups on the linker molecules remain intact. The substrate surface is preferably designed to prevent acid diffusion between adjacent sites. The substrate surface is then washed and subsequently supplied with the first monomer (a nucleophosphoramidite, a nucleophosphonate or an analog compound that is capable of chain growth). Monomer molecules attach only to the deprotected linker molecules (FIG. 4c). Chemical bonds are formed between the OH group of a linker molecule and phosphorus of a monomer to result in a phosphite linkage. This, after proper washing, oxidation, and capping steps, completes the addition of the first residue. The attached nucleotide monomer also contains a reactive functional terminal group protected by an acid-labile group. The chain propagation process is repeated until polymers of desired lengths and desired chemical sequences are formed at all selected surface sites (FIG. 4d-f).

The following is a more detailed description of each step for performing this preferred embodiment of oligonucleotide synthesis:

Step 1: Derivatization of Chip Surface

In a preferred embodiment, the parallel gene synthesis involves a surface containing high density functional groups, deprotection stable linkages between the surface molecules and solid support, and a cleavage point that can be specifically cleaved by enzymatic or chemical reagent to release 3′-OH oligonucleotides from the microarray surface after deprotection and wash steps. These are features that may not be necessary for conventional DNA synthesis methods using chips or other solid supports such as CPG or polystyrene beads.

In one embodiment, a SiO₂ surface (i.e., the inside surface of a microfluidic array chip reactor) is washed with H₂O followed by EtOH. A linker solution containing N-3-TriethoxySilylpropyl)-4-hydroxybutyramide is then pumped through the reactor. The derivatized internal surface of the reactor is then rinsed with 95% EtOH and cured at 105° C. under N₂. The linker thus formed is a stable linker and resists cleavage when the surface is reacted with deprotection agent for deprotection of nucleobase and phosphate protecting groups after the oligonucleotides are synthesized.

3′-phosphorylated oligonucleotides can also be synthesized on a microfluidic array substrate by using a chemical phosphorylation reagent to create a first DMT layer for subsequent oligonucleotide synthesis. These reagents are available from a number of chemical reagent suppliers, such as Glen Research (Sterling, Va.). Oligonucleotides with a 3′-phosphate can be cleaved under basic conditions, such as treatment with concentrated aqueous ammonia solution. Oligonucleotides can be deprotected without cleaving the first 3′-phosphate linkage, for example with EDA in EtOH, or they can be deprotected concomitantly with the cleavage of the oligonucleotides from the substrate.

Steps 2 and 3: Preparation of the 2′,3′-O-MethoxyethylideneU-5′-O-Support

The following reactions may be carried in parallel using either CPG or the microfluidic array substrate. Both types of supports contain the same functional groups (SiO₂) and thus permit reactions using the same types of chemistry. CPG synthesis can provide μmol of final products, which can be analyzed using conventional methods, such as direct trityl monitoring, UV, HPLC, and Mass analysis. Therefore, the CPG synthesis can help to identify and rapidly overcome some problems in the development process. The synthesis and analysis of the microfluidic array substrate are accomplished using a CCD imager or a laser scanner and image processing software, such as ArrayPro (Cybermedia).

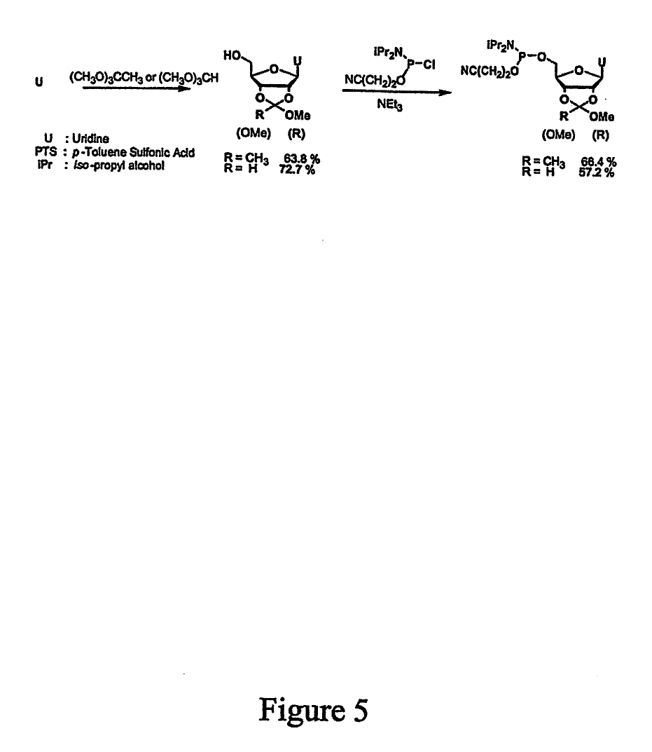

In one embodiment, the U linkage is formed by coupling the 5′-O-phosphoramidite uridine with the surface OH group through the phosphate bond formation (FIG. 5; U.S. Ser. No. 10/099,382, incorporated herein by reference). First, 2′,3′-Omethoxyethylideneuridine or 2′,3′-O-methoxymethylideneuridine is prepared according to known methods (Fromageot et al., Tetrahedron 23:2315-2331, 1967, incorporated herein by reference). These compounds are converted to the corresponding 5′-phosphoramidites using a similar procedure to that for preparing DNA nucleophoramidites (McBride and Caruthers, Tetrahedron Letters, 24:245-48, 1983). The 5′-U phosphoramidite is freshly dissolved in CH₃CN (50 mM) and used in the synthesis cycle during the coupling step. A typical synthesis process is as follows:

| Reaction | Reagent/Solvent | |
|---|---|---|
| Detritylation | 3% TCA/CH₂CI₂ or PGA-P | Use of PGA-1 in |
| | | parallel synthesis |
| Wash | CH₃CN, CH₃CN (anhydrous) | |
| Activation | tetrazole/CH₃CN | |
| Coupling | monomer/activator/CH₃CN | Special monomers, |
| | | such as 5′- |
| | | phosphoramidite- |
| | | U can be |
| | | incorporated |
| | | in this step. |
| Wash | CH₃CN | |
| Capping | 10% acetic anhydride/THF | |
| (simultaneous) | 10% Melm/THF/Pyridine (8/1) | |
| Wash | CH₃CN | |

The 2′,3′-ortho ester of U is then hydrolyzed upon treatment with 80% HOAc/H₂O at room temperature for about 2 hours, or with 3% TCA at room temperature for 6 minutes, resulting in the formation of 2′- or 3′-acetyl sugar, thereby causing one of the vicinal OH groups to become available for reaction. The surface can then be washed with suitable solvents and dried. The same reaction can also be achieved using photogenerated acids, such as H⁺, generated by light irradiation of a photogenerated acid precursor. Photogenerated acids can be used to selectively open up the 2′- or 3′-OH, thereby making the reaction sites available for the next reaction step on the microfluidic array chip. The linker-5′-O-U derivatized surface can be tested for density/loading and uniformity for subsequent oligonucleotide synthesis.

Step 4: Oligonucleotide Synthesis on the U-support

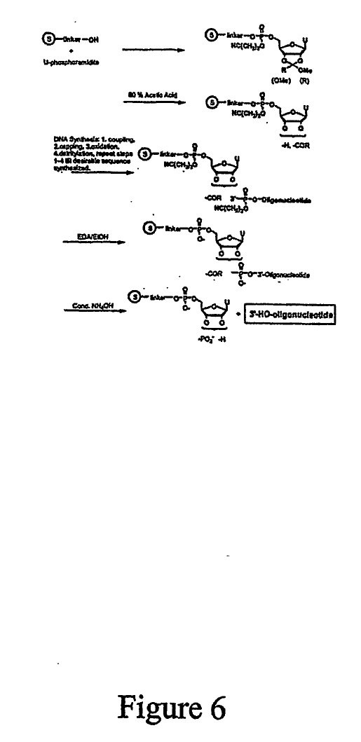

A schematic of this embodiment of oligonucleotide synthesis is shown in FIG. 6. The U-support prepared as described above, either on CPG in a column or on the microfluidic array substrate, is contacted with a 5′-DMT nucleophosphoramidite (A, C, G, or T, determined by the sequence synthesized). The coupling reaction results in the formation of a U-2′(3′)-O-[Phosphite]-O-3′-N (N is the DNA monomer) linkage and the sequence is terminated with a 5′-DMT group. Following the capping, oxidation, and detritylation reactions, a second 5′-DMT nucleophosphoramidite monomer can be coupled to the 5′-OH on the surface. The capping, oxidation, detritylation, and coupling reactions are repeated until the desired oligonucleotides are synthesized. The oligonucleotide support is then treated with TCA to remove terminal DMT groups, as well as with EDA/EtOH (1:1) to remove base and phosphate protecting groups as well as the 2′(3′)-acetyl group.

After the deprotection reactions, the oligonucleotide surface is extensively washed with suitable solvents to remove the small molecules formed from cleavage of the protecting groups. Finally, the oligonucleotides are cleaved from the surface upon treatment with aqueous ammonium hydroxide, which hydrolyzes the 2′(3′)-cyclic phosphate to produce oligonucleotides with a free 3′-OH. The linker-U moiety is also cleaved in this reaction, but does not cause any problem in the subsequent enzymatic reactions. The reaction volume recovered after cleavage reaction can be briefly evaporated to remove NH₃. A significant advantage of this embodiment of the present disclosure for synthesizing oligonucleotides is that the whole cycle of oligonucleotide synthesis from the coupling of the first nucleophosphoramidite monomer to the final collection of oligonucleotides in a tube can be completed in less than 16 hours (synthesis: 10 hours (120 steps for 40-mer products); deprotection: 2 hours; and cleavage: 4 hours).

The methods for deprotection and cleavage processes set forth above have significant advantages over the standard processes currently used. In a standard oligonucleotide synthesis manufacturing process, a deprotection step is required at the end of the synthesis cycle to remove base and phosphate protecting groups. The product of this deprotection process is a solution mixture of oligonucleotides and small compounds that are formed during deprotection. The oligonucleotides are extracted from the mixture usually by eluting through a column or using a spin column (the process- is usually called de-salt). But these processes disadvantageously demonstrate low recovery efficiency and do not provide clean separation between the oligonucleotides and small molecules. After the separation, the volumes of the collected samples often need to be reduced, further lengthening the time for oligonucleotide preparation. This process is also be problematic for pico-mole quantities of products produced in a miniaturized reactor due to potential significant sample loss and contamination. The present disclosure provides a method for overcoming these disadvantages. In this method deprotection and de-salt are followed by simple washing steps that are performed continuously in the synthesis reactor while oligonucleotide chains remain attached to the substrate surfaces. After the side products (mostly small molecules) are washed off the surface, oligonucleotides are released or cleaved and washed off from the surface in conditions free of salt contamination and in tens of μl volumes.

E. Purification of Oligonucleotides

During the synthesis of oligonucleotides on a solid substrate a monomer should be added to the growing oligonucleotide chain through bond formation with an activated function group. But because this coupling step is not 100% efficient, oligonucleotides are produced that are not full-length. Oligonucleotide chains which fail to couple properly with a monomer at a coupling step are referred to as failure oligonucleotides, and are preferably blocked or capped during the synthesis reaction to prevent their further reaction in subsequent coupling steps. If the oligonucleotide is not blocked or capped, oligonucleotides will be synthesized that have deletions and undesired sequences. Although the PGA chemistry used to generate oligonucleotides in the present disclosure greatly reduces the percentage of failure oligonucleotides by achieving better than 98% yield per step in the synthesis of oligonucleotides, failure oligonucleotides are still a problematic issue. Therefore, oligonucleotides synthesized on a solid substrate are preferably purified so that primarily full-length desired oligonucleotides are isolated from the chip in the pool of oligonucleotides.

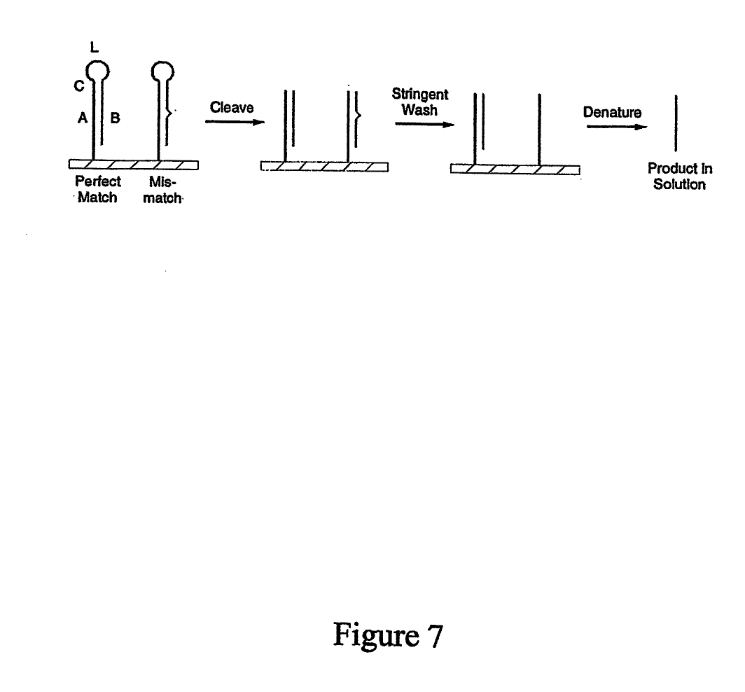

In a preferred embodiment of the present disclosure, a method is provided for purifying oligonucleotides synthesized on a chip by on-chip hybridization. As shown in FIG. 7, the oligonucleotides synthesized on a chip are designed so that they form hairpin structures, i.e. they have two regions of complementary nucleotide sequences that hybridize together, with an intervening sequence that forms the loop of the hairpin structure. In FIG. 7, the complementary sequences in the oligonucleotide are designated A and B, and the short intervening sequence is designated C. Preferably segment C contains a sequence recognized by a specific restriction endonuclease (R.E.) enzyme. In FIG. 7, segment B has the desired sequence. After synthesis of the oligonucleotide on the chip and deprotection, the hairpin structure naturally forms. The oligonucleotide is next washed with a solution containing the R.E. enzyme that cleaves the specific restriction site encoded in segment C. The sequences of recognition sites for a variety of R.E. enzymes are well known in the art. A list of R.E. enzymes and their recognition sequences is available, for example, in the New England Biolabs® Inc. Catalog, incorporated herein by reference (see http://www.neb.com), and Maniatis, T., 1990, Molecular Cloning, A Laboratory Manual, 2nd ed., Cold Spring Harbor Laboratory Press, NY, incorporated herein by reference. In another embodiment, a reverse-U (rU) or U can be incorporated into the hairpin loop region (segment C) and cleaved with RNase (see Section F. infra).

In a preferred embodiment, the solution containing the R.E. enzyme and the reaction conditions used (enzymatic cleavage temperature) are such that the double-strand oligonucleotide structure is not denatured during the cleavage. The oligonucleotide-containing substrate is next washed with a buffer solution of suitable concentration and at a suitable temperature (stringency) to remove any segment B sequences that contain one or more mismatched sites with the segment A of the same oligonucleotide. The mismatch may be a point mutation, a deletion, or an insertion, and the mismatch may be located in either segment A or B, or in both segments. Preferably the washing conditions are such that the majority of perfectly matched A and B segments remain hybridized and bound to the substrate. After the stringent wash, the oligonucleotides on the chip are subjected to denaturing conditions which release segment B from the chip, which allows for the subsequent collection of purified segment B.

Another embodiment of purification of synthesized oligonucleotides by hybridization involves synthesizing or placing oligonucleotides to be purified and their complementary strands at separate locations in one chip or in two separate chips. The desired oligonucleotides that will be purified are synthesized and cleaved from the substrate using methods disclosed herein, and then hybridized with the complementary strands that are still attached to the chip. A stringent wash is used to remove any failure or mismatched oligonucleotides, and then the purified oligonucleotides are collected after the hybridized strands are exposed to denaturing conditions.

A preferred embodiment for purifying fill-length synthesized oligonucleotides from failure oligonucleotides is to use a nuclease to digest the failure oligonucleotides, while leaving the full-length synthesized oligonucleotides intact (see U.S. Ser. No. 09/364,643, incorporated herein by reference). During synthesis of the oligonucleotides, full-length oligonucleotides are terminally blocked while failure oligonucleotides are capped. After synthesis, the oligonucleotides are treated so that the capping groups on the failure oligonucleotides are removed, but the terminally blocked oligonucleotides are not effected. The oligonucleotides are then treated with a nuclease that degrades the failure oligonucleotides while leaving the terminally blocked full-length oligonucleotides intact.

F. Cleavage of Oligonucleotides

Another important aspect of the present disclosure is the enzymatic cleavage of oligonucleotides from a solid support surface, whether the solid support is a conventional CPG substrate surface or the internal surface of a microfluidic array chip. As mentioned above, it is important that the synthesized oligonucleotides be released from the support with minimal loss and damage to the oligonucleotides themselves. One preferred method for releasing oligonucleotides from the chip is through the use of RNase enzymes, for example RNase A. RNase A is an ribonuclease that specifically cleaves 3′ of RNA U and C residues. For example, RNase A cleaves 3′ of an rU at the 3′-phosphate-3′ junction in the DNA oligonucleotides, thereby releasing the oligonucleotides from the solid surface with a 3′-OH group. The use of RNase A is efficient and is able to release oligonucleotides suitable for ligation use because they have a 3′-OH group. The recovery yield of the oligonucleotides containing rU and cleaved with RNase A is approximately 50% because some linkages of the rU to the oligonucleotides are 2′-phophate-3′, and this linkage is not cleaved by the enzyme. Improvement of cleavage efficiency is possible by using modified rU as disclosed in U.S. Ser. No. 10/099,382, incorporated herein by reference. For example, chemically synthesized modified reverse-U (rU) having a free 3′-OH and selectively protected at 2′-O would lead to the formation of 3′-phosphate-3′ DNA oligonucleotides, which can be cleaved with ˜100% yield.

Alternatively, an enzymatic approach involving the use of restriction endonuclease (R.E.) enzymes can be used to selectively and specifically cleave desired oligonucleotides from the substrate surface. R.E. enzymes generally recognize specific short DNA sequences four to eight nucleotides long, cleave DNA at a site within this sequence, and are well known to those of skill in the art. In the context of the present disclosure, R.E. enzymes may also be used to cleave DNA molecules at sites corresponding to various restriction-enzyme recognition sites, and for cloning nucleic acids. Additionally, R.E. enzymes may be used for genotype analysis, such as identifying markers and RFLP analyses. As stated earlier, the sequences of recognition sites for a variety of R.E. enzymes are well known in the art.

G. Phosphorylation of Oligonucleotides

The chemically synthesized oligonucleotides must be phosphorylated before they are connected by DNA ligase. DNA ligase catalyzes the formation of phosphodiester bond between adjacent 3′-hydroxyl and 5′-phosphate termini of DNA to join two pieces DNA. Oligonucleotide products synthesized according to the methods disclosed herein, however, have hydroxyl groups at both 3′ and 5′ ends. In the current state-of-art, chemically synthesized oligonucleotides are phosphorylated using polynucleotide kinase, which catalyzes the transfer of the y-phosphate of a nucleotide 5′-triphosphate to the 5′-hydroxyl terminus of a nucleic acid molecule to form a 5′-phosphoryl-terminated polynucleotide. Another alternative and potentially better, easier, and faster method is the direct production of 5′ phosphorylated oligonucleotides using a chemical phosphorylation reagent (shown below) at the end of the parallel synthesis process.

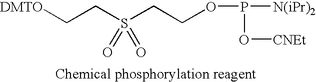

Yet another alternative is to conduct phosphorylation using polynucleotide kinase, which catalyzes the transfer of the γ-phosphate of a nucleotide 5′-triphosphate to the 5′-hydroxyl terminus of a nucleic acid molecule to form a 5′-phosphoryl-terminated polynucleotide. T4 polynucleotide kinase has been extensively used in molecular biology. The high quality enzyme expressed from recombinant is commercially available. The optical reaction condition is 70 mM Tris-HCl (pH 7.6), 100 mM KCl, 10 mM MgCl₂, 1 mM 2-mercaptoethanol, ˜5 μM ATP, at 37° C. Other methods of phosphorylation are known in the art.

H. Rapid Synthesis of Long DNA Sequences

Multiplex parallel oligonucleotide synthesis can be used to generate DNA sequences by the generation and assembly of oligonucleotides synthesized according to the methods disclosed herein. In preferred embodiments, the oligonucleotides synthesized are rapidly assembled to form long DNA sequences, for example DNA sequences, gene fragments, genes, transposons, chromosome fragments, chromosomes, regulatory regions, expression constructs, gene therapy constructs, viral constructs, homologous recombination constructs, vectors, viral genomes, bacterial genomes, and the like. Preferably, the present disclosure is used to generate long nucleic acid sequences composed of DNA. As used herein, the term “long DNA sequence(s)” includes DNA sequence(s), fragment(s), or construct(s) of at least 100 base pairs (bp) up to 200 bp, at least 200 bp up to 400 bp, at least 400 bp up to 1000 bp, at least 1000 bp up to 10,000 bp, and at least 10,000 bp up to 100,000 bp in length. This system provides for the efficient and high-fidelity synthesis of a large number of oligonucleotides and assembly of these oligonucleotides into macromolecules, for example long DNA sequences.

In a preferred embodiment, a method for producing long DNA sequences with high efficiency and fidelity is provided. In a preferred embodiment, the production cycle for a long DNA sequence (>400 bp) includes the following steps:
Computational selection of suitable subchains (computational fragmentation) for the assembly of a given long DNA chain
Parallel synthesis of the complete set of the oligonucleotide subchains.
On-chip deprotection of oligonucleotides and removal of side products; on-chip purification of the sequences synthesized as needed.
Cleavage of the oligonucleotides synthesized from the substrate surface to give 3′-OH free sequences.
Annealing the oligonucleotide subchains into double-stranded long DNA chains and synthesis of a long DNA sequence using ligation.
Amplification and sequence analysis of the long DNA sequence product to confirm sequence accuracy.

The presently described system for the generation of long DNA sequences allows for the assembly of wild-type, modified, or mutated partial or full-length genes, transposons, chromosome fragments, chromosomes, regulatory regions, expression constructs, gene therapy constructs, homologous recombination constructs, vectors, viral genomes, bacterial genomes, and the like. Combination sequences may also be produced by, for example, incorporating into the sequence of gene A a modification contained within gene A′ (a gene related to gene A). Combinations may also be made between unrelated genes where, for example, the skilled artisan desires to incorporate an active site of one protein into the structure of another. Similarly, immunogenic sequences may be exchanged between genes. Virtually any characteristic of one gene or polypeptide may be incorporated into another sequence using the presently described system. As described earlier, although such combination sequences have been generated by those of skill in the art using, for example, PCR or various DNA shuffling-type techniques, the presently described system overcomes many of the limitations of those techniques, thereby providing for the rapid and highly-efficient assembly of long DNA sequences.

The DNA sequence of interest is selected and analyzed to generate a series of oligonucleotide sequences which will anneal to form staggered DNA duplexes. The subchain sequences can be designed so that when the oligonucleotides anneal, a complete double-stranded DNA sequence is generated without any sequence gaps, but with nicks that can be ligated together. Alternatively, the oligonucleotide subchain sequences can be designed so that after the subchains anneal, there are one or more gaps present between the staggered DNA duplexes, which can be filled in with DNA polymerase. For example, oligonucleotides sequences of about 30-mers are selected, preferably oligonucleotides sequences of about 40, 50, 60, 70, 80, 90, 100, 110, 120, 130, 140, 150, 160, 170, 180, 190, or 200 nucleotides in length are selected. In choosing the oligonucleotides sequences to synthesize, the following general guidelines which are well known to those of skill in the art should be followed: (a) the two segments of the subchain sequence should have comparable stability of duplex formation; (b) most duplexes should have comparable Tm; (c) certain sequences, such as consecutive G's, which tend to form stable single stranded structures, should be avoided when possible; (d) repeat segment should be avoided by creating a gap, since this may result in misalignments, and thus resulting in wrong gene sequences.

In another preferred embodiment, an oligonucleotide sequence can be synthesized such that it will anneal to itself, thereby forming a duplex oligonucleotide with a hairpin loop. The hairpin loop can be cleaved, for example with Mung Bean Nuclease or with an R.E. enzyme, and the double-stranded oligonucleotide directly ligated to other oligonucleotides and/or duplex oligonucleotides to generate long DNA sequences.

After the oligonucleotide subchains are synthesized on the solid support, they are cleaved from the solid support as described earlier. Alternatively, some of the subchains remain attached to the substrate, and are annealed with oligonucleotide subchains that have been released from the solid support to generate a desired DNA sequence. The oligonucleotides collected from the solid substrate, for example microarray plates, can be used directly for subsequent steps to generate long DNA sequences without the need for reducing volume or de-salt purification if after synthesis the oligonucleotides are subjected to simple washing steps, cleaved, and washed off from the surface in conditions free of salt contamination and in tens of μl volumes as described earlier. Next, a set of oligonucleotide subchain sequences are annealed to form the desired DNA sequence. The large synthetic DNA sequence formed is separated from the short segments, which may form due to non-specific hybridization, non-equivalent ligation efficiency, and other reasons. The long double-stranded DNA sequence can be further purified using match repair enzymes, for example T7 endonuclease I, T4 endonuclease VII, and/or mut Y. The sequence accuracy will be validated using sequencing and agarose gel analysis. Further cloning and protein expression, which are well within the skill of those in the art, can be used for functional validation of the long DNA sequence synthesized.

The steps required for the assembly of oligonucleotide subchains into full-length DNA chains are well known to those of skill in the art. In the first step, subchains are annealed or hybridized in a buffer solution to form long-chain duplex structures. In a preferred embodiment, the oligonucleotides subchains are designed so that they anneal to form the long DNA sequence without any gaps in the DNA sequence, i.e. only ligase needs to be added to ligate the oligonucleotides subchains together to generate the desired DNA sequence. In another preferred embodiment, gaps may be present in the duplex structure due to certain constraints in the computational selection of subchains, such as sequences overlap, melting point compatibility, and secondary structures. The gaps are filled using DNA polymerase reaction. A variety of DNA polymerases are available for filling in the gaps, including but not limited to DNA polymerase I (Klenow fragment), T7 DNA polymerase, DNA polymerase I (E. coli), T4 DNA polymerase, and Taq DNA polymerase. In a preferred embodiment, DNA polymerase I (Klenow fragment) without 5′→3′ exodeoxyribonuclease function is used.

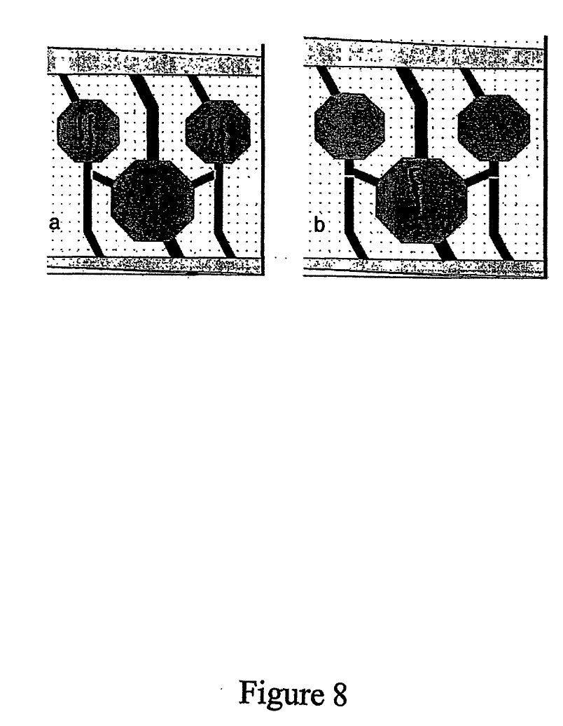

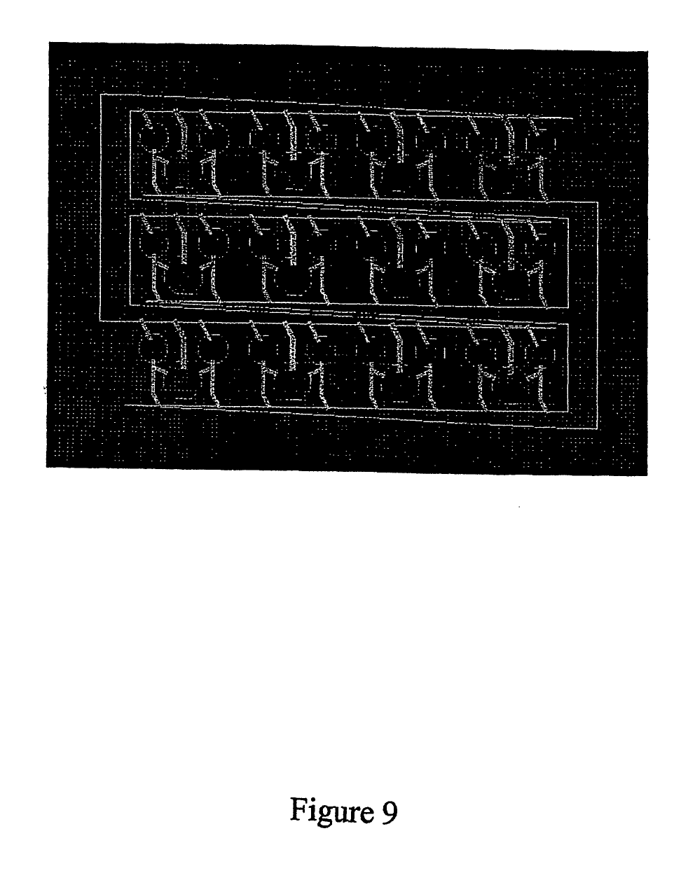

In another preferred embodiment of the present disclosure, the oligonucleotides synthesized on a solid substrate are preferably assembled into chains of intermediate length through ligation on the solid substrate, and the intermediate length chains are subsequently assembled into the full-length long DNA sequence desired, preferably on the solid substrate as well. A “cascade” synthesizer that will perform this process is shown in FIG. 8. The device consists of three individual reactors. First the flow of fluid is fed into each reactor where small DNA fragments are individually synthesized. Next the flow direction is reversed and the DNA fragments synthesized in the two upper reactors are cleaved and sent to the lower reactor for assembly through ligation. Parylene check-valves can be fabricated into flow channels to direct the flow as needed. To achieve better flow uniformity, the feed and drain channels are tapered along with the major flow direction to fit the change of flow flux. FIG. 9 illustrates a preferred device for synthesizing long DNA sequences which has an array of the synthesis units shown in FIG. 8.

In another preferred embodiment of the present disclosure, the oligonucleotides synthesized on a solid substrate are cleaved and isolated from the solid substrate. The oligonucleotides are subsequently assembled separate from the solid substrate. The oligonucleotides can also be assembled into chains of intermediate length through ligation, with the intermediate length chains subsequently assembled into the full-length long DNA sequence. Alternatively, the oligonucleotide can be directly assembled into the desired long DNA sequence.

In yet another embodiment, one or more synthesized oligonucleotides are ligated to another oligonucleotide that is attached to a solid substrate. In this method, a solid surface stringency-washing step can be incorporated into the reaction before the ligation step, which will result in most mismatched sequences that annealed during the hybridization step being washed away before ligation. This method can be used to directly generate the desired long DNA sequence, or can be used to assemble chains of intermediate length, which are subsequently hybridized to other oligonucleotides still attached to a solid substrate to form the final long DNA sequence product.

Oligonucleotides for gene assembly require a 3′-OH available for ligation. 5′-phosphorylation of the oligonucleotides can also be accomplished as described earlier. To complete the assembly of the annealed oligonucleotides into the desired long DNA sequence, nicks in the long-chain duplex of hybridized oligonucleotides must be joined by phosphodiester bonds. DNA ligase is used to catalyze the joining of polynucleotide strands provided they have juxtaposed 3′-hydroxyl and 5′-phosphoryl end groups aligned in a duplex structure. DNA ligases that may be used to ligate oligonucleotides together include but are not limited to T4 DNA ligase, Taq DNA ligase, and DNA ligase (E. coli). In a preferred embodiment, T4 DNA ligase is used for this reaction. The optimal reaction condition for T4 DNA ligase is 50 mM Tris-HCl (pH 7.6), 10 mM MgC12, 1 mM DTT, 1 mM ATP, 5% polyethyleneglycol-8000. In addition, because T4 DNA ligase works adequately in the presence of phosphorylation buffer it is not necessary to remove the phosphorylation buffer. Taq DNA ligase can also be used if the ligation is done at higher temperatures (˜65° C.).

As discussed above, the amount of the final long-chain DNA product is on the order of femto moles. If larger quantities of the long DNA sequence products are desired, an amplification process may be required after the assembly process. In one embodiment, PCR™ is utilized to perform the amplification, which is described in detail in U.S. Pat. Nos. 4,683,195, 4,683,202 and 4,800,159, each incorporated herein by reference. A micro-PCR reactor may also be used to perform this step on the chip (Burke et al., Genome Research 7(3):189-97, 1997; Burns et al., Science 282:484-87, 1998; incorporated herein by reference). In PCR™, pairs of primers that selectively hybridize to nucleic acids are used under conditions that permit selective hybridization. The term primer, as used herein, encompasses any nucleic acid that is capable of priming the synthesis of a nascent nucleic acid in a template-dependent process. Primers may be provided in double-stranded or single-stranded form, although the single-stranded form is preferred. The primers are used in any one of a number of template dependent processes to amplify the target-gene sequences present in a given template sample. In addition, different long-distance PCR kits are available from several companies, such as JumpStart REDAccTaq from Sigma and ELONGASE Enzyme mix from Life Technologies Inc. These enzymes can amplify fragments up to 30 Kb.

The necessary reaction components for DNA amplification are well known to those of skill in the art. It is also understood by those of skill in the art that the temperatures, incubation periods, and ramp times of the DNA amplification steps, such as denaturation, hybridization, and extension, may vary considerably without significantly altering the efficiency of DNA amplification and other results. Alternatively, those of skill in the art may alter these parameters to optimize the DNA amplification reactions. These minor variations in reaction conditions and parameters are included within the scope of the present disclosure.

Verification of the sequence of the assembled long DNA sequence products against the prescribed sequence can be used as the final validation of the parallel synthesis process for the manufacturing oligonucleotides and assembly into long DNA sequences. After the long DNA sequences products are amplified by PCR, or cloned into a suitable vector, the products will be sequenced using standard sequencing methods, which are well known to those of skill in the art. This can be done by using either a commercial sequencer, such as ABI 7300 from ABI (Foster City, Calif.), or using a commercial sequencing service, such as that from SeekRight (Houston, Tex.).

It is often desirable to clone the synthesized long DNA sequences after the ligation and PCR steps. Error-free sequences can be obtained by sequencing samples of the cloned long DNA sequences and selecting the ones with the desired sequence. One preferred embodiment of the present disclosure relates to synthesizing error-free genes. In this embodiment, intermediate sized and partially overlapping gene segments, such as gene segments that are 500 to 1000 bp long, are first synthesized, cloned, and sequenced. From the sequencing result, error-free segments are selected, and a full-length gene is assembled using PCR with all the partially overlapping, error-free, intermediate segments as mix templates. This approach will yield a greater percentage of error-free full-length gene sequences than the approach of assembling synthesized oligonucleotides directly into a fill-length gene because of the rate of errors involved in the synthesized oligonucleotides and ligation/PCR products.

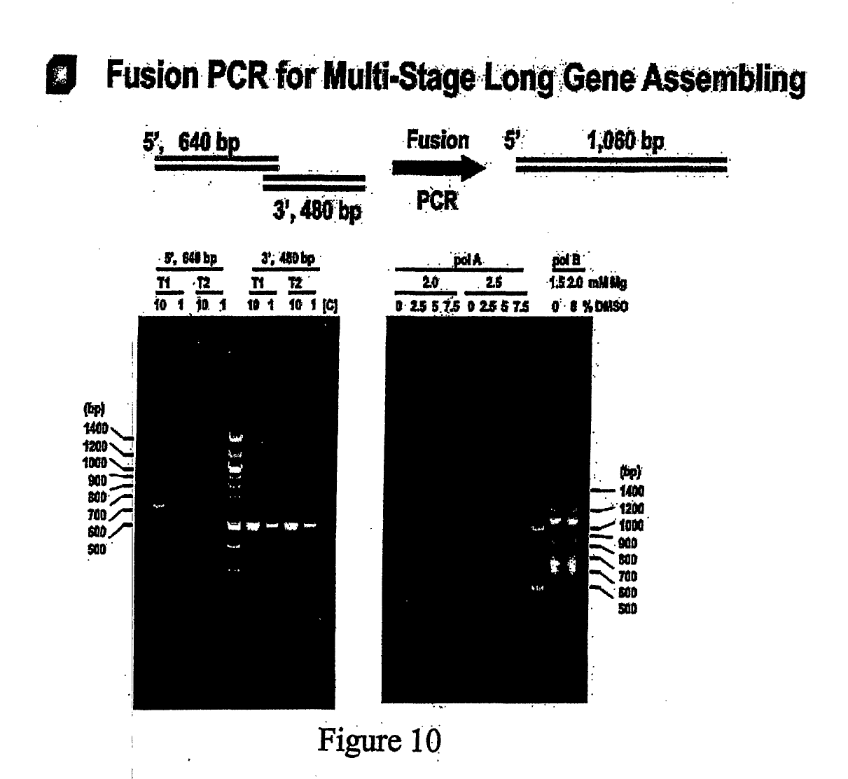

As described infra in Example 1, the error rate found for synthesizing one long DNA sequence, i.e. the GFP gene, using the above disclosed method was 1.40‰ Using this same error rate as a guide, a DNA or gene segment of 1000 bp can be produced with an expected (1-1.40√)¹⁰⁰⁰=24.6% of error-free product. These error-free products can be easily identified through the use of cloning followed by sequencing. Additionally, longer DNA sequences can be generated by ligating together several sequence-verified segments of about 1,000 bp in length. Alternatively these longer DNA sequences can be generated using fusion PCR methods (FIG. 10).

I. Single Nucleotide Polymorphism (SNP) Detection

Multiplex parallel oligonucleotide synthesis as disclosed herein can be used to generate a pool of oligonucleotides for large-scale SNP detection. SNPs are stable nucleotide sequence variations at specific locations in the genome of an individual, are found in both coding and non-coding regions of genomic DNA, and are found in large numbers throughout the human genome (Cooper et al., Hum Genet 69:201-205, 1985). On average there is one SNP per every thousand nucleotides of the genome. The SNP Consortium (TSC) has identified over two millions SNPs, and that number is still growing. The large-scale detection of SNPs is desirable because SNPs have predictive value in identifying many genetic diseases, as well as phenotypic characteristics that may be desirable, which are often caused by a limited number of different mutations in a population. In addition, certain SNPs result in disease-causing mutations such as, for example, heritable breast cancer (Cannon-Albright and Skolnick, Semin Oncol 23:1-5, 1996). SNP detection can also be used as markers in large-scale searches for genes that cause or contribute to common, multifactorial diseases using linkage disequilibrium mapping or genetic association studies (Schafer and Hawkins, Nat Biotech 16:33-39, 1998; Collins et al., Proc Natl Acad Sci 96:15173-77, 1999). Functional SNPs in genes encoding drug-metabolizing enzymes, drug transporters, and receptors may also be used to develop and design new medical therapies. Therefore, large-scale SNP detection will potentially provide significant scientific and practical value for population genetics, medicine, pharmacology, and molecular evolution research.

In one embodiment, large-scale SNP detection involves the amplification of hundreds, thousands, or tens of thousands of SNP-containing DNA fragments (amplicons). Since most SNPs are separated by conserved nucleotide sequences, average genomic amplification products contain only one or a few SNPs. For large-scale SNP detection in a genome, large numbers of amplicons must be produced and analyzed. The major limiting step in current large-scale SNP assays is synthesizing the large number of PCR primers for generating the amplicons. Generating pools of PCR primer oligonucleotides is costly and time consuming, and the preparation of large numbers of individual PCR reactions is labor intensive, error-prone, and, when the scale is tens of thousands of reactions, impractical even with an automated robotic system. The methods of the present disclosure overcome these limitations by allowing for the rapid and efficient generation of a pool of oligonucleotides that are used as primers to amplify an array of SNP-containing amplicons, which are then analyzed.

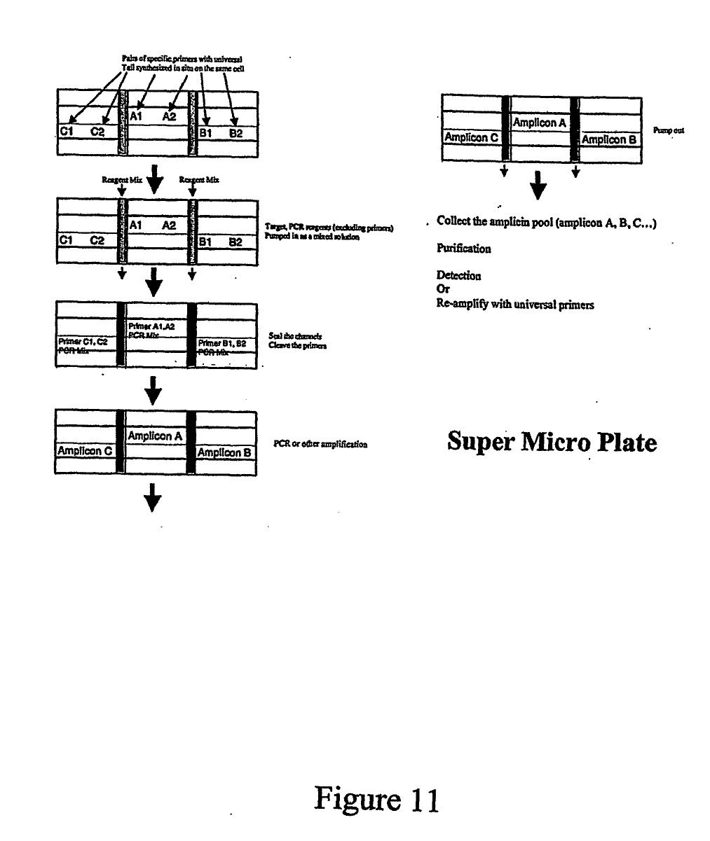

For large-scale SNP detection using a pool of oligonucleotide primers, a pair of specific primers for the amplification of an amplicon containing one or more SNPs is synthesized in each reaction cell of the microfluidic reactor for multiplex parallel oligomer synthesis as disclosed herein. Each primer is preferably synthesized with a cleavable linker. In another preferred embodiment, the reaction cells or micro channels of the microfluidic reactor are sealed with a hydrophobic fluid (such as mineral oil). The sealed reaction cells then function as independent reaction chambers creating a Super Micro Plate as shown in FIG. 11. In each reaction cell biomolecules such as DNA oligonucleotides, RNA oligonucleotides, peptides, etc., are synthesized in situ. In an alternative embodiment, the reaction cells are isolated at different levels by utilizing narrow channels and/or viscous reaction solutions. The synthesized primers are cleaved from the solid support of the reaction cell, or alternatively one primer is cleaved while the other primer remains attached to the solid support.

After cleavage, amplification reagents, for example RNase, chemicals, DNA polymerase, dNTP, buffer, genomic DNA, etc., are delivered into the reaction chamber of the chip, after which the reaction cells are again subjected to conditions which create independent reaction chambers and allow for the amplification of the amplicons using the synthesized primers (FIG. 11). In another preferred embodiment, the oligonucleotide primers are designed to include a universal primer sequence. This sequence will allow for another round of amplification of the amplicons with universal primers if desired, because the amplicons will all be tagged with the universal sequences. Conventional PCR conditions for the universal primers are used for subsequent rounds of amplification. This system is capable of amplifying tens of thousands of amplicons in parallel, with each reaction cell performing an independent monoplex amplification reaction, and avoiding the cross-interactions in a multiplex system.

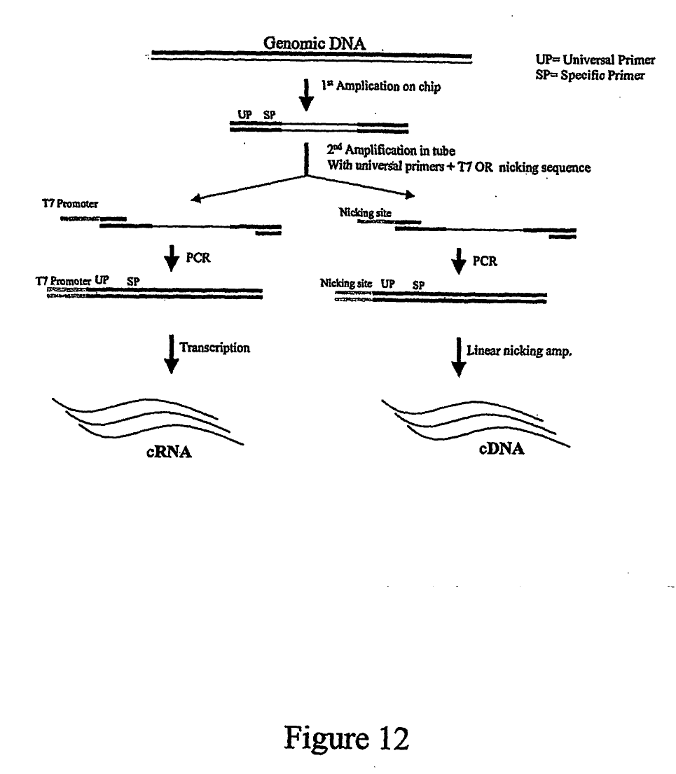

Another method for subsequent amplification of the amplicons generated as illustrated in FIG. 11 is to incorporate DNA sequences recognized by altered restriction enzymes that hydrolyze only one strand of the double-stranded DNA, thereby producing DNA molecules that are “nicked,” rather than cleaved. These nicks (3′-hydroxy, 5′-phosphate) serve as the initiation point for strand displacement amplification (Walker et al., Proc. Natl. Acad. Sci. USA 89:392-396, 1992; Walker et al., Nucl Acids Res 20:1691-96, 1992; U.S. Pat. No. 5,270,184; incorporated herein by reference). To utilize this method, a specific recognition site for a nicking enzyme, for example, N.BstNB I, N.Alw I, N.BbvC IA, and N.BbvC IB, is incorporated into one of the two universal sequences in the primers. The nicking enzyme recognizes and cuts one strand of the double-stranded amplicon, and a special DNA polymerase is used to extend the nicked strand and displace the original strand. The nicking enzyme will then make another cut on the extended strand, and the DNA polymerase will again extend and displace the DNA strand. This reaction is repeated multiple times, thereby generating multiple copies of single-stranded DNA for each amplicon. This linear amplification not only further amplifies the target amplicon sequences, but also generates single-stranded DNA targets that are suitable for hybridization (FIG. 12).

After the amplicons are generated, they must be analyzed for the presence of specific SNPs at specific locations. The amplicons are preferably either analyzed on the chip, or collected from the chip for analysis. For example, real-time assays such as Molecular Beacon™ and TaqMan™ may be modified and performed on the chip. Preferably the amplicon products are purified before SNP detection. A SNP may be detected and identified in an amplicon by a number of methods well known to those of skill in the art, including but not limited to identifying the SNP by PCR™ or DNA amplification, Oligonucleotide Ligation Assay (OLA) (Landegren et al., Science 241:1077, 1988, incorporated herein by reference), mismatch hybridization, mass spectrometry, Single Base Extension Assay, RFLP detection based on allele-specific restriction-endonuclease cleavage (Kan and Dozy, Lancet ii:910-912, 1978, incorporated herein by reference), hybridization with allele-specific oligonucleotide probes (Wallace et al., Nucl Acids Res 6:3543-3557, 1978, incorporated herein by reference), mismatch-repair detection (MRD) (Faham and Cox, Genome Res 5:474-482, 1995, incorporated herein by reference), binding of MutS protein (Wagner et al., Nucl Acids Res 23:3944-3948, 1995, incorporated herein by reference), single-strand-conformation-polymorphism detection (Orita et al., Genomics 5:874-879, 1983, incorporated herein by reference), RNAase cleavage at mismatched base-pairs (Myers et al., Science 230:1242, 1985, incorporated herein by reference), chemical (Cotton et al., Proc Natl Acad Sci USA 85:4397-4401, 1988, incorporated herein by reference) or enzymatic (Youil et al., Proc Natl Acad Sci USA 92:87-91, 1995, incorporated herein by reference) cleavage of heteroduplex DNA, methods based on allele specific primer extension (Syvanen et al., Genomics 8:684-692, 1990, incorporated herein by reference), genetic bit analysis (GBA) (Nikiforov et al., Nuci Acids Res 22:41674175, 1994, incorporated herein by reference), and radioactive and/or fluorescent DNA sequencing using standard procedures well known in the art. In a preferred embodiment, the method used to detect the SNPs is able to distinguish unequivocally between homozygous and heterozygous allelic variants in a diploid genome.

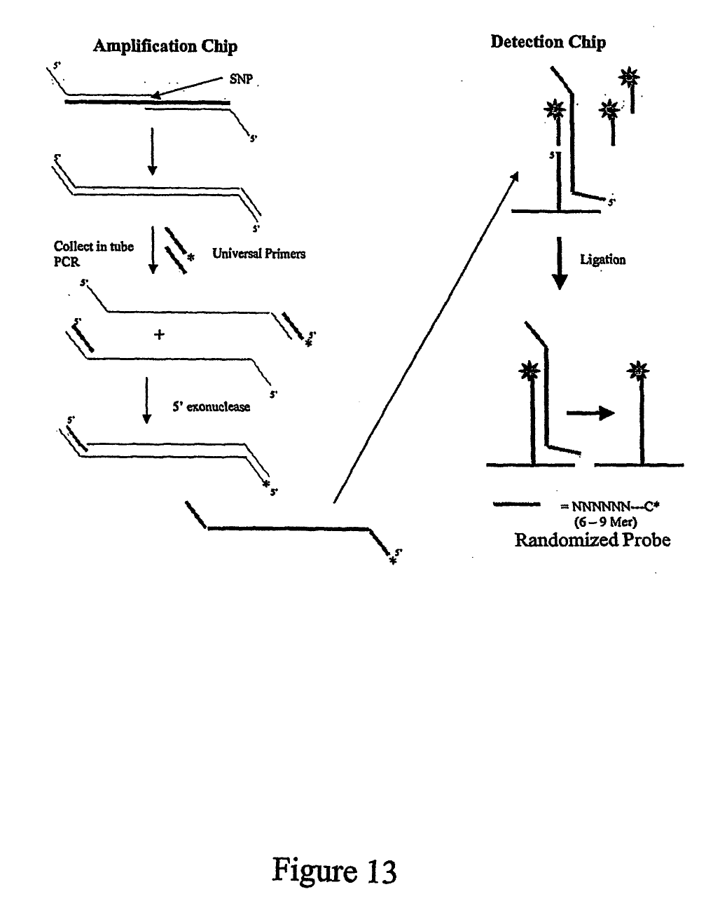

One method suitable for large-scale SNP detection is illustrated in FIG. 13. This method utilizes an amplification chip to amplify amplicons with one or more SNPs as disclosed above. The amplicons are subsequently collected in separate tubes, and because the primers used to amplify the amplicons included universal primer sequences, universal primers are used to produce another round of amplified amplicon products. The amplicons containing the SNP sequence is denatured, and added to a detection chip. This detection chip has an oligonucleotide sequence attached to the chip which hybridizes to the 5′ end of the single-stranded amplicon sequence, including the sequence encoding the SNP. The chip is subjected to a wash to remove any mismatched single-stranded amplicon sequence; the wash should be sufficiently stringent to remove substantially all amplicon sequences that do not hybridize with the SNP being detected (single base pair mismatch). Next, a labeled oligonucleotide (for example, a fluor label) is added to the chip which hybridizes to the 3′ end of the single-stranded amplicon sequence. Ligase is added so that if the SNP being detected is present, the labeled oligonucleotide is ligated with the attached oligonucleotide, which can then be detected. Thus, if the SNP being screened for is present in the amplicon that was amplified, a labeled product will be produced.

Another method suitable for large-scale SNP detection is the Single Base Extension Assay. The Single Base Extension Assay is performed by annealing an oligonucleotide primer to a complementary nucleic acid, and extending the 3′ end of the annealed primer with a chain terminating nucleotide that is added in a template directed reaction catalyzed by a DNA polymerase. Additionally, cycled Single Base Extension Reactions may be performed by annealing a nucleic acid primer immediately 5′ to a region containing a single base to be detected. Two separate reactions are conducted. In the first reaction, a primer is annealed to the complementary nucleic acid, and labeled nucleic acids complementary to non-wild-type variants at the single base to be detected, and unlabeled dideoxy nucleic acids complementary to the wild-type base, are combined. Primer extension is stopped the first time a base is added to the primer. Presence of label in the extended primer is indicative of the presence of a non-wild-type variant. A DNA polymerase, such as Sequenase™ (Amersham), is used for primer extension. In a preferred embodiment, a thermostable polymerase, such as Taq or thermal sequenase is used to allow more efficient cycling.

Once an extension reaction is completed, the first and second probes bound to target nucleic acids are dissociated by heating the reaction mixture above the melting temperature of the hybrids. The reaction mixture is then cooled below the melting temperature of the hybrids and additional primers are permitted to associate with target nucleic acids for another round of extension reactions. After completion of all cycles, extension products are isolated and analyzed. Alternatively, chain-terminating methods other than dideoxy nucleotides may be used. For example, chain termination occurs when no additional bases are available for incorporation at the next available nucleotide on the primer. The Single Base Extension Assay can be used to detect SNPs present either in amplicons that have been amplified by the methods disclosed above, or the primers used can be directly synthesized on a solid substrate as disclosed herein, and used to detect SNPs directly in the DNA samples being screened.

In another preferred embodiment, the oligonucleotide primers synthesized for the large-scale detection of SNPs may be designed for allele-specific PCR™ (Newton et al., Nucl Acids Res 17:2503-16, 1989, incorporated herein by reference). This technique is based on the observation that oligonucleotides with a mismatched 3′-residue will not function as primers for PCR under appropriate conditions. Therefore, primer pairs can be synthesized with different nucleotides at the 3′-end of one of the primers, which are designed to amplify different SNPs at a particular location in the genome, as specified by the sequence of the primers. If an amplicon is generated by the primer pairs, then the particular SNP being detected is present in that DNA sample. This system is simple and reliable, and will distinguish genomes that are heterozygous at a SNP locus from genomes that are homozygous at that SNP locus.

In a preferred embodiment, the pairs of primers needed for the above amplification of amplicons, or pairs of primers for the pools of oligonucleotides necessary for the applications disclosed herein, can be generated from a single oligonucleotide synthesized on a solid surface according to the methods disclosed herein.

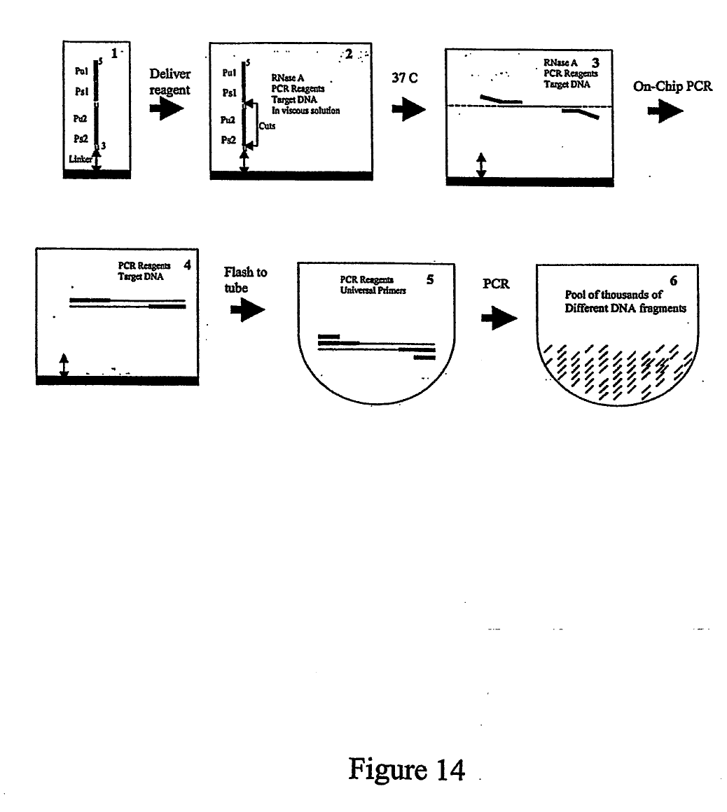

In this method the in situ synthesized oligonucleotide, which is preferably attached to the solid substrate with a cleavable linker, contains one pair of primers separated by another cleavable linker, for example reverse Us (FIG. 14). Preferably each primer sequence has a specific priming site and a universal priming site. After the oligonucleotide is synthesized, it is exposed to a reagent that will cleave the linker, for example RNase A, thereby releasing the oligonucleotide from the solid surface, as well as cleaving it so that the two primers are separated. PCR reagents and target DNA can be added to the reaction well as described earlier either at the same time as the reagent that will cleave the linker or after the oligonucleotide has been cleaved. In a preferred embodiment, the PCR reagents are added in a viscous solution as described earlier. PCR preferably occurs on-chip, and a specific PCR product is produced in each reaction cell. Since each fragment has a universal primer sites at both ends, the PCR products are preferably flushed from the chip to a tube and re-amplified using PCR with universal primers.

These amplified DNA products are now ready for use, for example, for SNP detection or for generating short DNA libraries.

Examples of cleavable oligonucleotides which contain two reverse U (rU) linkers and have been synthesized on a chip are as follows:

Probe

| | |
|---|---|
| | Pu1 PS1 PU2 PS2 |
| IL6-T7 | 5′CAAGGATCTTACCGCTGTTGtgaggagacttgcctggtgrUTAATACGACTCACTATAGGtctgcaggaactggatcaggrU |
| CYP11A-T7 | 5′CAAGGATCTTACCGCTGTTGgtgaccctgcagagatatctrUTAATACGACTCACTATAGGgttccggaagtaggtgatgtrU |
| ATP2A1_T7 | 5′CAAGGATCTTACCGCTGTTGgattggcattgccatgggatrUTAATACGACTCACTATAGGtccacagcagctacgatggrU |
| IL6_Nick | 5′CAAGGATCTTACCGCTGTTGtgaggagacttgcctggtgrUCGCTCCAGACTTGAGTCCGAtctgcaggaactggatcaggrU |
| CYP11A_Nick | 5′CAAGGATCTTACCGCTGTTGgtgaccctgcagagatatctrUCGCTCCAGACTTGAGTCCGAgttccggaagtaggtgatgtrU |
| ATP2A1_Nick | 5′CAAGGATCTTACCGCTGTTGgattggcattgccatgggatrUCGCTCCAGACTTGAGTCCGAtccacagcagctacgatggrU |

These oligonucleotides can be exposed to RNase A, which cleaves the rU linker sites, thereby releasing two distinct primers from the single synthesized oligonucleotide.

J. Generation of Short RNA Molecules or RNAi Libraries

Another embodiment of the present disclosure is a method for producing a large number of short RNA molecules or an RNAi library. RNAi (RNA interference) molecules are double stranded small RNA molecules (21-23 base pairs). These molecules suppress the expression of genes by degrading the targeted mRNA. Potentially, RNAi can be developed as therapeutic agents. For example, sequence-specific RNAi silencers can be designed to cover the entire HIV genome many times, degrading the viral RNA at a large number of sites. This approach could potentially overcome the most challenging issue in anti-HIV drug development: the high mutation rate of the viral genome which leads to multiple drug-resistance. By using an RNAi pool containing large number of different specific targeting sequences as a therapeutic agent, any mutations at the “hot spots” will not affect the overall performance of the drug. This RNAi pool strategy can also be applied to other areas, for example developing drugs against the multiple drug resistant bacteria. The pool of transcribed RNAi sequences can also be cloned into a vector to generate an RNAi library.

In a preferred embodiment, the production of short RNA molecules or an RNAi library includes the following steps:
Design oligonucleotide-DNA templates for in vitro transcription of the short RNA molecules or RNAi library.
Parallel synthesis of the designed oligonucleotides on a chip.
On-chip deprotection of the oligonucleotides and removal of side products; on-chip purification of the sequences synthesized as needed.
Cleavage of the oligonucleotides synthesized from the substrate surface to give 3′-OH free sequences.
Amplify the oligonucleotides using PCR to form a double-strand oligonucleotides or an oligonucleotide library.
In vitro transcription to form short RNA molecules or an RNAi library.

In other preferred embodiments, oligonucleotides synthesized include sequences for an RNA promoter, for example T7, SP6, or T3 promoters, and/or universal primer sequence. The RNA promoter sequences will allow for the transcription of short RNA sequences from the oligonucleotides generated, thereby generating a mixture of RNA molecules or an RNAi library.

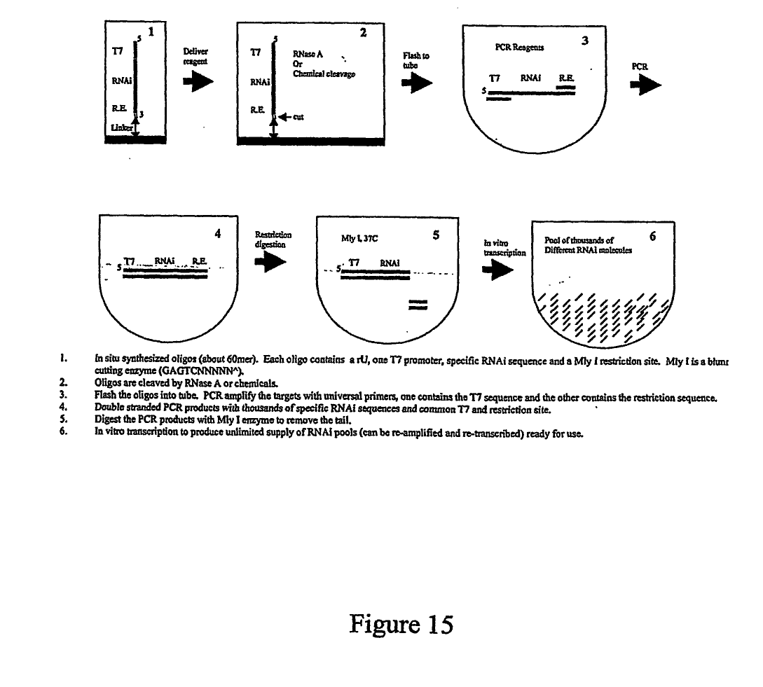

In a preferred embodiment, the oligonucleotides for producing a large number of short RNA molecules or an RNAi library are synthesized in situ (about 60-mers), and each oligonucleotide preferably contains an rU, a T7 promoter, a specific RNAi sequence, and a R.E. enzyme sequence. Preferably the R.E. enzyme used will generate blunt-ended fragments. In the example shown in FIG. 15, the restriction site utilized was for the Mly I enzyme. After the oligonucleotide is synthesized, it is exposed to a reagent that will cleave the linker, for example RNase A, thereby releasing the oligonucleotide from the solid surface. The cleaved oligonucleotides are then preferably flushed from the chip to a tube and re-amplified using PCR with a primer that hybridizes to the T7 sequence and a primer that hybridizes to the R.E. enzyme sequence. The amplified DNA products are digested with the R.E. enzyme, for example Mly I at 37° C., thus yielding thousands of specific RNAi sequences with a common T7 sequence and blunt-ended restriction site. In vitro transcription using the T7 RNA polymerase is then used to produce a pool of thousands of different RNAi molecules, ready for use.

Another preferred embodiment for generating a pool of RNAi molecules in shown in FIG. 12. In this example sequences of genomic DNA are amplified using primers with both a universal primer sequence and a specific primer sequence. The amplified DNA products are subsequently amplified again with primers that hybridize to the universal sequences, but one of the primers also contains a sequence specific for T7 RNA polymerase, thus incorporating this sequence into the second round amplified DNA sequences. T7 RNA polymerase can then be added to the amplified DNA to transcribe the amplified genomic DNA sequence into short RNA sequences.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1

The parallel synthesis of oligonucleotide DNA chips was performed on microarray chips held in a cartridge holder that was connected to a synthesizer. The microreaction well surfaces were derivatized with hydroxyl silyl and coupled with nucleophosphoramidite terminated with the 5′-O-DMT group for the detection chip, and coupled with 5′-phosphoamidite of 2′,3′-orthoester-U and terminated with 2′,3′-orthoester-U. During the light-directed deblock step, the reaction cell was first filled with a PGA-P solution (diaryl iodium salt and a sensitizer). A digital light pattern that was generated according to the predetermined chip layout and aligned to the reaction cells was projected onto the microarray plate. At irradiated reaction sites, 5′-DMT groups were removed by in situ formed PGA (H⁺) and terminal 5′-OH formed, or 2′,3′-orthoester of U was hydrolyzed by in situ formed PGA (H⁺) and terminal 2′ or 3′-OH formed. At un-irradiated reaction sites, no chemical reaction took place. After deblock, the reactor was washed with a solvent. A solution containing the appropriate nucleophosphoramidite (monomer) was then added, and the OH groups at the selected sites coupled with the monomers to complete the addition of a new residue to the growing chain. The synthesis of an oligonucleotide array was accomplished by stepping through a set of predetermined digital light irradiating patterns or digital masks in successive synthesis cycles.

### EXAMPLE 2

Different strategies can be used to release or cleave oligonucleotides synthesized on a solid substrate from that substrate. The cleavage efficiency of three different linkers was examined to determine the preferred linker(s) for cleaving oligonucleotides from a solid substrate (rU is 5′-phosphoramidite with 2′-acetyl and 3′-DMT; U is 3′-phosphoramidite with 2′-fpmp and 5′-DMT; and dU is 2′-deoxyuridine). To begin, the following oligonucleotides were synthesized using an Expetide™ DNA synthesizer and standard phosphoamidite chemistry:

Sequence A
3′-TTTTTTTTTTrUGTCCACAGCATCCGA-FAM-5′
Sequence B
3′-TTTTTTTTTTUGTCCACAGCATCCGA-FAM-5′
Sequence C
3′-TTTTTTTTTTdUGTCCACAGCATCCGA-FAM-5′

Sequence A was synthesized on CPG or an affinity support (stable linker under deprotection condition, Glen Research) functionalized for coupling with regular nucleophosphoramidites or 5′-phosphoamidte of 2′,3′-orthoester-U (rU). After coupling of rU with the surface OH group on the chip substrate, a 6 minute deblock using 3% TCA was applied to give 2′- or 3′-OH while the other hydroxyl was acetylated. The subsequent synthesis of the oligonucleotide was done using a standard protocol for DNA oligonucleotide synthesis. For sequences B and C, FpMp-U phosphoamidite purchased from Cruchem (PA) and dU phosphoamidite from Glen Research were used in the synthesis. The subsequent sequence of the oligonucleotides were synthesized with a standard protocol for DNA oligonucleotide synthesis. The oligonucleotides on CPG and affinity support were first deprotected with EDA/EtOH (1:1) at room temperature for 2 hours, then washed with EtOH and dried. The oligonucleotides were cleaved from CPG with concentrated ammonia at room temperature for 2 hours, dried and ethanol participation. The 260 nm UV absorption of the oligonucleotide samples were measured and the samples stored at −20° C.

17 μg of each of the oligonucleotides A, B and C in solution or bounded to an affinity support were incubated with 100 units of RNase A in 20 μl 1×TE buffer at 37° C. for 1 hour. The cleaved products were then analyzed by capillary electrophoresis on a Beckman MDQ instrument from Beckman. The results demonstrated that Sequence B, which contained the linker RNA U, was 100% cleaved by RNase A. Only about 50% of sequence A, which contained the linker reverse-U (rU), was cleaved. No cleaved oligonucleotide products were isolated for Sequence C, which was expected since dU was used and was not expected to be cleaved by a ribonuclease. Additionally, no further cleavage was observed for Sequence A after extended incubation times. The RNase A cleaved Sequence A was subsequently used as a substrate for DNA ligation, indicating that the sequence has a 3′-OH group. Experiments did demonstrate, however, that Sequence A is 100% cleaved by incubating the oligonucleotide with concentrated ammonia at 80° C. for 3 hours, and that the cleaved oligonucleotide products can be used for DNA ligation without any further modification.

### EXAMPLE 3

The ability to synthesize a functional full-length gene using the disclosed method of generating oligonucleotides on a microfluidic array platform and then ligating the oligonucleotides to generate a long DNA sequence was demonstrated for the Green Fluorescent Protein (GFP) gene. Members of the GFP family are the only known type of natural pigments that are essentially encoded by a single gene, since both the substrate for pigment biosynthesis and the necessary catalytic moieties are provided within a single polypeptide chain (Matz et al., Bioessays 24(10):953-59, 2002). The fluorescent nature of the gene allowed for a straight-forward analysis of the functionality of the gene produced by the disclosed method.

The GFP gene is 714 base pairs (bp) long. Suitable subchains (computational fragmentation) for the assembly of the GFP gene were selected, and oligonucleotides between 40 and 47 nucleotides long were synthesized on a chip using the methods outlined above. The complete set of 34 GFP subchains synthesized on a chip are as follows:

| | |
|---|---|
| GFP-F2 | ATGAGTAAAGGAGAAGAACTTTTCACTGGAGTTGTCCCAATT |
| | CTTG |
| GFP-F3 | TTGAATTAGATGGTGATGTTAATGGGCACAAATTTTCTGTCA |
| | GT |
| GFP-F4 | GGAGAGGGTGAAGGTGATGCAACATACGGAAAACTTACCCT |
| GFP-F5 | TAAATTTATTTGCACTACTGGAAAACTACCTGTTCCATGGCC |
| | AA |
| GFP-F6 | CACTTGTCACTACTTTCTCTTATGGTGTTCAATGCTTTTCAA |
| | GATA |
| GFP-F7 | CCCAGATCATATGAAACGGCATGACTTTTTCAAGAGTGCCAT |
| GFP-F8 | GCCCGAAGGTTATGTACAGGAAAGAACTATATTTTTCAAAGA |
| | TG |
| GFP-F9 | ACGGGAACTACAAGACACGTGCTGAAGTCAAGTTTGAAGGT |
| GFP-F10 | GATACCCTTGTTAATAGAATCGAGTTAAAAGGTATTGATTTT |
| | AAAG |
| GFP-F11 | AAGATGGAAACATTCTTGGACACAAATTGGAATACAACTATA |
| | ACTC |
| GFP-F12 | ACACAATGTATACATCATGGCAGACAAACAAAAGAATGGAAT |
| | CAA |
| GFP-F13 | AGTTAACTTCAAAATTAGACACAACATTGAAGATGGAAGCGT |
| | TCA |
| GFP-F14 | ACTAGCAGACCATTATCAACAAAATACTCCAATTGGCGATGG |
| GFP-F15 | CCCTGTCCTTTTACCAGACAACCATTACCTGTCCACACAAT |
| GFP-F16 | CTGCCCTTTCGAAAGATCCCAACGAAAAGAGAGACCACATG |
| GFP-F17 | GTCCTTCTTGAGTTTGTAACAGCTGCTGGGATTACACATGGC |
| GFP-F18 | ATGGATGAACTATACAAATAGCATTCGTAGAATTGACTCTAT |
| | AGTG |
| GFP-R1 | TGAAAAGTTCTTCTCCTTTACTCAT |
| GFP-R2 | ATTAACATCACCATCTAATTCAACAAGAATTGGGACAACTCC |
| | AG |
| GFP-R3 | CATCACCTTCACCCTCTCCACTGACAGAAAATTTGTGCC |
| GFP-R4 | TTCCAGTAGTGCAAATAAATTTAAGGGTAAGTTTTCCGTATG |
| | TTG |
| GFP-R5 | ATAAGAGAAAGTAGTGACAAGTGTTGGCCATGGAACAGGTAG |
| | T |
| GFP-R6 | GCCGTTTCATATGATCTGGGTATCTTGAAAAGCATTGAACAC |
| | C |
| GFP-R7 | CCTGTACATAACCTTCGGGCATGGCACTCTTGAAAAAGTCAT |
| GFP-R8 | ACGTGTCTTGTAGTTCCCGTCATCTTTGAAAAATATAGTTCT |
| | TT |
| GFP-R9 | CGATTCTATTAACAAGGGTATCACCTTCAAACTTGACTTCAG |
| | C |
| GFP-R10 | TGTCCAAGAATGTTTCCATCTTCTTTAAAATCAATACCTTTT |
| | AACT |
| GFP-R11 | TGCCATGATGTATACATTGTGTGAGTTATAGTTGTATTCCAA |
| | TTTG |
| GFP-R12 | TTGTGTCTAATTTTGAAGTTAACTTTGATTCCATTCTTTTGT |
| | TTGTC |
| GFP-R13 | TTGTTGATAATGGTCTGCTAGTTGAACGCTTCCATCTTCAAT |
| | G |
| GFP-R14 | TGTCTGGTAAAGGACAGGGCCATCGCCAATTGGAGTATT |
| GFP-R15 | GGGATCTTTCGAAAGGGCAGATTGTGTGGACAGGTAATGGT |
| GFP-R16 | CTGTTACAAACTCAAGAAGGACCATGTGGTCTCTCTTTTCGT |
| | T |
| GFP-R17 | TGCTATTTGTATAGTTCATCCATGCCATGTGTAATCCCAGCA |
| | G |

Additionally, the following two control oligonucleotides (Puc2PM- perfect match and Puc2MM- mismatch) were also synthesized on the chip using the methods outlined above:

| | |
|---|---|
| PUC2PM | CTGGCAGCAGCCACTGGTAACAGGATTAGCAGAGCGAGGTAT |
| | GTA |
| PUC2MM | CTGGCAGTAGCCACTGGTAACAGGATTAGCAGAGCGAGGTAT |
| | GTA |

The design for splitting the long double-stranded DNA sequence of GFP into stacking short oligonucleotide subchains was based on unifying the annealing temperature of the overlapping complementary regions, for example making the Tm around 60° C. for each portion. Then each of the 34 GFP oligonucleotide subchains were synthesized on a chip with a rU as a linker between the chip and the oligonucleotide. The oligonucleotides were cleaved from the chip using RNase at 37° C. with a concentration of 10 to 100 μg/ml for about 30 to 120 minutes. The cleaved oligos were then flushed out, concentrated, and ethanol precipitated.

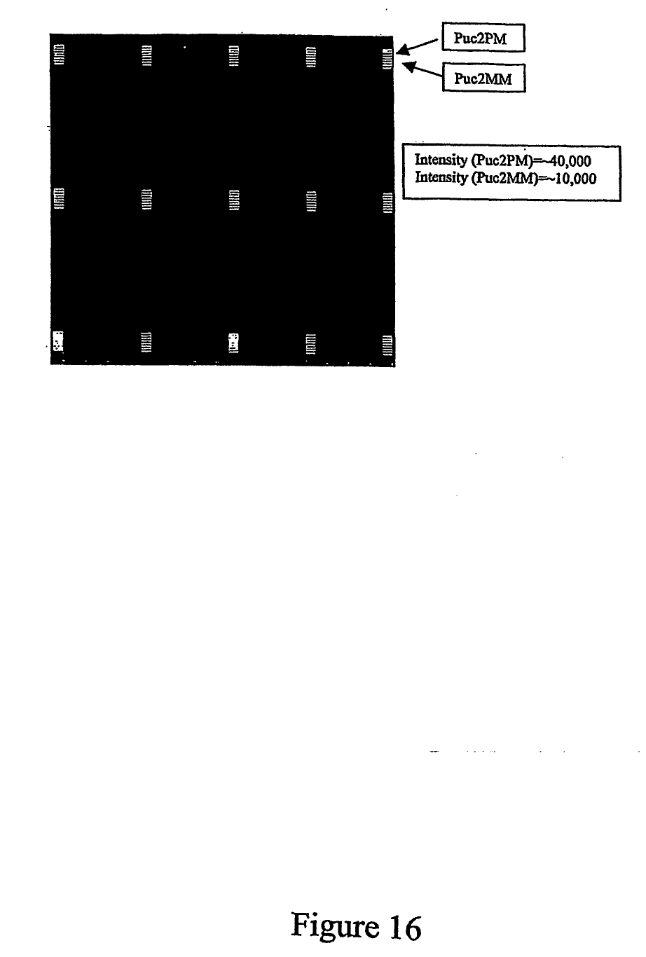

After RNase A cleavage, the gene chip was hybridized with 10 nM of the Cy3-Puc2 15-mer probe (Puc2 probe), which hybridizes with the 5′-end of the Puc2PM. The hybridization reaction occurred in 6×SSPE (pH 6.6, 25% formamide) buffer at room temperature for 1 hour, and the chip was subsequently washed with the same buffer. Next, the chip was scanned with a laser scanner at 532 nm and the images were analyzed with ArrayPro software. The data demonstrated that the Puc2 probe hybridized strongly with the Puc2PM control sites (intensity=˜40,000), hybridized less strongly with the Puc2MM control sites (intensity=˜10,000), and did not hybridize significantly with any other sequences on the chip (FIG. 16).

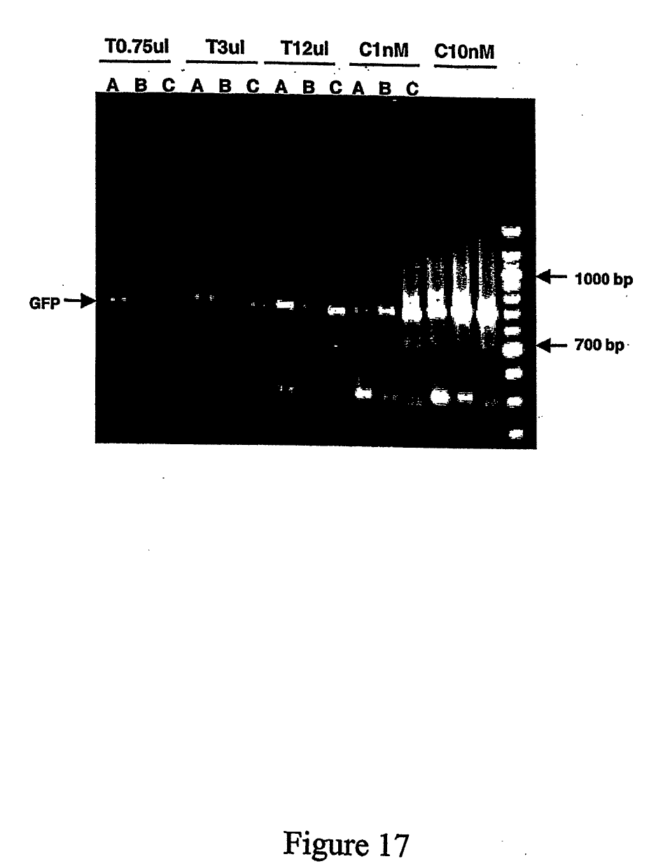

The cleaved oligonucleotides were assembled into a single reaction tube and concentrated to 16 μl for the ligation reaction. The recovered oligonucleotides were then aliquoted to four tubes with a ratio of 1:4:16:64 of the oligonucleotide product respectively. The oligos were assembled in a 25 μl volume with 0 to 20% PEG8000 and 40 units of Taq DNA ligase (New England Biolabs) at 75° C. for 1 minute, then 60° C. for 5 minutes for 40 cycles on a thermal cycler. The same set of oligonucleotide subchains were also synthesized on CPG with a concentration of 1 nM and 10 nM as a ligation control. The full-length GFP ligation products were detected by PCR. FIG. 17 demonstrates that fill-length GFP ligation products were generated in all of the ligation reactions, with varying efficiency. The addition of PEG8000 into the reaction significantly increases the ligation efficiency, and generates longer fragment.

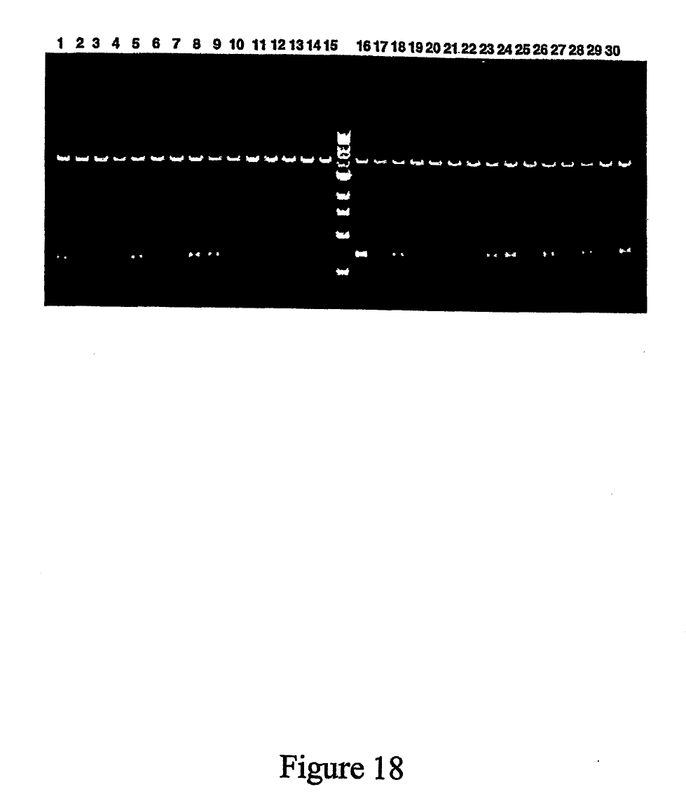

The synthesized GFP gene was cloned into a pTrcHIS vector (Invitrogen). FIG. 18 shows that 11 out of 30 clones analyzed contained the GFP gene. Of the 11, 8 of the subcloned GFP gene were sequenced to determine the error rate for the chipmade gene sequence. Importantly, the experiment demonstrated that the disclosed method for generating chip-made full-length genes has a lower error rate than that of CPG derived synthesized genes. The sequencing results found a total of 8 errors for the subcloned GFP gene, leading to an error rate of 8/(8×714)=1.40‰ (0.14%) using the disclosed method. This error rate is acceptable for large gene synthesis, and is lower than that obtained for the CPG synthesized GFP gene, which is 1.67‰ (0.17%). Among the 8 clones of the GFP fill-length gene sequenced, 3 or 37.5% were error free.

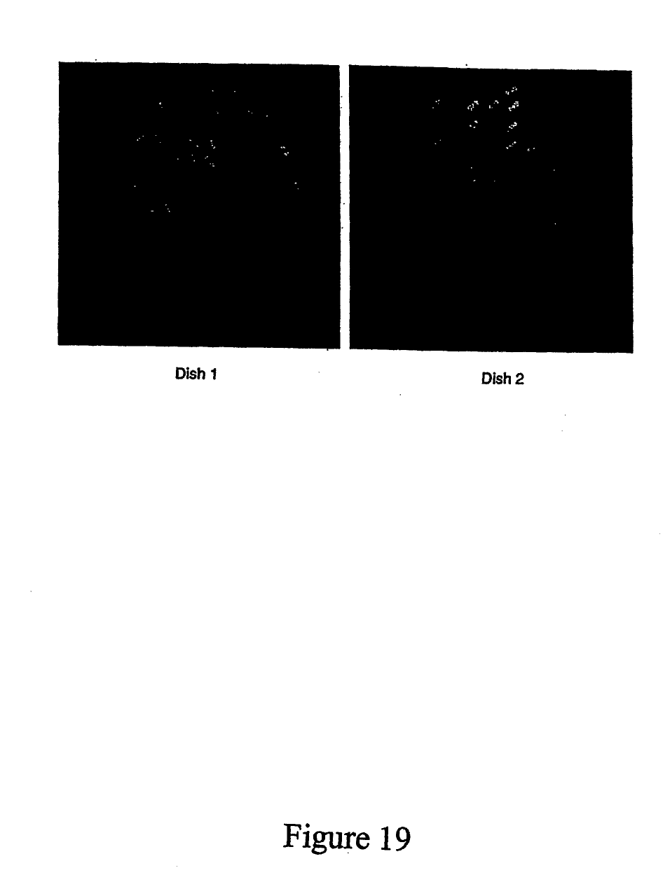

The functionality of the subcloned synthesized fill-length GFP gene was also tested. The amplified GFP gene was inserted into BamHI and EcoRI sites in the pTrcHIS vector, which was then transformed into XL1-blue competent cells. The transformants were plated on Luria Bertani (LB) agar plates, and expression of the GFP gene was induced using isopropylthio-β-galactoside (IPTG). The EGFP gene (from Clonetech) was also subcloned into pTrcHis as a positive control. FIG. 19 shows that 78 glowing green fluorescence colonies were observed out of a total of 256 colonies, excluding positive and negative controls. This demonstrates that a total of 30.5% of the clones containing the chip-made GFP gene contained functional full-length genes.

### EXAMPLE 4

It is inevitable that some errors will exist in synthesized oligonucleotide sequences, which may be subsequently incorporated into the long DNA sequence product. Thus, it is very desirable to remove any erroneous sequences before the ligated oligonucleotide sequences are amplified. T7 endonuclease I is a nuclease that recognizes and cleaves non-perfectly matched DNA, cruciform DNA structures, Holliday structures or junctions, heteroduplex DNA, as well as nicked double-stranded DNA (Parkinson and Lilley, J. Mol. Biol. 270, 169-178, 1997). To determine whether this nuclease would improve the yield of properly assembled large DNA sequences, the subchain oligonucleotides synthesized in Example 3 were divided into two fractions before the ligation process. The first fraction was treated with T7 endonuclease I. The purpose of this treatment was to remove any mismatched DNA after the hybridization and ligation of the subchain oligonucleotides. The other fraction was not treated with the nuclease, and therefore served as a control.

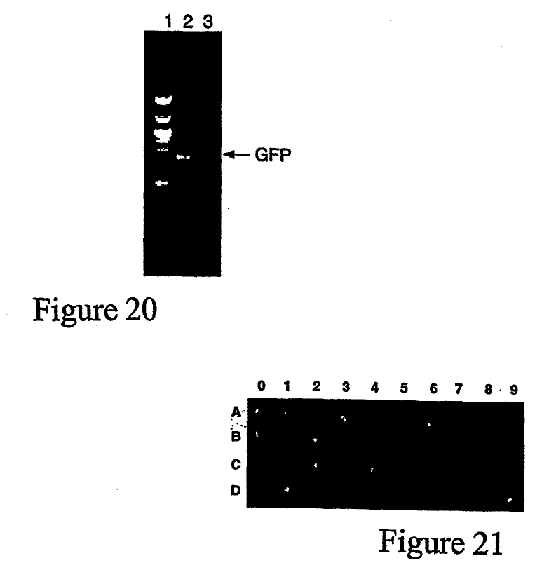

To examine the ligation products from the two fractions, the fill-length GFP sequence was amplified by PCR using the primers. FIG. 20 shows that full-length GFP sequences were obtained from both fractions, but that a reduced amount of full-length GFP is amplified from the fraction treated with T7 endonuclease I. This result suggests that T7 endonuclease I did digest a portion of the ligated GFP products. Additionally, experiments demonstrated that the T7 endonuclease I does not non-specifically degrade DNA.

To test the functionality of the T7 endonuclease I digested fraction, the amplified GFP gene was inserted into BamHI and EcoRI sites of the expression vector pTrcHis, and transformed into XL1-blue competent cells. The transformants were then transferred to grid plates and induced by IPTG. The subcloned EGFP gene was once again used as a positive control. FIG. 21 shows that under UV illumination green fluorescence light was observed from the various colonies expressing the synthesized GFP gene. Significantly, after analyzing approximately 300 colonies from both fractions, 75% of the T7 endonuclease I digested fraction emitted green fluorescence, while only 31% of the colonies from the untreated fraction glowed green. This result suggest that T7 endonuclease I removes mismatched products that occurred during the ligation of the synthesized oligonucleotides, thereby increasing the percentage of error-free full-length GFP gene products produced. Therefore, T7 endonuclease I may be used to clean up the ligation products and decrease the error rate in the generated long DNA sequences.

### EXAMPLE 5

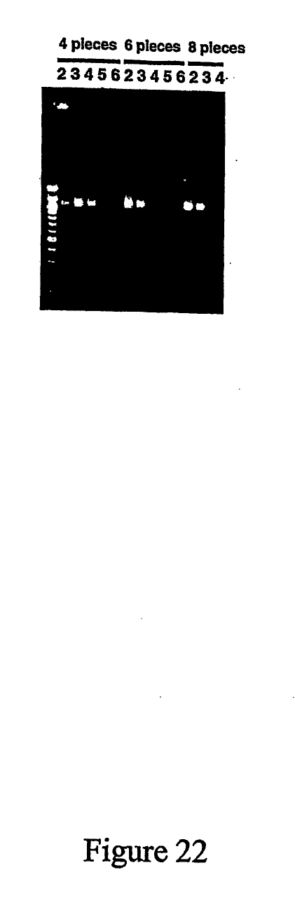

Synthesized oligonucleotide sequences can be annealed and fused together to generate long DNA sequences. To determine whether there are limitations on the number of oligonucleotide sequences that can be fused together, 4 pieces, 6 pieces, and 8 pieces were fused together to generate long DNA sequences, as shown in FIG. 22. Four, six, or eight DNA fragments of the GFP gene were mixed and diluted to a series of concentrations for PCR. The lanes of the gel in FIG. 22 are labeled with 2-6, which indicates the template DNA dilution: lane 2 is 1:4; lane 3 is 1:16; lane 4 is 1:64; lane 5 is 1:256; and lane 6 is 1:1024. As demonstrated in FIG. 22, four, six, or eight DNA fragments can be fused to generate long DNA sequences.

### EXAMPLE 6

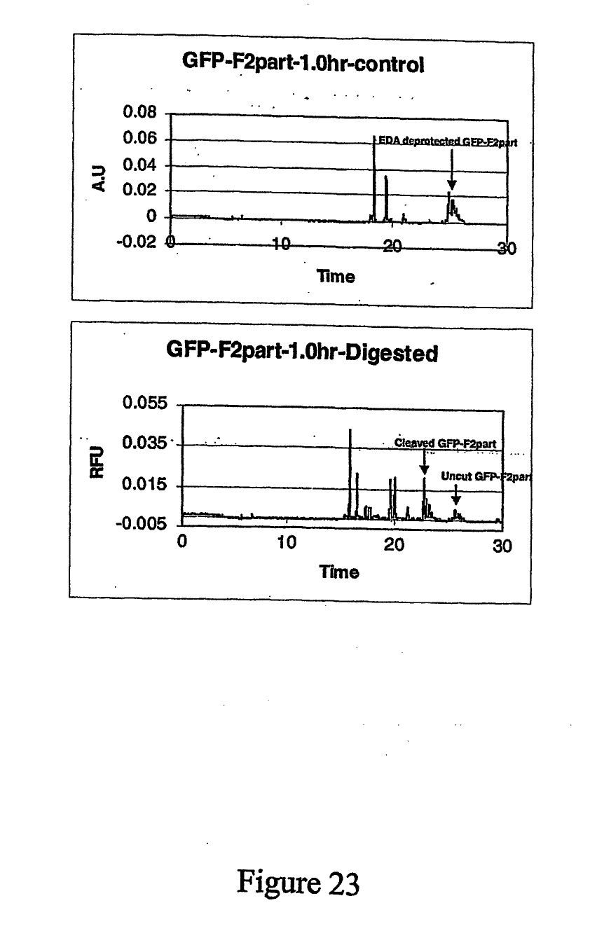

One method for releasing or cleaving synthesized oligonucleotides from a solid substrate is an enzymatic approach involving the use of restriction endonuclease (R.E.) enzymes to selectively and specifically cleave desired oligonucleotides from the substrate surface. To test this approach, the Dpn II R.E. enzyme was used to cleave two complementary oligonucleotide DNAs, the first oligo being GFP-F2Part 5′-CACTGGAGTTGTCCCAATTCTTGgatcggcc-3′ and the second one being DpnIISite 5′-ggccgatcCAA-3′. Since the Dpn II enzyme recognizes and cleaves the sequence 5′-ˆGATC-3′, the isolation of clean oligonucleotides was expected after digestion with the enzyme. Our initial test on the digested oligonucleotides in solution phase was successful. In the experiment, two oligonucleotides were mixed at a molar ratio of 1:5 (GFP-F2Part:DpnIISite) and incubated with or without Dpn II enzyme at 37° C. These reactions were analyzed at various time points with CE (capillary electrophoresis, 10% polyacryliamid gel with 7 M urea). As shown in FIG. 23, approximately 80% of the longer oligonucleotides were cut by Dpn II in 1 hour. This experiment demonstrates the efficient release of synthesized oligonucleotides from the substrate surface through the use of R.E. enzymes.

In other embodiments of the present disclosure, an oligonucleotide sequence can be synthesized such that it will anneal to itself, thereby forming a duplex oligonucleotide with a hairpin loop. The duplex DNA can then be digested with an enzyme, for example a R.E. enzyme, to form double-stranded DNA that can be ligated to other double-stranded DNA and/or oligonucleotides. To demonstrate the ability of a R. E. enzyme to digest a synthesized oligonucleotide that anneals to itself, the following oligonucleotide sequences with FAM label (DEFINE FAM) were synthesized on a chip with a regular DMT chip surface:

| | |
|---|---|
| ePM-40 | FAM-CTGGCAGCAGCCACTTTAACTATGCGGCATTTAACTAT |
| | GCGATCGGCCTTTTGGCCGATCGCATAGTTAAATGCCGCATA |
| | GTTAAAGTGGCTGCTGCCAG |
| ePM-20 | FAM-CTGGCAGCAGCCACTTTAACTATGCGGCATTTAACTAT |
| | GCGATCGGCCTTTTGGCCGATCGCATAGTTAAATGCCGCATA |
| eMM-40 | FAM-CTGGCAGCAGCCACTTTAACTATGCGGCATTTAACTAT |
| | GCGATCGGCCTTTTGGCCGATCGCATAGTTACATGCCGCATA |
| | GTTAAAGTGGCTGCTGCCAG |
| eMM-40-2 | FAM-CTGGCAGCAGCCACTTTAACTATGCGGCATTTAACTAT |
| | GCGATCGGCCTTTTGGCCGATCGCATAGTTACATGCCGCATA |
| | GTTAAAGTGGCCGCTGCCAG |
| eMM-20 | FAM-CTGGCAGCAGCCACTTTAACTATGCGGCATTTAACTAT |
| | GCGATCGGCCTTTTGGCCGATCGCATAGTTACATGCCGCATA |
| eD-40 | FAM-CTGGCAGCAGCCACTTTAACTATGCGGCATTTAACTAT |
| | GCGATCGGCCTTTTGGCCGATCGCATAGTTAATGCCGCATAG |
| | TTAAAGTGGCTGCTGCCAG |
| eD-40-2 | FAM-CTGGCAGCAGCCACTTTAACTATGCGGCATTTAACTAT |
| | GCGATCGGCCTTTTGGCCGATCGCATAGTTAATGCCGCATAG |
| | TTAAAGTGGCGCTGCCAG |
| eD-20 | FAM-CTGGCAGCAGCCACTTTAACTATGCGGCATTTAACTAT |
| | GCGATCGGCCTTTTGGCCGATCGCATAGTTAATGCCGCATA |

All of these oligonucleotide sequences are able to form an intra-molecular duplex that contains a 5′GATC-3′ site, which is recognized and cleaved by the Dpn II R.E. enzyme. After the oligonucleotides were synthesized on the chip and deprotected with EDA, the Dpn II R.E. enzyme was pumped through the chip at 37° C. for 1 hour. The FAM images of the chip demonstrated that 90% of the FAM signals were lost after the oligonucleotides were exposed to the R.E. enzyme. This result suggests that the Dpn II R.E. enzyme was able to cleave the synthesized double-stranded oligonucleotides.

### EXAMPLE 7

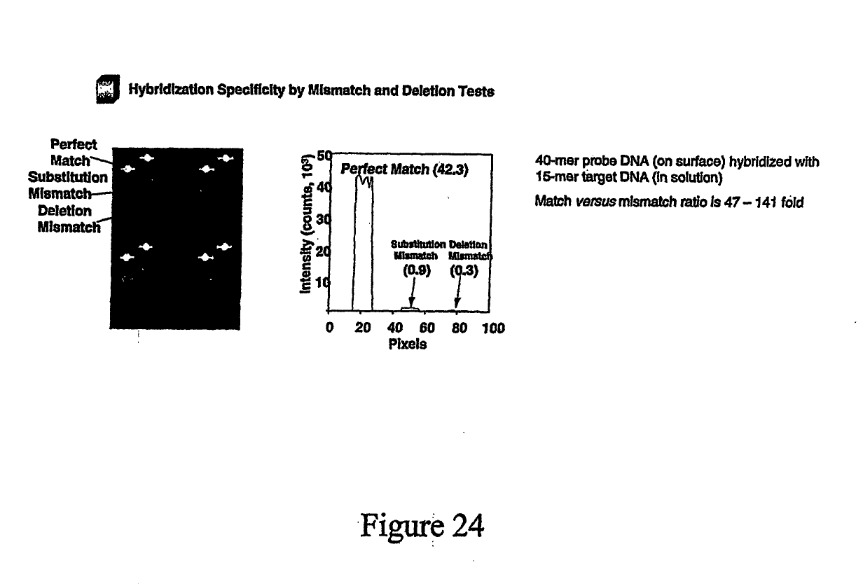

As set forth earlier in this application, the PGA chemistry used to generate oligonucleotides in the present disclosure achieves a better than 98% yield per step in the synthesis of oligonucleotides. Indeed, an examination of the hybridization specificity by mismatch and deletion tests of oligonucleotides synthesized using this chemistry demonstrated a high level of discrimination for substitution and deletion/insertion mutations. FIG. 24 shows the results of oligonucleotide hybridization on a chip for discriminating perfectly matched synthesized oligonucleotides from mismatched oligonucleotides with a single base pair mismatch, deletion, or insertion. 40-mer DNA oligonucleotides were synthesized on the surface of the chip, and hybridized with 15-mer target DNA in solution. The match versus mismatch ratio was found to be 47-141 fold. Therefore, more than a 50-fold level of discrimination is found for a substitution mutation and more than a 140-fold level of discrimination is observed for a deletion or insertion mutation.

This efficiency of the PGA chemistry utilized in the present disclosure also results in the ability of this chemistry to generate synthetic oligonucleotide sequences that are significantly longer than those that could be synthesized using previously disclosed methods. A programmable light-directed synthesis system was used to synthesize oligomers up to 100 nucleotides in length on a microfluidic array chip. The oligonucleotides synthesized on a chip were as follows:

| | |
|---|---|
| Puc2PM-100 | CTGGCAGCAGCCACTTTAACTATGCGGCATTTAACTATG |
| | CGGCATTTAACTATGCGGCATTTAACTATGCGGCATTAA |
| | CTATGCGGCATTTAACTATGC |
| Puc2PM-95 | CTGGCAGCAGCCACTTTAACTATGCGGCATTTAACTATG |
| | CGGCATTTAACTATGCGGCATTTAACTATGCGGCATTAA |
| | CTATGCGGCATTTAAC |
| Puc2PM-90 | CTGGCAGCAGCCACTTTAACTATGCGGCATTTAACTATG |
| | CGGCATTTAACTATGCGGCATTTAACTATGCGGCATTAA |
| | CTATGCGGCAT |
| Puc2PM-85 | CTGGCAGCAGCCACTTTAACTATGCGGCATTTAACTATG |
| | CGGCATTTAACTATGCGGCATTTAACTATGCGGCATTAA |
| | CTATGC |
| Puc2PM-80 | CTGGCAGCAGCCACTTTAACTATGCGGCATTTAACTATG |
| | CGGCATTTAACTATGCGGCATTTAACTATGCGGCATTAA |
| | C |
| Puc2PM-75 | CTGGCAGCAGCCACTTTAACTATGCGGCATTTAACTATG |
| | CGGCATTTAACTATGCGGCATTTAACTATGCGGCAT |
| Puc2PM-70 | CTGGCAGCAGCCACTTTAACTATGCGGCATTTAACTATG |
| | CGGCATTTAACTATGCGGCATTTAACTATGC |
| Puc2PM-85 | CTGGCAGCAGCCACTTTAACTATGCGGCATTTAACTATG |
| | CGGCATTTAACTATGCGGCATTTAAC |
| Puc2PM-60 | CTGGCAGCAGCCACTTTAACTATGCGGCATTTAACTATG |
| | CGGCATTTAACTATGCGGCAT |
| Puc2PM-55 | CTGGCAGCAGCCACTTTAACTATGCGGCATTTAACTATG |
| | CGGCATTTAACTATGC |
| Puc2PM-50 | CTGGCAGCAGCCACTTTAACTATGCGGCATTTAACTATG |
| | CGGCATTTAAC |
| Puc2PM-45 | CTGGCAGCAGCCACTTTAACTATGCGGCATTTAACTATG |
| | CGGCAT |
| Puc2PM-40 | CTGGCAGCAGCCACTTTAACTATGCGGCATTTAACTATG |
| | C |
| Puc2PM-35 | CTGGCAGCAGCCACTTTAACTATGCGGCATTTAAC |
| Puc2PM-30 | CTGGCAGCAGCCACTTTAACTATGCGGCAT |
| Puc2PM-25 | CTGGCAGCAGCCACTTTAACTATGC |
| Puc2PM-20 | CTGGCAGCAGCCACTTTAAC |
| Puc2PM-15 | CTGGCAGCAGCCACT |
| Puc2MM-100 | CTGGCAGTAGCCACTTTAACTATGCGGCATTTAACTATG |
| | CGGCATTTAACTATGCGGCATTTAACTATGCGGCATTAA |
| | CTATGCGGCATTTAACTATGC |
| Puc2MM-95 | CTGGCAGTAGCCACTTTAACTATGCGGCATTTAACTATG |
| | CGGCATTTAACTATGCGGCATTTAACTATGCGGCATTAA |
| | CTATGCGGCATTTAAC |
| Puc2MM-90 | CTGGCAGTAGCCACTTTAACTATGCGGCATTTAACTATG |
| | CGGCATTTAACTATGCGGCATTTAACTATGCGGCATTAA |
| | CTATGCGGCAT |
| Puc2MM-85 | CTGGCAGTAGCCACTTTAACTATGCGGCATTTAACTATG |
| | CGGCATTTAACTATGCGGCATTTAACTATGCGGCATTAA |
| | CTATGC |
| Puc2MM-80 | CTGGCAGTAGCCACTTTAACTATGCGGCATTTAACTATG |
| | CGGCATTTAACTATGCGGCATTTAACTATGCGGCATTAA |
| | C |
| Puc2MM-75 | CTGGCAGTAGCCACTTTAACTATGCGGCATTTAACTATG |
| | CGGCATTTAACTATGCGGCATTTAACTATGCGGCAT |
| Puc2MM-70 | CTGGCAGTAGCCACTTTAACTATGCGGCATTTAACTATG |
| | CGGCATTTAACTATGCGGCATTTAACTATGC |
| Puc2MM-65 | CTGGCAGTAGCCACTTTAACTATGCGGCATTTAACTATG |
| | CGGCATTTAACTATGCGGCATTTAAC |
| Puc2MM-60 | CTGGCAGTAGCCACTTTAACTATGCGGCATTTAACTATG |
| | CGGCATTTAACTATGCGGCAT |
| Puc2MM-55 | CTGGCAGTAGCCACTTTAACTATGCGGCATTTAACTATG |
| | CGGCATTTAACTATGC |
| Puc2MM-50 | CTGGCAGTAGCCACTTTAACTATGCGGCATTTAACTATG |
| | CGGCATTTAAC |
| Puc2MM-45 | CTGGCAGTAGCCACTTTAACTATGCGGCATTTAACTATG |
| | CGGCAT |
| Puc2MM-40 | CTGGCAGTAGCCACTTTAACTATGCGGCATTTAACTATG |
| | C |
| Puc2MM-35 | CTGGCAGTAGCCACTTTAACTATGCGGCATTTAAC |
| Puc2MM-30 | CTGGCAGTAGCCACTTTAACTATGCGGCAT |
| Puc2MM-25 | CTGGCAGTAGCCACTTTAACTATGC |
| Puc2MM-20 | CTGGCAGTAGCCACTTTAAC |
| Puc2MM-15 | CTGGCAGTAGCCACT |
| Puc2D-100 | CTGGCAGAGCCCACTTTAACTATGCGGCATTTAACTATG |
| | CGGCATTTAACTATGCGGCATTTAACTATGCGGCATTAA |
| | CTATGCGGCATTTAACTATGC |
| Puc2D-95 | CTGGCAGAGCCCACTTTAACTATGCGGCATTTAACTATG |
| | CGGCATTTAACTATGCGGCATTTAACTATGCGGCATTAA |
| | CTATGCGGCATTTAAC |
| Puc2D-90 | CTGGCAGAGCCCACTTTAACTATGCGGCATTTAACTATG |
| | CGGCATTTAACTATGCGGCATTTAACTATGCGGCATTAA |
| | CTATGCGGCAT |
| Puc2D-85 | CTGGCAGAGCCCACTTTAACTATGCGGCATTTAACTATG |
| | CGGCATTTAACTATGCGGCATTTAACTATGCGGCATTAA |
| | CTATGC |
| Puc2D-80 | CTGGCAGAGCCCACTTTAACTATGCGGCATTTAACTATG |
| | CGGCATTTAACTATGCGGCATTTAACTATGCGGCATTAA |
| | C |
| Puc2D-75 | CTGGCAGAGCCCACTTTAACTATGCGGCATTTAACTATG |
| | CGGCATTTAACTATGCGGCATTTAACTATGCGGCAT |
| Puc2D-70 | CTGGCAGAGCCCACTTTAACTATGCGGCATTTAACTATG |
| | CGGCATTTAACTATGCGGCATTTAACTATGC |
| Puc2D-65 | CTGGCAGAGCCCACTTTAACTATGCGGCATTTAACTATG |
| | CGGCATTTAACTATGCGGCATTTAAC |
| Puc2D-60 | CTGGCAGAGCCCACTTTAACTATGCGGCATTTAACTATG |
| | CGGCATTTAACTATGCGGCAT |
| Puc2D-55 | CTGGCAGAGCCCACTTTAACTATGCGGCATTTAACTATG |
| | CGGCATTTAACTATGC |
| Puc2D-50 | CTGGCAGAGCCCACTTTAACTATGCGGCATTTAACTATG |
| | CGGCATTTAAC |
| Puc2D-45 | CTGGCAGAGCCCACTTTAACTATGCGGCATTTAACTATG |
| | CGGCAT |
| Puc2D-40 | CTGGCAGAGCCCACTTTAACTATGCGGCATTTAACTATG |
| | C |
| Puc2D-35 | CTGGCAGAGCCCACTTTAACTATGCGGCATTTAAC |
| Puc2D-30 | CTGGCAGAGCCCACTTTAACTATGCGGCAT |
| Puc2D-25 | CTGGCAGAGCCCACTTTAACTATGC |
| Puc2D-20 | CTGGCAGAGCCCACTTTAAC |
| Puc2D-15 | CTGGCAGAGCCCACT |
| Stem-85 | TTAACTATGCGGCATTTAACTATGCGGCATTTAACTATG |
| | CGGCATTTAACTATGCGGCATTTAACTATGCGGCATTAA |
| | CTATGC |
| Stem-80 | TTAACTATGCGGCATTTAACTATGCGGCATTTAACTATG |
| | CGGCATTTAACTATGCGGCATTTAACTATGCGGCATTAA |
| | C |
| Stem-75 | TTAACTATGCGGCATTTAACTATGCGGCATTTAACTATG |
| | CGGCATTTAACTATGCGGCATTTAACTATGCGGCAT |
| Stem-70 | TTAACTATGCGGCATTTAACTATGCGGCATTTAACTATG |
| | CGGCATTTAACTATGCGGCATTTAACTATGC |
| Stem-65 | TTAACTATGCGGCATTTAACTATGCGGCATTTAACTATG |
| | CGGCATTTAACTATGCGGCATTTAAC |
| Stem-60 | TTAACTATGCGGCATTTAACTATGCGGCATTTAACTATG |
| | CGGCATTTAACTATGCGGCAT |
| Stem-55 | TTAACTATGCGGCATTTAACTATGCGGCATTTAACTATG |
| | CGGCATTTAACTATGC |
| Stem-50 | TTAACTATGCGGCATTTAACTATGCGGCATTTAACTATG |
| | CGGCATTTAAC |
| Stem-45 | TTAACTATGCGGCATTTAACTATGCGGCATTTAACTATG |
| | CGGCAT |
| Stem-40 | TTAACTATGCGGCATTTAACTATGCGGCATTTAACTATG |
| | C |
| Stem-35 | TTAACTATGCGGCATTTAACTATGCGGCATTTAAC |
| Stem-30 | TTAACTATGCGGCATTTAACTATGCGGCAT |
| Stem-25 | TTAACTATGCGGCATTTAACTATGC |
| Stem-20 | TTAACTATGCGGCATTTAAC |
| Stem-15 | TTAACTATGCGGCAT |
| Stem-10 | TTAACTATGC |
| Stem-5 | TTAAC |

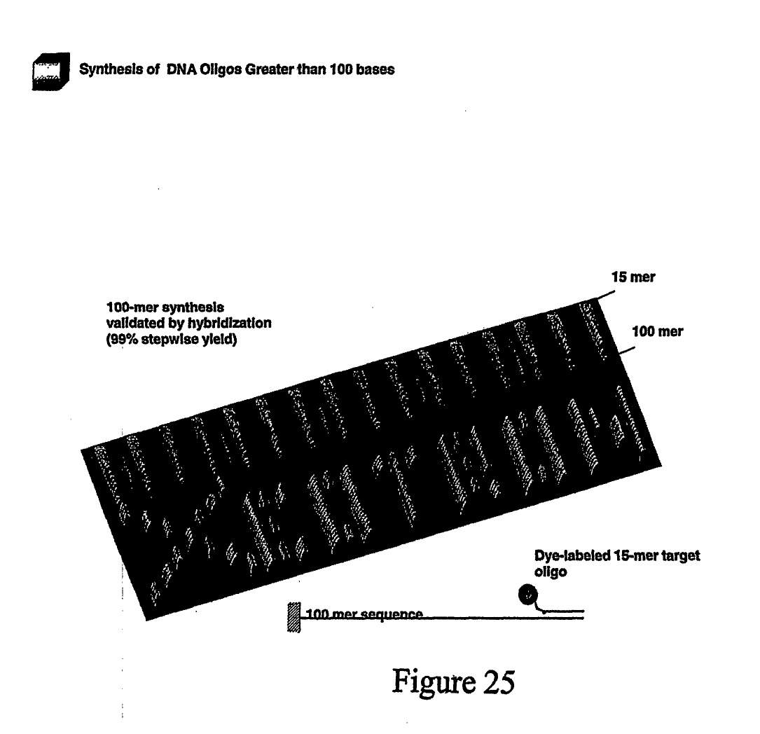

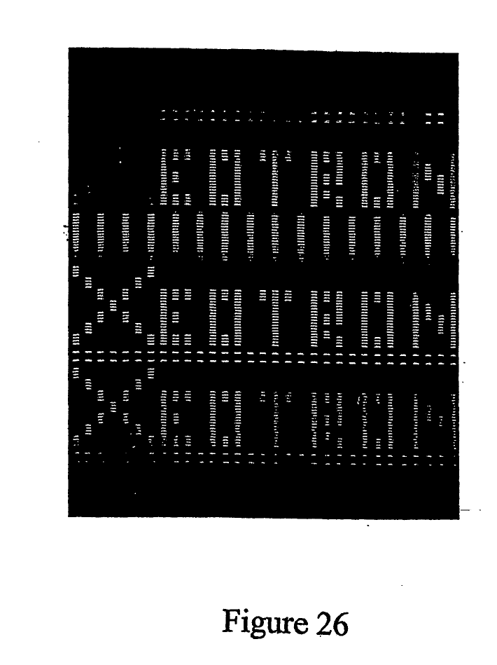

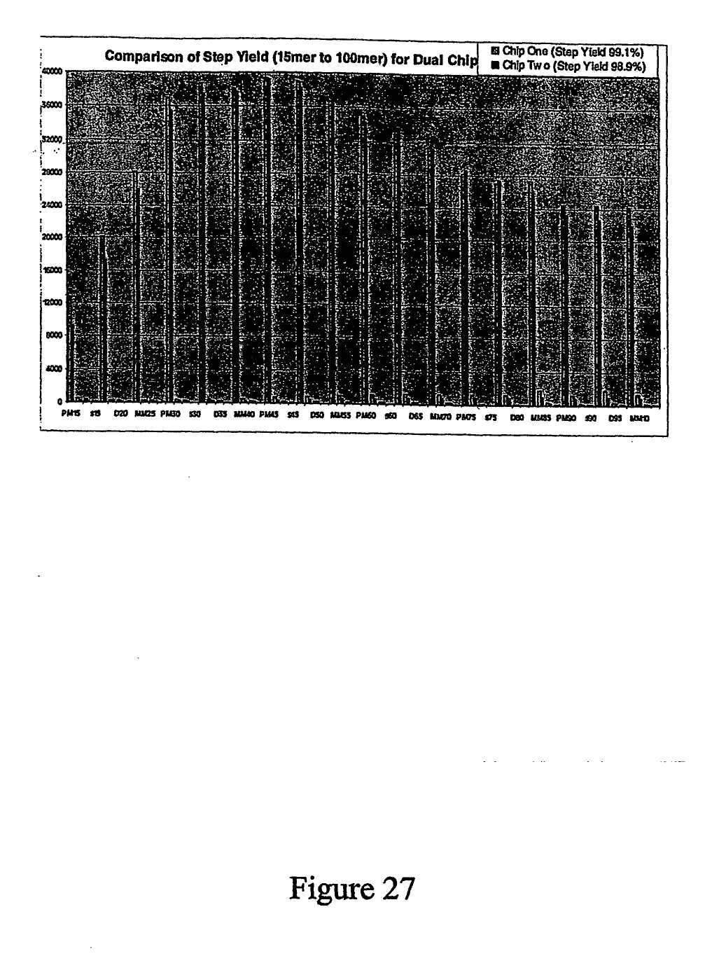

The oligonucleotides were designed to contain a 15-mer probe (CTGGCAGCAGCCACT) at their 5′-end and connected to variable sizes of non-probe sequence from 0 to 85 nucleotides in length. Additionally, a single base mismatch 15-mer (CTGGCAGTAGCCACT) probe and a single base deletion 14-mer (CTGGCAGAGCCACT) probe were also synthesized on the chip as control sequences. Oligonucleotides from 5 to 100 nucleotides in length were synthesized on the chip, and the two control sequences were arranged side by side in the array for comparison purpose. After the oligomers were synthesized on the array chip, the chip was deprotected with EDA at room temperature for 2 hours and fill with 6×SSPE buffer. The 15 nucleotide target oligonucleotide labeled with a Cy3 dye was hybridized to the chip in 6×SSPE for 2 hours at room temperature, and the chip was subsequently washed with 0.001×SSPE buffer. As illustrated in FIG. 25 and shown in FIG. 26, the presence of fluorescence on the chip after the hybridization assay demonstrates that 100-mer oligonucleotides were synthesized on the chip. Additionally, the fluorescence intensity profile indicated a stepwise yield of 98.5% for the synthesis of these long oligonucleotides, which is a significant improvement over known methods for synthesizing oligonucleotides on an array chip. In another experiment, a comparison of the per step yield for oligonucleotides 15 to 100 nucleotides in length on a dual chip demonstrated an even higher stepwise yield of 98.9% and 99.1% (FIG. 27).

### EXAMPLE 8

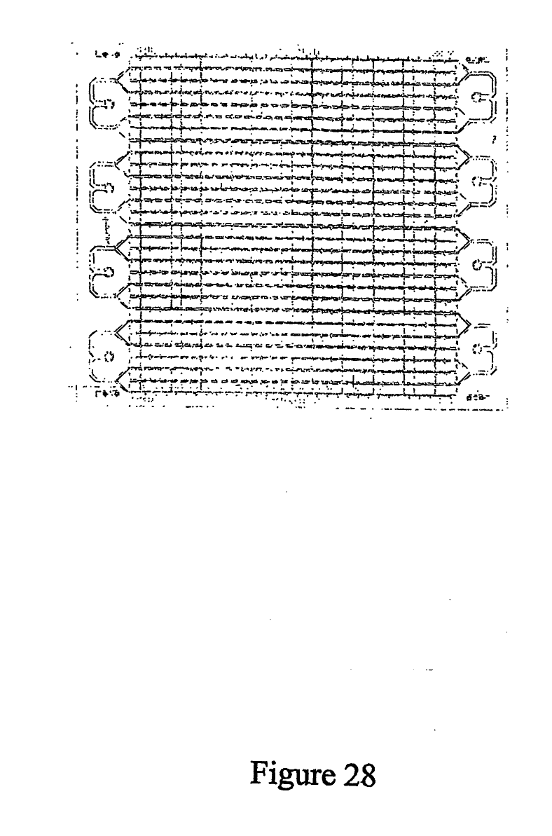

FIG. 28 is an illustration of the design of a microfluidic array chip for DNA synthesis. The purpose of this chip is to synthesize oligonucleotide DNA at very high yields and low error rates. The chip is designed to contain four sub-arrays, each containing 224 reaction chambers. Each reaction chamber measures 400×400×10 μm³ and has a capacity of producing up to 0.16 pmole oligonucleotide DNA. The oligonucleotide DNA can then be released from the chip and collected into a 20-μl aliquots of solution, and the solution concentration for each oligonucleotide would be approximately 8 nM. This concentration of oligonucleotide is sufficient for ligating different synthesized oligonucleotides together to form a long DNA sequence. Each sub-array is sufficient to make a complete set of oligonucleotide DNA for assembling into a 1,000 to 1,500 bp long DNA segment. The number of reaction chambers (224) in each sub-array is also large enough to allow for the production of multiple redundancies for each oligonucleotide. Therefore, one chip as shown in FIG. 28 could be used to synthesize a DNA sequence approximately 1500×4=6,000 bp long. It is well within the skill of those in the art to alter this design and fabricate chips to generate DNA sequences of 10,000 bp or longer.

The main consideration for reaction chamber design is to maximize deblock efficiency and minimize optical and chemical cross talk between adjacent reaction chambers. Long and narrow induction conduits are used as the inlet and outlet of the reaction chamber to provide a sufficient chemical confinement for retaining acid inside the reaction chamber after light exposure so as to ensure complete deblock reaction. CFD (computational fluidic dynamics) simulations were performed to assess fluid flow distribution, pressure distribution, bubble trapping/removal, and chemical diffusion. This reaction chamber configuration results in a significant improvement of chemical confinement, which will reduce error-rates during oligonucleotide synthesis.

### EXAMPLE 9

The disclosed methods for generating pools of oligomers can also be used to generate an RNAi (RNA interference) chip. 252 oligonucleotides were generated on an RNAi chip using the methods previously outlined, with each oligonucleotide synthesized containing a SAP1 sequence (TGCAGTTAGCTCTTCCAAT) at the 3′ end, a variable RNAi specific sequence in the middle (22 nucleotides in length), and a T7 promotor sequence (CCTATAGTGAGTCGTATTA) at the 5′-end (total length about 60 nucleotides). In order to cleave the oligonucleotides from the chip, reverse-U was incorporated into the 3′-end of all oligonucleotides. Additionally, the same two control oligonucleotides (Puc2PM-perfect match and Puc2MM-mismatch) as disclosed in Example 3 were also synthesized on the RNAi chip. The quality of the oligonucleotides synthesized on the RNAi chip was also analyzed by hybridization with Cy3 labeled 15-mer Puc2 target as outlined in Example 3.

After oligonucleotide synthesis, the oligonucleotides were cleaved from the chip with Rnace-it (RNase A plus RNase T1, Stratagene) at 37° C. for 60 minutes, with circulation. The cleaved products were then collected in an eppendorf tube in a volume of 100 μl. 5 μl of the cleaved oligonucleotides was used as a template for PCR amplification using the SAP1 and T7 specific sequences as universal primers. The PCR conditions used were as follows:

| | |
|---|---|
| Taq PCR buffer | 1x |
| Mg++ | 2.5 mM |
| Template | 5 ul of cleavage product |
| Primers | 0.2 uM each |
| dNTP | 0.5 mM each |
| Taq DNA polymerase | 2.5 Unites |
| Total volume | 50 ul |

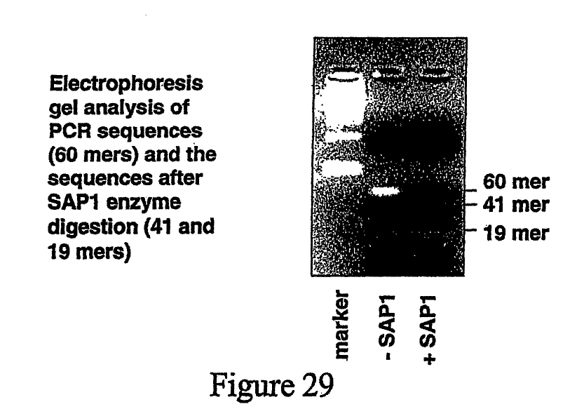

The PCR reaction was first heated to 94° C. for 2 minutes to denature the DNA, and then 35 cycles were performed with the following reaction conditions: 94° C. for 30 seconds; 50° C. for 30 seconds, and 72° C. for 30 seconds. The PCR products were a pool of double stranded short DNA fragments. The sizes of the PCR products, as well as the PCR products digested with the restriction enzyme SAP1 were analyzed on an agarose gel. The results of the agarose gel indicated that the PCR products were the correct size (60 bp), and that the SAP1 digested samples were the expected two bands of 41 bp and 19 bp (FIG. 29).

The content of this oligonucleotide library can be validated by hybridization to a detection chip. 5 μl of the PCR products were used for a linear PCR reaction with fluorescent-labeled SAP1 (cy3 labeled sense strands) and T7 (cy5 labeled anti-sense strands) primers in separate reactions. The PCR conditions were basically the same as described above, except that only one primer was used in each reaction, and the total cycle number was 45. The linear PCR generated labeled single stranded DNA molecules, which are complimentary to the probes on a detection chip. The detection chip was designed for the evaluation of the PCR DNA products and their transcripts. 252 sense probes (S) and 252 anti-sense probes (A) were arranged in a chess-board pattern and in six repeated blocks on the detection chip. In another block, anti-sense probes were arranged in a perfect match (S), single deletion (DS), and double deletion (DDS) pattern The two sets of labeled single stranded DNA were hybridized with the detection chip. The cy3 labeled strands fluoresce green, while the cy5 anti-sense strands fluoresce red. One region of the chip showed both red and green colors because it contained probes for both types of DNA fragments. Another region showed only the green color because it only contained probes for the anti-sense sequence, thus demonstrating the specificity of the hybridization events. Overall 96% of spots on the chip showed hybridization as judged by intensity (although the intensity strength is not necessarily a quantitative measurement due to the influence of probe properties). These hybridization results indicate the high sequence specificity of the DNA templates (oligonucleotides) synthesized on the chip and the suitability of these oligonucleotides for PCR reactions.

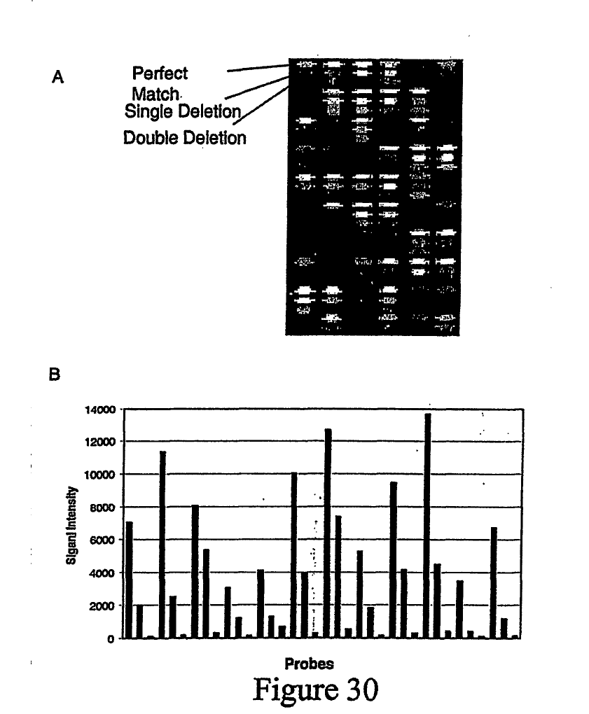

The double stranded DNA PCR products were also used for in vitro transcription (MEGAscript, Ambion) to generate single stranded RNA. The position of the T7 promoter was designed to generate anti-sense RNA molecules, so they would hybridize to sense strand probes on the detection chip. The RNA molecules were labeled during the in vitro transcription by adding cy3 or cy5 dUTP in the reaction mix. Two types of RNA molecules were transcribed: The DNA templates digested by SAP1 produced RNA molecules with 21-22 bases (cy3 labeled), and the templates without SAP1 digestion produced RNA molecules with 40-41 bases (cy5 labeled), with 19 of the bases being common SAP1 primer sequence. The same detection chip used above was again used to analyze the RNA molecules produced by in vitro transcription of the DNA PCR products. FIG. 30A is a representative image from the dual color co-hybridization experiment using both 21-22 and 41-mer transcribed RNA sequences. The chip contains probes which are perfect matches (S) to the siRNA targets and probes which contain one (DS) or two (DDS) deletions. These probes are arranged vertically in order of S, DS, and DDS. FIG. 30B is a representative bar graph of the hybridization intensities shown in FIG. 30B drawing vertically along a column. Each type of probe is plotted in order of S, DS, or DDS from left to right, three bars in a set. These results demonstrate that the RNA targets bind specifically to the perfect match, but less tightly to the one deletion probes and nearly not at all to the two deletion probes. Overall the RNA samples gave positive signals to >89% probes for both the 21-22 and 41-mer sequences, although there was a large variation in signal intensities.

All of the compositions and methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the methods described herein without departing from the concept, spirit and scope of the invention. More specifically, it will be apparent that certain agents that are chemically or physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for parallel synthesis of an array of selected multimers on a substrate comprising isolated reaction sites containing one or more protected initiating moieties, the method comprising:
(a) selectively irradiating isolated reaction sites to generate deprotected initiating moieties at the irradiated isolated reaction sites;
(b) coupling one or more monomers to the deprotected initiating moieties;
(c) repeating steps (a)-(b) until the array of selected multimers has been synthesized;
wherein the multimers synthesized comprise multimers from about 75 to 200 monomers is length.

2. The method of claim 1, wherein the multimers synthesized comprise multimers from about 100 to 125 monomers is length.

3. The method of claim 1, wherein the selected multimers are DNA.

4. The method of claim 1, wherein the selected multimers are oligonucleotides.

5. The method of claim 1, wherein the selected multimers are RNA.

6. The method of claim 1, wherein the selected multimers are DNA/RNA hybrids.

7. The method of claim 1, wherein the selected multimers are peptides.

8. The method of claim 1, wherein the selected multimers are carbohydrates.

9. The method of claim 1, wherein the deprotected initiating moieties are generated by:
(a) contacting the substrate with a liquid solution comprising one or more photo-reagent precursors, such that the liquid solution is in contact with the initiating moieties;
(b) selectively irradiating isolated reaction sites to produce one or more photo-generated reagents, wherein the photo-generated reagents are effective to deprotect the initiating moieties at the irradiated isolated reaction sites.

10. The method of claim 10, wherein the photo-reagent precursors are selected from the group consisting of acid precursors and base precursors.

11. The method of claim 1, wherein the monomer comprises an unprotected reactive site and a protected reactive site.

12. The method of claim 1, where in the monomer is selected from the group consisting of nucleophosphoramidites, nucleophosphonates and analogs thereof.

13. The method of claim 1, wherein the protected initiating moieties are protected by an acid-labile group.

14. The method of claim 1, wherein the protected initiating moieties comprise linker molecules, wherein each of the linker molecules comprise a reactive functional group protected by an acid-labile group.

15. A method of generating a DNA sequence comprising: selecting suitable oligonucleotide subchains for the assembly of the DNA sequence, wherein the subchains are designed so that the DNA sequence is formed by the annealed subchains;
parallel synthesis of the subchains on a solid support, wherein the subchains are from about 75 to about 150 nucleotides in length;
annealing the subchains;
ligating the annealed subchains to generate the DNA sequence.

16. The method of claim 15, wherein the DNA sequence is 100 bp to 1,000 bp in length.

17. The method of claim 15, wherein the DNA sequence is 1,000 bp to 10,000 bp in length.

18. The method of claim 15, wherein the DNA sequence is selected from the group consisting of genes, gene fragments, transposons, regulatory regions, transcription machines, expression constructs, gene therapy constructs, homologous recombination constructs, vaccine constructs, viral genomes, vectors, and artificial chromosomes.

19. The method of claim 15, wherein the subchains are cleaved from the solid support before the subchains are annealed.

20. The method of claim 19, wherein predetermined subchains are cleaved from the solid support before the subchains are annealed.

21. The method of claim 20, wherein the predetermined subchains are annealed to subchains attached to the solid support.

22. The method of claim 20, wherein the subchains are cleaved from the solid support using a restriction endonuclease enzyme.

23. The method of claim 15, wherein the oligonucleotide subchains comprise one or more reverse-U linkers.

24. The method of claim 23, wherein the oligonucleotide subchains are cleaved from the solid support using RNase A.

25. The method of claim 15, wherein the oligonucleotide subchains are designed so that gaps are present in the duplex DNA sequence formed by the annealed subchains.

26. The method of claim 25, wherein the gaps present in the duplex DNA sequence are filled in with a DNA polymerase.

27. A method of generating a DNA sequence comprising:
a) selecting suitable oligonucleotide subchains for the assembly of tie DNA sequence, wherein the subchains are designed so that the duplex DNA sequence is formed by the annealed subchains;
b) parallel synthesis of the subchains on a solid support, wherein a 98% coupling efficiency or greater per step of oligonucleotide synthesis is achieved;
c) annealing the subchains;
d) ligating the annealed subchains to generate the DNA sequence.

28. A method of generating a library of short RNA molecules comprising:
a) synthesizing an array of selected oligonucleotides on a substrate, wherein the selected oligonucleotides comprise an RNA polymerase promoter sequence, wherein the substrate comprises protected initiating moieties at specific reaction sites on the substrate, comprising:
i) contacting the substrate with a liquid solution comprising one or more photo-reagent precursors, such that the liquid solution is in contact with the protected initiating moieties;
ii) isolating the specific reaction sites;
iii) selectively irradiating isolated reaction sites to produce one or more photo-generated reagents, wherein the photo-generated reagents are effective to deprotect the initiating moieties at the irradiated reaction sites;
iv) contacting the substrate with a monomer, wherein the monomer comprises an unprotected reactive site and a protected reactive site, under conditions such that the unprotected reactive site of the monomer couples with the deprotected initiating moieties so as to create an attached monomer and protected initiating moieties;
v) repeating steps (i)-(iv) until the array of selected oligonucleotides has been synthesized;
wherein the selected oligonucleotides comprise two specific primer sequences for DNA amplification;
b) cleaving of the selected oligonucleotides from the solid support;
c) amplifying the selected oligonucleotides using primers that recognize the specific primer sequences, wherein double stranded DNA comprising the sequences of the selected oligonucleotides is generated;
d) in vitro transcription of the amplified double stranded DNA using an RNA polymerase that recognizes the RNA promoter sequence, wherein a library of short RNA molecules is generated.

29. The method of claim 28, wherein the short RNA molecules are short interfering RNA (siRNA) molecules.

30. The method of claim 28, wherein the selected oligonucleotides comprise one or more reverse-U linkers.

31. The method of claim 31, wherein the selected oligonucleotides are cleaved from the solid support using RNase A.

32. The method of claim 28, wherein the selected oligonucleotide comprise one or more restriction enzyme sites.

33. The method of claim 28, wherein the RNA polymerase is selected from the group consisting of T7 RNA polymerase, SP6 RNA polymerase, and T3 RNA polymerase.

34. A method of large-scale Single Nucleotide Polymorphism (SNP) detection in a DNA sample comprising:
a) designing an array of primer pairs that will amplify an array of amplicons from the DNA sample, wherein each amplicon comprises one or more SNPs;
b) synthesizing the array of primer pairs on a substrate, wherein the substrate comprises protected initiating moieties at specific reaction sites on the substrate, comprising:
i) contacting the substrate with a liquid solution comprising one or more photo-reagent precursors, such that the liquid solution is in contact with the protected initiating moieties;
ii) isolating the specific reaction sites;
iii) selectively irradiating isolated reaction sites to produce one or more photo-generated reagents, wherein the photo-generated reagents are effective to deprotect the initiating moieties at the irradiated reaction sites;
iv) contacting the substrate with a monomer, wherein the monomer comprising an unprotected reactive site and a protected reactive site, under conditions such that the unprotected reactive site of the monomer couples with the deprotected initiating moieties so as to create an attached monomer and protected initiating moieties;
v) repeating steps (i)-(iv) until the array of selected oligonucleotides has been synthesized;
wherein a single primer pair is synthesized in each reaction site on the substrate;
b) DNA amplification of the amplicons using the primer pairs, wherein a single amplicon is generated in each reaction site on the substrate;
c) detection of the one or more SNPs present in each amplicon.

35. The method of claim 34, wherein the one or more SNPs present in each amplicon are detected by PCR, Oligonucleotide Ligation Assay (OLA), mismatch hybridization, Single Base Extension Assay, RFLP detection based on allele-specific restriction-endonuclease cleavage, or hybridization with allele-specific oligonucleotide probes.

36. A method of large-scale Single Nucleotide Polymorphism (SNP) detection in a DNA sample comprising:
a) designing an array of primer pairs that will amplify an array of amplicons from the DNA sample, wherein each primer pair will only amplify an amplicon if a particular SNP is present in the DNA sample;
b) synthesizing the array of primer pairs on a substrate, wherein the substrate comprises protected initiating moieties at specific reaction sites on the substrate, comprising:
i) contacting the substrate with a liquid solution comprising one or more photo-reagent precursors, such that the liquid solution is in contact with the protected initiating moieties;
ii) isolating the specific reaction sites;
iii) selectively irradiating isolated reaction sites to produce one or more photo-generated reagents, wherein the photo-generated reagents are effective to deprotect the initiating moieties at the irradiated reaction sites;
iv) contacting the substrate with a monomer, wherein the monomer comprising an unprotected reactive site and a protected reactive site, under conditions such that the unprotected reactive site of the monomer couples with the deprotected initiating moieties so as to create an attached monomer and protected initiating moieties;
v) repeating steps (i)-(iv) until the array of selected oligonucleotides has been synthesized;
wherein a single primer pair is synthesized in each reaction site on the substrate;
b) DNA amplification of the amplicons using the primer pairs, wherein the amplification of an amplicon indicates the presence of a particular SNP in the DNA sample.

37. A method of generating an oligonucleotide library comprising:
a) synthesizing an array of selected oligonucleotides on a substrate, wherein the selected oligonucleotides comprise two specific primer sequences and a variable region of sequence, wherein the substrate comprises protected initiating moieties at specific reaction sites on the substrate, comprising:
i) contacting the substrate with a liquid solution comprising one or more photo-reagent precursors, such that the liquid solution is in contact with the protected initiating moieties;
ii) isolating the specific reaction sites;
iii) selectively irradiating isolated reaction sites to produce one or more photo-generated reagents, wherein the photo-generated reagents are effective to deprotect the initiating moieties at the irradiated reaction sites;
iv) contacting the substrate with a monomer, wherein the monomer comprising an unprotected reactive site and a protected reactive site, under conditions such that the unprotected reactive site of the monomer couples with the deprotected initiating moieties so as to create an attached monomer and protected initiating moieties;
v) repeating steps (i)-(iv) until the array of selected oligonucleotides has been synthesized;
b) cleavage of the selected oligonucleotides from the solid support;
c) DNA amplification of the selected oligonucleotides using primers that recognize the specific primer sequences, thereby generating an oligonucleotide library of double stranded DNA sequences comprising the variable region sequences of the selected oligonucleotides.


SEQUENCE LISTING (129 sequences)

SEQ ID NO: 1 - DNA, 80 bp, Artificial
  Oligonucleotide probes
  misc_feature (40)..(40): n = reverse Uridine
  misc_feature (80)..(80): n = reverse Uridine
caaggatcttaccgctgttgtgaggagacttgcctggtgntaatacgactcactataggtctgcaggaactggatcaggn

SEQ ID NO: 2 - DNA, 81 bp, Artificial
  Oligonucleotide probes
  misc_feature (41)..(41): n = reverse Uridine
  misc_feature (81)..(81): n = reverse Uridine
caaggatcttaccgctgttggtgaccctgcagagatatctntaatacgactcactatagggttccggaagtaggtgatgtn

SEQ ID NO: 3 - DNA, 80 bp, Artificial
  Oligonucleotide probes
  misc_feature (41)..(41): n = reverse Uridine
  misc_feature (80)..(80): n = reverse Uridine
caaggatcttaccgctgttggattggcattgccatgggatntaatacgactcactataggtccacagcagctacgatggn

SEQ ID NO: 4 - DNA, 81 bp, Artificial
  Oligonucleotide probes
  misc_feature (40)..(40): n = reverse Uridine
  misc_feature (81)..(81): n = reverse Uridine
caaggatcttaccgctgttgtgaggagacttgcctggtgncgctccagacttgagtccgatctgcaggaactggatcaggn

SEQ ID NO: 5 - DNA, 82 bp, Artificial
  Oligonucleotide probes
  misc_feature (41)..(41): n = reverse Uridine
  misc_feature (82)..(82): n = reverse Uridine
caaggatcttaccgctgttggtgaccctgcagagatatctncgctccagacttgagtccgagttccggaagtaggtgatgtn

SEQ ID NO: 6 - DNA, 81 bp, Artificial
  Oligonucleotide probes
  misc_feature (41)..(41): n = reverse Uridine
  misc_feature (81)..(81): n = reverse Uridine
caaggatcttaccgctgttggattggcattgccatgggatncgctccagacttgagtccgatccacagcagctacgatggn

SEQ ID NO: 7 - DNA, 26 bp, Artificial
  Oligonucleotide probes
  misc_feature (11)..(11): n = 5′ phosphoramidite with 2′-acetyl and 3′-DMT
ttttttttttngtccacagcatccga

SEQ ID NO: 8 - DNA, 26 bp, Artificial
  Oligonucleotide probes
  misc_feature (11)..(11): n = 3′ phosphoramidite with 2′-fpmp and 5′ DMT
ttttttttttngtccacagcatccga

SEQ ID NO: 9 - DNA, 27 bp, Artificial
  Oligonucleotide probes
  misc_feature (11)..(11): n = 2′-deoxyuridine
ttttttttttndgtccacagcatccga

SEQ ID NO: 10 - DNA, 46 bp, Aequorea victoria
atgagtaaaggagaagaacttttcactggagttgtcccaattcttg

SEQ ID NO: 11 - DNA, 44 bp, Aequorea victoria
ttgaattagatggtgatgttaatgggcacaaattttctgtcagt

SEQ ID NO: 12 - DNA, 41 bp, Aequorea victoria
ggagagggtgaaggtgatgcaacatacggaaaacttaccct

SEQ ID NO: 13 - DNA, 44 bp, Aequorea victoria
taaatttatttgcactactggaaaactacctgttccatggccaa

SEQ ID NO: 14 - DNA, 46 bp, Aequorea victoria
cacttgtcactactttctcttatggtgttcaatgcttttcaagata

SEQ ID NO: 15 - DNA, 42 bp, Aequorea victoria
cccagatcatatgaaacggcatgactttttcaagagtgccat

SEQ ID NO: 16 - DNA, 44 bp, Aequorea victoria
gcccgaaggttatgtacaggaaagaactatatttttcaaagatg

SEQ ID NO: 17 - DNA, 41 bp, Aequorea victoria
acgggaactacaagacacgtgctgaagtcaagtttgaaggt

SEQ ID NO: 18 - DNA, 46 bp, Aequorea victoria
gatacccttgttaatagaatcgagttaaaaggtattgattttaaag

SEQ ID NO: 19 - DNA, 46 bp, Aequorea victoria
aagatggaaacattcttggacacaaattggaatacaactataactc

SEQ ID NO: 20 - DNA, 45 bp, Aequorea victoria
acacaatgtatacatcatggcagacaaacaaaagaatggaatcaa

SEQ ID NO: 21 - DNA, 45 bp, Aequorea victoria
agttaacttcaaaattagacacaacattgaagatggaagcgttca

SEQ ID NO: 22 - DNA, 42 bp, Aequorea victoria
actagcagaccattatcaacaaaatactccaattggcgatgg

SEQ ID NO: 23 - DNA, 41 bp, Aequorea victoria
ccctgtccttttaccagacaaccattacctgtccacacaat

SEQ ID NO: 24 - DNA, 41 bp, Aequorea victoria
ctgccctttcgaaagatcccaacgaaaagagagaccacatg

SEQ ID NO: 25 - DNA, 42 bp, Aequorea victoria
gtccttcttgagtttgtaacagctgctgggattacacatggc

SEQ ID NO: 26 - DNA, 46 bp, Aequorea victoria
atggatgaactatacaaatagcattcgtagaattgactctatagtg

SEQ ID NO: 27 - DNA, 25 bp, Aequorea victoria
tgaaaagttcttctcctttactcat

SEQ ID NO: 28 - DNA, 44 bp, Aequorea victoria
attaacatcaccatctaattcaacaagaattgggacaactccag

SEQ ID NO: 29 - DNA, 40 bp, Aequorea victoria
catcaccttcaccctctccactgacagaaaatttgtgccc

SEQ ID NO: 30 - DNA, 46 bp, Aequorea victoria
tttccagtagtgcaaataaatttaagggtaagttttccgtatgttg

SEQ ID NO: 31 - DNA, 43 bp, Aequorea victoria
ataagagaaagtagtgacaagtgttggccatggaacaggtagt

SEQ ID NO: 32 - DNA, 43 bp, Aequorea victoria
gccgtttcatatgatctgggtatcttgaaaagcattgaacacc

SEQ ID NO: 33 - DNA, 42 bp, Aequorea victoria
cctgtacataaccttcgggcatggcactcttgaaaaagtcat

SEQ ID NO: 34 - DNA, 44 bp, Aequorea victoria
acgtgtcttgtagttcccgtcatctttgaaaaatatagttcttt

SEQ ID NO: 35 - DNA, 43 bp, Aequorea victoria
cgattctattaacaagggtatcaccttcaaacttgacttcagc

SEQ ID NO: 36 - DNA, 46 bp, Aequorea victoria
tgtccaagaatgtttccatcttctttaaaatcaataccttttaact

SEQ ID NO: 37 - DNA, 46 bp, Aequorea victoria
tgccatgatgtatacattgtgtgagttatagttgtattccaatttg

SEQ ID NO: 38 - DNA, 47 bp, Aequorea victoria
ttgtgtctaattttgaagttaactttgattccattcttttgtttgtc

SEQ ID NO: 39 - DNA, 43 bp, Aequorea victoria
ttgttgataatggtctgctagttgaacgcttccatcttcaatg

SEQ ID NO: 40 - DNA, 40 bp, Aequorea victoria
tgtctggtaaaaggacagggccatcgccaattggagtatt

SEQ ID NO: 41 - DNA, 41 bp, Aequorea victoria
gggatctttcgaaagggcagattgtgtggacaggtaatggt

SEQ ID NO: 42 - DNA, 43 bp, Aequorea victoria
ctgttacaaactcaagaaggaccatgtggtctctcttttcgtt

SEQ ID NO: 43 - DNA, 43 bp, Aequorea victoria
tgctatttgtatagttcatccatgccatgtgtaatcccagcag

SEQ ID NO: 44 - DNA, 45 bp, Artificial
  Oligonucleotide probes
ctggcagcagccactggtaacaggattagcagagcgaggtatgta

SEQ ID NO: 45 - DNA, 45 bp, Artificial
  Oligonucleotide probes
ctggcagtagccactggtaacaggattagcagagcgaggtatgta

SEQ ID NO: 46 - DNA, 31 bp, Aequorea victoria
cactggagttgtcccaattcttggatcggcc

SEQ ID NO: 47 - DNA, 11 bp, Artificial
  Restriction site
ggccgatccaa

SEQ ID NO: 48 - DNA, 100 bp, Artificial
  Oligonucleotide probes
ctggcagcagccactttaactatgcggcatttaactatgcgatcggccttttggccgatcgcatagttaaatgccgcatagttaaagtggctgctgccag

SEQ ID NO: 49 - DNA, 80 bp, Artificial
  Oligonucleotide probes
ctggcagcagccactttaactatgcggcatttaactatgcgatcggccttttggccgatcgcatagttaaatgccgcata

SEQ ID NO: 50 - DNA, 100 bp, Artificial
  Oligonucleotide probes
ctggcagcagccactttaactatgcggcatttaactatgcgatcggccttttggccgatcgcatagttacatgccgcatagttaaagtggctgctgccag

SEQ ID NO: 51 - DNA, 100 bp, Artificial
  Oligonucleotide probes
ctggcagcagccactttaactatgcggcatttaactatgcgatcggccttttggccgatcgcatagttacatgccgcatagttaaagtggccgctgccag

SEQ ID NO: 52 - DNA, 80 bp, Artificial
  Oligonucleotide probes
ctggcagcagccactttaactatgcggcatttaactatgcgatcggccttttggccgatcgcatagttacatgccgcata

SEQ ID NO: 53 - DNA, 99 bp, Artificial
  Oligonucleotide probes
ctggcagcagccactttaactatgcggcatttaactatgcgatcggccttttggccgatcgcatagttaatgccgcatagttaaagtggctgctgccag

SEQ ID NO: 54 - DNA, 98 bp, Artificial
  Oligonucleotide probes
ctggcagcagccactttaactatgcggcatttaactatgcgatcggccttttggccgatcgcatagttaatgccgcatagttaaagtggcgctgccag

SEQ ID NO: 55 - DNA, 79 bp, Artificial
  Oligonucleotide probes
ctggcagcagccactttaactatgcggcatttaactatgcgatcggccttttggccgatcgcatagttaatgccgcata

SEQ ID NO: 56 - DNA, 99 bp, Artificial
  Oligonucleotide probes
ctggcagcagccactttaactatgcggcatttaactatgcggcatttaactatgcggcatttaactatgcggcattaactatgcggcatttaactatgc

SEQ ID NO: 57 - DNA, 94 bp, Artificial
  Oligonucleotide probes
ctggcagcagccactttaactatgcggcatttaactatgcggcatttaactatgcggcatttaactatgcggcattaactatgcggcatttaac

SEQ ID NO: 58 - DNA, 89 bp, Artificial
  Oligonucleotide probes
ctggcagcagccactttaactatgcggcatttaactatgcggcatttaactatgcggcatttaactatgcggcattaactatgcggcat

SEQ ID NO: 59 - DNA, 84 bp, Artificial
  Oligonucleotide probes
ctggcagcagccactttaactatgcggcatttaactatgcggcatttaactatgcggcatttaactatgcggcattaactatgc

SEQ ID NO: 60 - DNA, 79 bp, Artificial
  Oligonucleotide probes
ctggcagcagccactttaactatgcggcatttaactatgcggcatttaactatgcggcatttaactatgcggcattaac

SEQ ID NO: 61 - DNA, 75 bp, Artificial
  Oligonucleotide probes
ctggcagcagccactttaactatgcggcatttaactatgcggcatttaactatgcggcatttaactatgcggcat

SEQ ID NO: 62 - DNA, 70 bp, Artificial
  Oligonucleotide probes
ctggcagcagccactttaactatgcggcatttaactatgcggcatttaactatgcggcatttaactatgc

SEQ ID NO: 63 - DNA, 65 bp, Artificial
  Oligonucleotide probes
ctggcagcagccactttaactatgcggcatttaactatgcggcatttaactatgcggcatttaac

SEQ ID NO: 64 - DNA, 60 bp, Artificial
  Oligonucleotide probes
ctggcagcagccactttaactatgcggcatttaactatgcggcatttaactatgcggcat

SEQ ID NO: 65 - DNA, 55 bp, Artificial
  Oligonucleotide probes
ctggcagcagccactttaactatgcggcatttaactatgcggcatttaactatgc

SEQ ID NO: 66 - DNA, 50 bp, Artificial
  Oligonucleotide probes
ctggcagcagccactttaactatgcggcatttaactatgcggcatttaac

SEQ ID NO: 67 - DNA, 45 bp, Artificial
  Oligonucleotide probes
ctggcagcagccactttaactatgcggcatttaactatgcggcat

SEQ ID NO: 68 - DNA, 40 bp, Artificial
  Oligonucleotide probes
ctggcagcagccactttaactatgcggcatttaactatgc

SEQ ID NO: 69 - DNA, 35 bp, Artificial
  Oligonucleotide probes
ctggcagcagccactttaactatgcggcatttaac

SEQ ID NO: 70 - DNA, 30 bp, Artificial
  Oligonucleotide probes
ctggcagcagccactttaactatgcggcat

SEQ ID NO: 71 - DNA, 25 bp, Artificial
  Oligonucleotide probes
ctggcagcagccactttaactatgc

SEQ ID NO: 72 - DNA, 20 bp, Artificial
  Oligonucleotide probes
ctggcagcagccactttaac

SEQ ID NO: 73 - DNA, 15 bp, Artificial
  Oligonucleotide probes
ctggcagcagccact

SEQ ID NO: 74 - DNA, 99 bp, Artificial
  Oligonucleotide probes
ctggcagtagccactttaactatgcggcatttaactatgcggcatttaactatgcggcatttaactatgcggcattaactatgcggcatttaactatgc

SEQ ID NO: 75 - DNA, 94 bp, Artificial
  Oligonucleotide probes
ctggcagtagccactttaactatgcggcatttaactatgcggcatttaactatgcggcatttaactatgcggcattaactatgcggcatttaac

SEQ ID NO: 76 - DNA, 89 bp, Artificial
  Oligonucleotide probes
ctggcagtagccactttaactatgcggcatttaactatgcggcatttaactatgcggcatttaactatgcggcattaactatgcggcat

SEQ ID NO: 77 - DNA, 84 bp, Artificial
  Oligonucleotide probes
ctggcagtagccactttaactatgcggcatttaactatgcggcatttaactatgcggcatttaactatgcggcattaactatgc

SEQ ID NO: 78 - DNA, 79 bp, Artificial
  Oligonucleotide probes
ctggcagtagccactttaactatgcggcatttaactatgcggcatttaactatgcggcatttaactatgcggcattaac

SEQ ID NO: 79 - DNA, 75 bp, Artificial
  Oligonucleotide probes
ctggcagtagccactttaactatgcggcatttaactatgcggcatttaactatgcggcatttaactatgcggcat

SEQ ID NO: 80 - DNA, 70 bp, Artificial
  Oligonucleotide probes
ctggcagtagccactttaactatgcggcatttaactatgcggcatttaactatgcggcatttaactatgc

SEQ ID NO: 81 - DNA, 65 bp, Artificial
  Oligonucleotide probes
ctggcagtagccactttaactatgcggcatttaactatgcggcatttaactatgcggcatttaac

SEQ ID NO: 82 - DNA, 60 bp, Artificial
  Oligonucleotide probes
ctggcagtagccactttaactatgcggcatttaactatgcggcatttaactatgcggcat

SEQ ID NO: 83 - DNA, 55 bp, Artificial
  Oligonucleotide probes
ctggcagtagccactttaactatgcggcatttaactatgcggcatttaactatgc

SEQ ID NO: 84 - DNA, 50 bp, Artificial
  Oligonucleotide probes
ctggcagtagccactttaactatgcggcatttaactatgcggcatttaac

SEQ ID NO: 85 - DNA, 45 bp, Artificial
  Oligonucleotide probes
ctggcagtagccactttaactatgcggcatttaactatgcggcat

SEQ ID NO: 86 - DNA, 40 bp, Artificial
  Oligonucleotide probes
ctggcagtagccactttaactatgcggcatttaactatgc

SEQ ID NO: 87 - DNA, 35 bp, Artificial
  Oligonucleotide probes
ctggcagtagccactttaactatgcggcatttaac

SEQ ID NO: 88 - DNA, 30 bp, Artificial
  Oligonucleotide probes
ctggcagtagccactttaactatgcggcat

SEQ ID NO: 89 - DNA, 25 bp, Artificial
  Oligonucleotide probes
ctggcagtagccactttaactatgc

SEQ ID NO: 90 - DNA, 20 bp, Artificial
  Oligonucleotide probes
ctggcagtagccactttaac

SEQ ID NO: 91 - DNA, 15 bp, Artificial
  Oligonucleotide probes
ctggcagtagccact

SEQ ID NO: 92 - DNA, 98 bp, Artificial
  Oligonucleotide probes
ctggcagagccactttaactatgcggcatttaactatgcggcatttaactatgcggcatttaactatgcggcattaactatgcggcatttaactatgc

SEQ ID NO: 93 - DNA, 93 bp, Artificial
  Oligonucleotide probes
ctggcagagccactttaactatgcggcatttaactatgcggcatttaactatgcggcatttaactatgcggcattaactatgcggcatttaac

SEQ ID NO: 94 - DNA, 88 bp, Artificial
  Oligonucleotide probes
ctggcagagccactttaactatgcggcatttaactatgcggcatttaactatgcggcatttaactatgcggcattaactatgcggcat

SEQ ID NO: 95 - DNA, 83 bp, Artificial
  Oligonucleotide probes
ctggcagagccactttaactatgcggcatttaactatgcggcatttaactatgcggcatttaactatgcggcattaactatgc

SEQ ID NO: 96 - DNA, 78 bp, Artificial
  Oligonucleotide probes
ctggcagagccactttaactatgcggcatttaactatgcggcatttaactatgcggcatttaactatgcggcattaac

SEQ ID NO: 97 - DNA, 74 bp, Artificial
  Oligonucleotide probes
ctggcagagccactttaactatgcggcatttaactatgcggcatttaactatgcggcatttaactatgcggcat

SEQ ID NO: 98 - DNA, 69 bp, Artificial
  Oligonucleotide probes
ctggcagagccactttaactatgcggcatttaactatgcggcatttaactatgcggcatttaactatgc

SEQ ID NO: 99 - DNA, 64 bp, Artificial
  Oligonucleotide probes
ctggcagagccactttaactatgcggcatttaactatgcggcatttaactatgcggcatttaac

SEQ ID NO: 100 - DNA, 59 bp, Artificial
  Oligonucleotide probes
ctggcagagccactttaactatgcggcatttaactatgcggcatttaactatgcggcat

SEQ ID NO: 101 - DNA, 54 bp, Artificial
  Oligonucleotide probes
ctggcagagccactttaactatgcggcatttaactatgcggcatttaactatgc

SEQ ID NO: 102 - DNA, 49 bp, Artificial
  Oligonucleotide probes
ctggcagagccactttaactatgcggcatttaactatgcggcatttaac

SEQ ID NO: 103 - DNA, 44 bp, Artificial
  Oligonucleotide probes
ctggcagagccactttaactatgcggcatttaactatgcggcat

SEQ ID NO: 104 - DNA, 39 bp, Artificial
  Oligonucleotide probes
ctggcagagccactttaactatgcggcatttaactatgc

SEQ ID NO: 105 - DNA, 34 bp, Artificial
  Oligonucleotide probes
ctggcagagccactttaactatgcggcatttaac

SEQ ID NO: 106 - DNA, 29 bp, Artificial
  Oligonucleotide probes
ctggcagagccactttaactatgcggcat

SEQ ID NO: 107 - DNA, 24 bp, Artificial
  Oligonucleotide probes
ctggcagagccactttaactatgc

SEQ ID NO: 108 - DNA, 19 bp, Artificial
  Oligonucleotide probes
ctggcagagccactttaac

SEQ ID NO: 109 - DNA, 14 bp, Artificial
  Oligonucleotide probes
ctggcagagccact

SEQ ID NO: 110 - DNA, 84 bp, Artificial
  Oligonucleotide probes
ttaactatgcggcatttaactatgcggcatttaactatgcggcatttaactatgcggcatttaactatgcggcattaactatgc

SEQ ID NO: 111 - DNA, 79 bp, Artificial
  Oligonucleotide probes
ttaactatgcggcatttaactatgcggcatttaactatgcggcatttaactatgcggcatttaactatgcggcattaac

SEQ ID NO: 112 - DNA, 75 bp, Artificial
  Oligonucleotide probes
ttaactatgcggcatttaactatgcggcatttaactatgcggcatttaactatgcggcatttaactatgcggcat

SEQ ID NO: 113 - DNA, 70 bp, Artificial
  Oligonucleotide probes
ttaactatgcggcatttaactatgcggcatttaactatgcggcatttaactatgcggcatttaactatgc

SEQ ID NO: 114 - DNA, 65 bp, Artificial
  Oligonucleotide probes
ttaactatgcggcatttaactatgcggcatttaactatgcggcatttaactatgcggcatttaac

SEQ ID NO: 115 - DNA, 60 bp, Artificial
  Oligonucleotide probes
ttaactatgcggcatttaactatgcggcatttaactatgcggcatttaactatgcggcat

SEQ ID NO: 116 - DNA, 55 bp, Artificial
  Oligonucleotide probes
ttaactatgcggcatttaactatgcggcatttaactatgcggcatttaactatgc

SEQ ID NO: 117 - DNA, 50 bp, Artificial
  Oligonucleotide probes
ttaactatgcggcatttaactatgcggcatttaactatgcggcatttaac

SEQ ID NO: 118 - DNA, 45 bp, Artificial
  Oligonucleotide probes
ttaactatgcggcatttaactatgcggcatttaactatgcggcat

SEQ ID NO: 119 - DNA, 40 bp, Artificial
  Oligonucleotide probes
ttaactatgcggcatttaactatgcggcatttaactatgc

SEQ ID NO: 120 - DNA, 35 bp, Artificial
  Oligonucleotide probes
ttaactatgcggcatttaactatgcggcatttaac

SEQ ID NO: 121 - DNA, 30 bp, Artificial
  Oligonucleotide probes
ttaactatgcggcatttaactatgcggcat

SEQ ID NO: 122 - DNA, 25 bp, Artificial
  Oligonucleotide probes
ttaactatgcggcatttaactatgc

SEQ ID NO: 123 - DNA, 20 bp, Artificial
  Oligonucleotide probes
ttaactatgcggcatttaac

SEQ ID NO: 124 - DNA, 15 bp, Artificial
  Oligonucleotide probes
ttaactatgcggcat

SEQ ID NO: 125 - DNA, 10 bp, Artificial
  Oligonucleotide probes
ttaactatgc

SEQ ID NO: 126 - DNA, 15 bp, Artificial
  Oligonucleotide probes
ctggcagtagccact

SEQ ID NO: 127 - DNA, 14 bp, Artificial
  Oligonucleotide probes
ctggcagagccact

SEQ ID NO: 128 - DNA, 19 bp, Artificial
  Oligonucleotide probes
tgcagttagctcttccaat

SEQ ID NO: 129 - DNA, 19 bp, T7 Virus
cctatagtgagtcgtatta